(19) United States
(12) Patent Application Publication
(10) Pub. No.: US 2014/0038172 A1
(43) Pub. Date: Feb. 6, 2014

(54) Matrix and System for Preserving Biological Specimens for Qualitative and Quantitative Analysis

(71) Applicant: ViveBio, LLC, Alpharetta, GA (US)

(72) Inventors: Abel De La Rosa, Alpharetta, GA (US); Mimi C. G. Healy, Athens, GA (US); Kristy S. Reece, Pearland, TX (US); Daniel R. McClernon, Cary, NC (US); Anita Matthews McClernon, Cary, NC (US)

(73) Assignee: ViveBio, LLC, Alpharetta, GA (US)

(21) Appl. No.: 14/020,142

(22) Filed: Sep. 6, 2013

Related U.S. Application Data
(63) Continuation of application No. PCT/US2013/053799, filed on Aug. 6, 2013.
(60) Provisional application No. 61/680,193, filed on Aug. 6, 2012.

(51) Int. Cl. G01N 1/30

(52) U.S. Cl. CPC G01N 1/30
USPC 435/5; 435/309.1

(57) ABSTRACT

The present invention provides a device, system, and methods of use comprising an absorbent hydrophobic polyolefin matrix, and methods of use thereof, for storage, preserving, and recovering liquid suspension of biological specimens containing analytes of interest in a dry state. The dried biological specimens containing analytes of interest absorbed on the polyolefin matrix are reconstituted such as with molecular-grade water and released by compressing the polyolefin matrix. The reconstituted biological analytes are qualified for subsequent analysis, such as for qualitative and quantitative analysis of viral nucleic acids, such a viral load testing, genotyping, and sequencing. Also provided are kits with instructions, and methods of use thereof, for storage, preserving, and recovering biological specimens containing analytes of interest using the compression device of the invention.

### CROSS-REFERENCE TO RELATED APPLICATIONS

This application is a continuation of PCT Application No. PCT/US2013/053799 filed Aug. 6, 2013 which claims priority to U.S. Provisional Application No. 61/680,193 filed Aug. 6, 2012, the entire contents of which are incorporated by reference herewith.

### FIELD OF THE INVENTION

This invention relates generally to biological specimen preserving matrix and system, devices, and methods for use therewith. More specifically, the invention relates to a matrix and system for collection, storage and recovery of nucleic acids such as viral DNA and RNA specimens for subsequent quantitative and qualitative laboratory analysis such as viral load, genotyping, and antiviral drug resistance testing.

### BACKGROUND OF THE INVENTION

Biological specimens are often collected, transported and stored for analysis of the levels and concentrations of various analytes contained therewithin. Conventionally, liquid suspensions of biological specimens are stored in sealed airtight tubes under refrigeration. Liquid sample collection, handling, transportation and storage has many problems associated with it, for example: the cost of refrigeration (typically by dry ice) in remote collection centers; the risk of container breakage or leakage which causes loss of sample and the danger of infection; sample instability during shipment and storage; refusal of transport carriers to accept liquid biohazard shipments; and collection of adequate sample volume to ensure quantities compatible with laboratory methods of subsequent qualitative and quantitative analyses. The costs of addressing the above problems are substantial.

Dried blood spot (DBS) and dried plasma spot (DPS) sampling on filter paper are alternative methods to the liquid sampling procedures, and have been used worldwide with some success. Since the 1980s, manufacturers such as Schleicher and Schuell Corp., Bio-Rad, Boehringer Mannheim Corp., and Whatman, Inc., have been producing filter papers for DBS and DPS sampling. In using these commercially available biological sampling filter paper systems, a blood or plasma spot is placed in one or more designated areas of the filter paper, allowed to dry, and then mailed along with a test request form to the laboratory. Commonly used filter papers are known to those of ordinary skill in the art, such as Whatman 3 MM, GF/CM30, GF/QA30, S&S 903, GB002, GB003, or GB004. Several categories of blotting materials for blood specimen collection are available, e.g., S&S 903 cellulose (wood or cotton derived) filter paper and Whatman glass fiber filter paper. However, certain disadvantages have been associated with these commercially available filter papers. Specifically, certain of these commercially available and commonly used materials lack characteristics which provide precision values and accuracy that are preferred for carrying out certain qualitative and quantitative biological assays.

Genetic material can be extracted and isolated from prior art DBSs in sufficient quantities for use in genetic analysis. For instance, DBS has been used for the detection of prenatal human immunodeficiency virus (HIV) infection by the polymerase chain reaction (PCR) (Cassol, et al., J. Clin Microbiol. 30 (12): 3039-42, 1992). DPS and DBS have also been used with limited success for HIV RNA detection and quantification (Cassol, et al., J. Clin. Microbiol. 35: 2795-2801, 1997; Fiscus, et al., J. Clin. Microbiol. 36: 258-60, 1998; O'Shea, et al., AIDS 13: 630-1, 1999; Biggar, et al., J. Infec. Dis. 180 1838-43, 1999; Brambilla, et al., J. Clin. Microbiol. 41(5): 1888-93, 2003); HIV DNA detection and quantification (Panteleefe, et al., J. Clin. Microbiol. 37: 350-3, 1999; Nyambi, et al., J. Clin. Microbiol. 32: 2858-60, 1994); and HIV antibody detection (Evengard, et al., AIDS 3: 591-5, 1989; Gwinn, et al., JAMA 265: 1704-08, 1991). HCV RNA detection and genotyping are also reported using DBS (Solmone et al., J. Clin. Microbio. 40 (9): 3512-14, 2002). Although these studies provide a good correlation with titers using DPS or DBS is obtained as compared with conventional liquid plasma samples, a loss of viral titers may occur after room temperature storage (Cassol, et al., J. Clin. Microbiol. 35: 2795-2801, 1997; Fiscus, et al., J. Clin. Microbiol. 36: 258-60, 1998). DBS and DPS samples are clearly less expensive and less hazardous to transport than liquid samples.

However, the procedure of analyte microextraction from DBS and DPS on filter paper suffers from a number of disadvantages. For example, microextraction of sufficient DNA or RNA from filter paper involves reconstitution in a liquid medium under certain vigorous procedures, e.g., vortex and centrifugation that damages the genetic analytes of interest. Furthermore, the fibers and other components of the filters become dislodged into the reconstitution solution, and require further centrifugation separation and/or can impede the ability to isolate the genetic material, such as by blocking genetic material from adhering to a separation column. Such prior microextraction procedures require a high standard of technical assistance, and even then do not consistently provide results with a desired level of sensitivity, reproducibility, quantification and specificity.

Furthermore, the sample volume used for DBS and DPS on filter paper is limited, typically to 50-200 ul spots, and considerable difficulty in analyte detection and accurate quantification and reproducibility can be encountered, particularly when the concentration of the desired analyte material is low in the sample. Also in the prior art, there is a lack of deliberate inhibition of enzymes and chemicals which degrade the analytes, such as genetic material contained therewithin. Even in the presence of a bacteriostatic agent there are conditions that permit enzymatic, nonenzymatic and autolytic breakdown of the genetic material. Furthermore, microextraction of genetic material from DBS or DPS on filter papers is considerably more difficult if absorption of high molecular weight DNA or RNA is required. Although the introduction of new material and transportation methods continuously improve the ways samples are handled, the quantity and quality of the sample available for subsequent analysis are still of great concern to researchers and clinicians alike.

U.S. Pat. No. 7,638,099 provides an advantageous alternative system for biological sample collection, storage and transportation. The reference suggests the use of cellulose acetate fibers and hydrophilic polymer fibers as being advantageous for an absorbent matrix material. However, further improvements are desired for certain situations, such as to achieve more accurate and reproducible quantification of viral load in a sample.

Thus, there is a need for an improved device for collection, storage and transportation of liquid suspension of biological specimens containing analytes of interest in a dry state, especially in large field studies and for application in settings where collection, centrifugation, storage and shipment can be difficult, as is often the case in developing countries. In addition, there is a need for improved recovery of viral specimens for subsequent analysis that provides precision values and accuracy of detection, reproducibility and quantification of the analytes of interest contained therewithin.

### SUMMARY OF THE INVENTION

This invention fulfills in part the need to provide a safe, convenient and simple device and method for preserving, storage and transportation of biological specimens containing analytes of interest. The invention also fulfills in part the need to recover biological specimens containing analytes of interest for subsequent analysis that provides more desirable sensitivity and specificity of detection. More particularly, the invention provides an improved matrix storage material comprising hydrophobic polyolefin polymers for use as a device, system, and method for accurate and reproducible quantification of viral load in a patient. The invention provides a novel device and method for preserving, storing, and transporting a liquid suspension of biological specimens in a dry state and further reconstituting the analytes of interest contained in the biological specimens for use in research and site validated clinical testing.

In certain embodiments, the absorbent polyolefin matrix comprises hydrophobic polymers, including polyethylene. In certain embodiments, the absorbent polyolefin fiber matrix comprises a hydrophobic polyethylene surface coating. In certain embodiments, the matrix comprises a plurality of polyolefin fiber strands, wherein each individual fiber strand within the absorbent polyolefin fiber matrix is composed of a core and an outer sheath. In certain embodiments, the core of each fiber comprises polypropylene, and the outer coating sheath of each fiber comprises polyethylene. In certain embodiments, each individual fiber strand within the polyolefin fiber matrix is composed of a core of each strand comprising about 50% polypropylene and a hydrophobic outer sheath surrounding the core of each strand comprising about 50% polyethylene.

Based on the data presented, the invention provides that a hydrophobic polyolefin fiber matrix is superior compared to previous dried collection devices for absorption, preservation, stabilisation, and subsequent recovery of nucleic acid for quantification and qualification. Without wishing to be bound by theory, it is believed that these surprising results are due to the properties of the embedded hydrophobic interstices, or pockets within the polyolefin matrix. These pockets provide a reservoir for the analyte to reside while excluding water from the analyte, e.g., nucleic acid, providing a stable environment during storage. The improved hydrophobic polyolefin matrix further allows polar solvents to evaporate more consistently and efficiently. Therefore, the improved polyolefin matrix retains analytes and suspended particles inside the matrix better than for example a cellulose matrix. Contrary to the teachings in the prior art that hydrophilic polymer surfaces in the matrix are more desirable, it has been discovered that hydrophobic polyolefin surfaces in the matrix are surprisingly advantageous. Thus, a substantially intact viral nucleic acid, for example, can be eluted from the reconstituted matrix with great efficiency permitting a surprisingly accurate degree of quantification and qualification of the viral load in the biological sample.

The polyolefin fiber matrix of the invention absorbs greater than 0.05 ml of a liquid suspension of biological specimens absorbed and dried thereon. In certain embodiments, the polyolefin fiber matrix absorbs at least 0.1, ml or 0.5, ml of the liquid suspension. In yet other embodiments, the polyolefin fiber matrix absorbs at least 1 ml, 1.5 ml, 2.0 ml, 2.5 ml, 3.0 ml, or more, of the liquid suspension of biological specimens.

The invention provides that the absorbent polyolefin fiber matrix, while harboring numerous hydrophobic pockets, is able to be compressed by applying force against the matrix by at least 10% of the volume of the matrix to release a portion of the re-suspended biological specimen stored therewithin. In other embodiments, the matrix is able to be compressed by at least 20%, 50%, 75%, 80%, 85%, 90%, or 95% or more of the volume of the matrix to release a portion of the liquid suspension of biological specimen stored in the matrix. In other words, the matrix is at least 10% porous or defines at least 10% available space, including numerous hydrophobic pockets within the polyolefin fiber matrix, for the storage of a biological specimen therein.

In certain embodiments, the polyolefin fiber matrix is three-dimensional in a variety of different shapes, including but not limited to, a cylinder, disk, cube, sphere, pyramid, cone, concave, indented, invaginated or other shapes and surface textures suitable for absorption and fitting inside a container. In certain embodiments, the matrix is in the shape of a cylinder about 18 mm to 24 mm, or 21 mm, in length, and 5 mm to 15 mm, or 9 mm, in diameter, with a density of about 0.01 g/cc to 0.1 g/cc, or about 0.077 g/cc. In certain embodiments, a majority of the polyolefin fiber sizes are in the range of about 1-100 microns, 10-50 microns, or 20-25 microns and contain numerous hydrophobic pockets.

The invention provides a device and methods that allow for biological testing of air-dried bodily fluid samples without the need for refrigerated or frozen shipping and storage. The inventive device and methods provide the capability to significantly reduce the costs of shipping infectious materials worldwide, especially those associated with large clinical trials. Moreover, the inventive device and methods for preserving biological specimens are applicable to and include a wide range of esoteric and standard clinical testing, including qualitative and quantitative nucleic acid analysis.

In certain embodiments, the invention provides a device, and method of use thereof, for preserving and recovering a biological specimen containing analytes of interest. More particularly, the device comprises a first enclosed container defining an interior space having side walls, a bottom and an openable and sealable lid or cap. In certain embodiments, the first enclosed container is a tube having a sealable cap with an absorbent three-dimensional polyolefin fiber matrix mounted therein. In certain embodiments, an interior of the tube or cap has an internal surface extension with the absorbent three-dimensional matrix removably mounted thereon.

In certain embodiments, the invention further comprises a second enclosed compression container with a syringe barrel shape or any other suitable shape for receiving therein the matrix for reconstitution, compression, and release of the analytes of interest, e.g., intact viral RNA or DNA. In certain embodiments, only one container is required for storage, transportation, reconstitution, and release of the analytes of interest from the matrix.

In certain embodiments, the device may optionally comprise a desiccant inside the enclosed container in vaporous communication with the matrix to maintain a dried state of the matrix and integrity of the biological specimen and analytes of interest it contains on the matrix. Exemplary suitable desiccant includes, but is not limited to, montmorillonite clay, lithium chloride, activated alumina, alkali alumino-silicate, DQ11 Briquettes, silica gel, molecular sieve, calcium sulfate, or calcium oxide. In certain embodiments, the desiccant indicates its moisture content by colorimetric means. In other embodiments, since unlike the hydrophilic cellulose acetate matrix where the solvents are not released as efficiently, the hydrophobic polyolefin fiber matrix of the invention allows the solvents to evaporate more consistently and efficiently, and a desiccant is not necessary.

According to the invention, the analytes of interest include, but are not limited to, nucleic acids, proteins, carbohydrates, lipids, whole cells, cellular fragments, whole virus or viral fragments. In certain embodiments, the analytes of interest are nucleic acids including either or both DNA and RNA molecules. The invention particularly provides improved systems and methods for the detection and quantitation of RNA, e.g., whole virus for determining viral load and genotyping in a biological specimen or subject.

In certain embodiments, the nucleic acid of interest is HCV or other single stranded RNA viruses. In certain embodiments, the nucleic acid of interest is HIV or other retroviruses. In certain embodiments, the nucleic acid of interest is HBV or other double stranded DNA viruses. In certain embodiments, the nucleic acid of interest is Influenza or other double stranded RNA viruses. In certain embodiments, the nucleic acid of interest is Parvovirus B19 or other single stranded DNA viruses. In certain embodiments, the nucleic acid of interest is contained within the HCV genome or the genome of other single stranded RNA viruses. In certain embodiments, the nucleic acid of interest is contained within the HIV genome or the genome of other retrovirus. In certain embodiments, the nucleic acid of interest is HBV genome or the genome of other double stranded DNA viruses. In certain embodiments, the nucleic acid of interest is Influenza genome or the genome of other double stranded RNA viruses. In certain embodiments, the nucleic acid of interest is Parvovirus B19 or the genome of other single stranded DNA virus.

According to the invention, the biological specimens include, but are not limited to, whole blood, plasma, urine, saliva, sputum, semen, vaginal lavage, bone marrow, cerebrospinal fluid, other physiological or pathological body liquids, or any of the combinations thereof. In certain embodiments, the biological specimen is human body fluid, such as whole blood containing the analytes of interest, such as nucleic acids, including either or both DNA and RNA molecules. In certain embodiments, the analytes of interest are nucleic acids and the biological specimens comprise at least 5 ng to 1 μg either or both DNA or RNA molecules. In yet other embodiments, the biological specimen is contained in liquid suspension. According to the invention, the liquid suspension includes, but is not limited to, cell suspension, liquid extracts, tissue homogenates, media from DNA or RNA synthesis, saline, or any combinations thereof.

The invention further provides a system and method for preserving and recovering a biological specimen containing analytes of interest, such as RNA, from the matrix in the device provided by the invention. In certain embodiments, the method comprises the following steps of providing a device comprising an absorbent matrix comprised of hydrophobic polyolefin fibers, wherein in certain embodiments each strand of fiber is comprised of a core and an outer sheath surface, wherein said core of each strand comprises polypropylene, and said outer sheath surface of each strand comprises polyethylene. In the method the matrix can be provided with a dried biological specimen contained thereon obtained from a volume of at least 0.05 ml of an evaporated liquid suspension comprising a liquid and the biological specimen containing analytes of interest. The method further comprises reconstituting the biological specimen on the matrix with a controlled volume of a reconstitution medium; and removing the biological specimen from the matrix, such as by compressing the matrix.

In certain embodiments, the reconstitution solution is water medium. In other embodiments, the reconstitution buffer comprises 1× phosphate buffered saline (PBS) or nuclease-free water optionally comprising sodium azide or other antimicrobial agent. In yet other embodiments, the reconstitution buffer is a “lysis” buffer. The reconstitution buffer may also include any number or combinations of available biological preservatives or blood anticoagulants including, but not limited to, ethylenediaminetetraacetic acid (EDTA), sodium citrate, and heparin.

In one embodiment, the method can comprise removing the matrix from the container prior to compressing the matrix in a second container, e.g., a syringe barrel. In yet another embodiment, the compression of the matrix is achieved by applying force against the hydrophobic polyolefin matrix within the same container to release the analytes of interest. According to the invention, the hydrophobic polyolefin matrix in the compression device is capable of compressing by at least 10%, 20%, 25%, 50%, 55%, 60%, 65%, 70%, 75%, 80%, 85%, 90% or more of the volume of the matrix to release a portion of the biological specimen suspended in the matrix.

The invention further provides a kit for preserving a liquid suspension of a biological specimen containing analytes of interest and for follow-up recovery and analysis. In certain embodiments, the kit includes the compression device provided by the present invention and instructions for preserving the biological specimens containing analytes of interest. The kit can further comprise a stabilising solution to inhibit degradation of the analytes. The kit can further comprise a reconstitution medium, a compression device and further instructions for recovery the analytes of interest contained in the biological specimen. In certain embodiments, the compression device comprises a tube with a syringe barrel shape that contains a plunger with a cup attached that the matrix is permanently adhered to allowing compression of the matrix to be achieved by applying force to the plunger, and wherein at least 10% to 90%, or greater, of the volume of the matrix is compressed to release a portion of the bound biological specimen.

The invention further provides subsequent analysis using the recovered biological specimen containing analytes of interest. In certain embodiments, the analytes of interest are RNA molecules that are detected or analyzed using analytical and diagnostic methods known in the art. In certain embodiments, the analytes of interest are intact virus, such as HCV or HIV, and the biological specimen recovered from the device is used for evaluation and analytical measurements with reproducibility, accuracy, and precision.

### BRIEF DESCRIPTION OF THE DRAWINGS

FIG. 1A is a perspective view of an assembled device according to one embodiment of the invention. FIG. 1B is a perspective view of a disassembled device according to one embodiment of the invention ready for sample addition.

FIG. 2 illustrates addition of sample to the polyolefin matrix of a device according to one embodiment of the invention.

FIG. 3 illustrates addition of sample to the polyolefin matrix of a device according to one embodiment of the invention.

FIG. 4 is a perspective view of preparing to transfer the polyolefin matrix of a device according to one embodiment of the invention into an empty syringe barrel.

FIG. 5 is a perspective view of completed delivery of the polyolefin matrix into the syringe barrel.

FIG. 6 illustrates rehydration of the polyolefin matrix by a pipette tip gently placed on the top of the matrix and slowly dispensing reconstitution buffer.

FIG. 7A illustrates insertion of the plunger into the syringe barrel. FIG. 7B illustrates application of pressure to the syringe plunger. FIG. 7C illustrates compression of the polyolefin matrix plug. FIG. 7D illustrates completion of sample recovery.

FIG. 8 provides a linear regression analysis for matrix comparison studies using the Abbott REALTIME HBV assay.

FIG. 9 provides a sample correlation and HCV viral load using fresh plasma and plasma samples processed through the ViveST devices of the invention.

FIG. 10 provides a sample correlation and HIV-1 viral load using fresh plasma and plasma samples processed through the ViveST devices of the invention and recovered with mLysis.

FIG. 11 provides a sample correlation and HIV-1 viral load using fresh plasma and plasma samples processed through the ViveST devices of the invention and recovered with water.

FIG. 12 provides a HCV analytical measurement range determination using the Abbott REALTIME HCV assay for samples processed through the ViveST devices of the invention.

FIG. 13 provides comparisons of frozen plasma and plasma samples processed through the ViveST devices of the invention using the Roche COBAS AmpliPrep/COBAS TaqMan HCV assay.

FIG. 14 provides comparisons of frozen plasma and plasma samples processed through the VivesST devices of the invention using the Roche COBAS AmpliPrep/COBAS TaqMan HIV assay.

FIG. 15 provides a HIV-1 analytical measurement range determination using the Abbott REALTIME HIV-1 assay for samples processed through the ViveST devices of the invention.

FIG. 16 provides a linear regression analysis of HCV 7-day stability studies at ambient conditions using the Abbott REALTIME HCV assay for samples processed through the ViveST devices of the invention.

FIG. 17 provides comparisons of target and actual HCV titers in the 7-day stability studies at ambient conditions using the Abbott REALTIME HCV assay, viewed by concentration level.

FIG. 18 provides comparisons of HCV titers analyzed on initial test point (Day 1) in the nominal frozen plasma not processed through the ViveST devices of the invention, and the HCV titers of the plasma samples stored on the ViveST device for 7 days and processed through the ViveST devices thereafter.

FIG. 19 provides a linear regression analysis of HCV 21-day stability studies at ambient storage condition using the Abbott REALTIME HCV assay for samples processed through the ViveST devices of the invention.

FIG. 20 provides comparisons of target and actual HCV titers in the 21-day stability studies at ambient storage condition using the Abbott REALTIME HCV assay, view by concentration level.

FIG. 21 provides a linear regression analysis of HCV 21-day stability studies at 4° C. storage condition using the Abbott REALTIME HCV assay for samples processed through the ViveST devices of the invention.

FIG. 22 provides comparisons of target and actual HCV titers in the 21-day stability studies at 4° C. storage condition using the Abbott REALTIME HCV assay, view by concentration level.

FIG. 23 provides a linear regression analysis of HCV 21-day stability studies at 40° C./75% RH storage condition using Abbott REALTIME HCV assay for samples processed through the ViveST devices of the invention.

FIG. 24 provides comparisons of target and actual HCV titers in the 21-day stability studies at 40° C./75% RH storage condition using the Abbott REALTIME HCV assay, view by concentration level.

FIG. 25 provides comparisons of target and actual HCV titers in the 21-day stability studies, view by storage condition after 21 days storage.

FIG. 26 provides a linear regression analysis of HIV-1 stability studies at ambient conditions using the Abbott REALTIME HIV-1 assay for samples processed through the ViveST devices of the invention.

FIG. 27 provides comparisons of target and actual HIV-1 titers in the HIV-1 stability studies at ambient conditions using the Abbott REALTIME HIV-1 assay, view by concentration level.

FIG. 28 provides a linear regression analysis of HCV 62-day stability studies at ambient storage conditions using the Abbott REALTIME HCV assay for samples processed through the ViveST devices of the invention.

FIG. 29 provides comparisons of target and actual HCV titers in the 62-day stability studies at ambient storage condition using the Abbott REALTIME HCV assay, view by concentration level.

FIG. 30 provides a linear regression analysis of HCV 62-day stability studies at 4° C. storage condition using the Abbott REALTIME HCV assay for samples processed through the ViveST devices of the invention.

FIG. 31 provides comparisons of target and actual HCV titers in the 62-day stability studies at 4° C. storage condition using the Abbott REALTIME HCV assay, view by concentration level.

FIG. 32 provides a linear regression analysis of HCV 62-day stability studies at 40° C./75% RH storage conditions using the Abbott REALTIME HCV assay for samples processed through the ViveST devices of the invention.

FIG. 33 provides comparisons of target and actual HCV titers in the 62-day stability studies at 40° C./75% RH storage conditions using the Abbott REALTIME HCV assay, view by concentration level.

FIG. 34 provides comparisons of target and actual HCV titers in the 62-day stability studies, view by storage condition after 62 days storage.

FIG. 35 provides a linear regression analysis of HIV-1 62-day stability studies at ambient storage conditions using the Abbott REALTIME HIV-1 assay for samples processed through the ViveST devices of the invention.

FIG. 36 provides comparisons of target and actual HIV-1 titers in the 62-day stability studies at ambient storage conditions using the Abbott REALTIME HIV-1 assay, view by concentration level.

FIG. 37 provides a linear regression analysis of the HIV-1 62-day stability studies at 4° C. storage condition using the Abbott REALTIME HIV-1 assay for samples processed through the ViveST devices of the invention.

FIG. 38 provides comparisons of target and actual HIV-1 titers in the 62-day stability studies at 4° C. storage conditions using the Abbott REALTIME HIV-1 assay, view by concentration level.

FIG. 39 provides a linear regression analysis of HIV-1 62-day stability studies a 40° C./75% RH storage conditions using the Abbott REALTIME HIV-1 assay for samples processed through the ViveST devices of the invention.

FIG. 40 provides comparisons of target and actual HIV-1 titers in the 62-day stability studies at 40° C./75% RH storage conditions using the Abbott REALTIME HIV-1 assay, view by concentration level.

FIG. 41 provides comparisons of target and actual HIV-1 titers in the 62-day stability studies, view by storage condition after 62 days storage.

FIG. 42 provides a linear regression analysis for target and achieved frozen plasma samples.

FIG. 43 provides a probit analysis for HIV-1 limited of detection (LOD) evaluation.

FIG. 44 provides a regression analysis for samples processed through the ViveST device of the invention and the frozen plasma using the Roche COBAS TaqMan HCV Test (v2.0).

FIG. 45 provides a linear regression analysis of HCV 7-day stability studies at ambient storage conditions using the Roche COBAS TaqMan HCV Test (v 2.0) for samples processed through the ViveST devices of the invention.

FIG. 46 provides comparisons of target and actual HCV titers in the 7-day stability studies at ambient storage conditions using the Roche COBAS TaqMan HCV Test (v 2.0).

FIG. 47 provides a linear regression analysis for target and achieved frozen plasma samples.

FIG. 48 provides a probit analysis for HCV LOD/LOQ Studies.

FIG. 49 illustrates 1.0 mL loaded on 3 matrixes. Picture taken at time of loading demonstrating that all matrixes completely absorbed all material.

FIG. 50 illustrates 1.0 mL, 1.5 mL, and 2.0 mL loaded. Picture taken at time of loading. With 1.5 mL it was observed that specimen was not completely absorbed and liquid pooled in the inner rim of the inverted cap. With 2.0 mL it was observed that specimen was not completely absorbed and liquid flowed over the inner rim of the inverted cap and pooled in the outer rim of the inverted cap.

FIG. 51 illustrates 1.0 mL, 1.5 mL, and 2.0 mL loaded. Picture taken 30 minutes after loading. With 1.5 mL it was observed that all specimens were completely absorbed by the matrix. With 2.0 mL it was observed that specimen was not yet completely absorbed and liquid still pooled in the outer rim of the inverted cap.

FIG. 52 illustrates 1.0 mL, 1.5 mL, and 2.0 mL loaded. Picture taken after drying overnight. All matrixes were dried. With 1.5 mL matrix it was observed that all specimens were completely absorbed by the matrix and dried. With 2.0 mL it was observed that the matrix did not absorb all specimens and dried specimen was visible in the outer rim of the inverted cap.

FIG. 53 provides a box plot of results of HIV-1 concentration study using the Abbott REALTIME HIV-1 Assay.

FIG. 54 provides a scatter plot of Samples (n=180) processed through the ViveST device of the invention using the Abbott REALTIME HCV Assay.

FIG. 55 provides a regression analysis for samples processed through the ViveST devices of the invention and the frozen plasma sample using the Abbott REALTIME HBV Assay.

FIG. 56 provides a linear regression analysis of HBV 60-day stability studies at ambient storage conditions using the Abbott REALTIME HBV assay for samples processed through the ViveST device of the invention.

FIG. 57 provides comparisons of target and actual titers in the 60-day stability studies at ambient storage conditions using the Abbott REALTIME HBV Assay.

FIG. 58 provides a linear regression analysis for target and achieved frozen plasma samples.

FIG. 59 provides a probit analysis for HBV LOD/LOQ studies.

### DETAILED DESCRIPTION OF THE INVENTION

The invention may be understood more readily by reference to the following detailed description of the preferred embodiments of the invention and the Examples included herein. However, before the present devices, materials, and methods are disclosed and described, it is to be understood that this invention is not limited to specific embodiments of the devices, materials and methods, as such may, of course, vary, and the numerous modifications and variations therein will be apparent to those skilled in the art. It is also to be understood that the terminology used herein is for the purpose of describing specific embodiments only and is not intended to be limiting.

The invention provides a device and method for collection, storage and transportation of a liquid suspension of a biological specimen containing an analyte of interest. More particularly, the present invention provides a device and method for collection, storage and transportation of a liquid suspension containing a biological specimen in a dry state that is convenient and simple to use. As used herein, the terms “a” or “an” mean one or more than one depending upon the context in which they are used. For example, “an analyte” in a sample refers to a particular type of analyte of interest (e.g., such as intact HCV or HIV RNA), of which there may be numerous copies within the sample. Where a sample is referred to as containing an analyte, it is understood that the sample may contain many other types of analytes of interest also.

According to the invention, the time period for which biological specimen may be preserved may be as short as the time necessary to transfer a sample of biological specimen from a collection source to the place where subsequent analysis is to be performed. Therefore, the invention provides that such preservation can occur for a period of several minutes, hours, days, months, or greater. The temperature conditions under which a biological specimen may be stored in the device provided by the invention are not limited. Typically, samples are shipped and/or stored at ambient or room temperature, for example, from about 15° C. to about 40° C., preferably about 15° C. to 25° C. In another embodiment the samples may be stored in a cool environment. For example, in short-term storage, the samples can be refrigerated at about 2° C. to about 10° C. In yet another example, the samples may be refrigerated at about 4° C. to about 8° C. In another example, in long-term storage, the samples can be frozen at about −80° C. to about −10° C. In yet another example, the samples can be frozen from about −60° C. to about −20° C. In addition, the device may preferably but not necessarily be stored in dry or desiccated conditions or under an inert atmosphere.

In certain embodiments, the invention provides a device comprising a first enclosed container defining an interior space having side walls, a bottom and an openable and sealable lid or cap with an absorbent three-dimensional hydrophobic polyolefin fiber matrix disposed inside the first enclosed container. The invention can further comprise a second container with a syringe barrel-shape or any other suitable shape, and a plunger contained therewith, wherein the matrix can be placed therein for compression and release of the analyte of interest. In certain embodiments, the matrix can be loaded with a biological specimen and dried, and placed into a single container which serves both a protective, dry transportation vessel and is configured for compression of the reconstituted matrix for release of the analyte of interest.

The shape of the first or second container is not limited, but can be cylindrical, rectangular, or tubular for example. Materials for construction of the containers are not limited, but can be plastic, metal foil, laminate comprising metal foil, metallized film, glass, silicon oxide coated films, aluminum oxide coated films, liquid crystal polymer layers, and layers of nano-composites, metal or metal alloys, acrylic, and amorphous carbon for example. In certain embodiments, the invention provides a first enclosed container having a threaded screw cap. In other embodiments, the lid or cap can remain attached to the first enclosed container such as a flip-top fashion. In yet other embodiments, the lid or cap may also be cork-like or any other openable configuration. The lid or cap can also provide an air-tight seal when the first enclosed container is closed.

The device also comprises a hydrophobic polyolefin fiber matrix for retaining the biological specimen, drying the analyte of interest therein, reconstitution and release of the analyte. In certain embodiments, the hydrophobic matrix is made from polyolefin fibers that can be quality-controlled during manufacturing. As used herein, the term “polyolefin fiber matrix” refers to a fiber matrix made of at least one type polyolefin polymer produced from a simple olefin (also called an alkene with the general formula CₙH₂ₙ) as a monomer. The term “hydrophobic” polyolefin surface is used to describe a polyolefin surface that generally repels water or resists wetting, for example, as would result from minimal or substantially absent hydrogen bonding or other chemical bonding interactions between the polyolefin surface and water molecules. A hydrophobic polyolefin surface generally lacks the molecular entities or substituents to interact with the polar solvents, in particular water, or with other polar groups. In one aspect, the hydrophobicity of a polyolefin surface can be quantified by the contact angle, θ_{C}, which is the angle between the polyolefin surface and the tangent to the water surface at the contact point, that is, where the water/air (or water/vapor) interface meets the polyolefin surface. For example, the polyolefin surface can be considered “hydrophobic” if the water contact angle is greater than about 85°. In another aspect, the polyolefin surface can be considered “hydrophobic” if the water contact angle is greater than about 90°; alternatively, greater than about 95°; alternatively, greater than about 100°; alternatively, greater than about 105°; alternatively, greater than about 110′; alternatively, greater than about 115′; or alternatively, greater than about 120°.

In certain embodiments, the hydrophobic polyolefin fiber matrix comprises fibers that have a hydrophobic first polyolefin, such as polyethylene surface. In certain embodiments the surface can be a coating or sheath substantially disposed on a core of a second polyolefin, such as polypropylene. The relative amounts of each polymer can range from 10%-90% polyethylene and 10%-90% polypropylene, and in some embodiments about 50% polyethylene and about 50% polypropylene by weight. The hydrophobic polymer fibers are bound together and shaped as is known in the art and commercially available, such as from Filtrona Porous Technologies, with pore sizes ranging from 2 microns to 100 microns.

In certain embodiments, the hydrophobic polyolefin matrix of the invention is an absorbent material to which the liquid suspension of biological specimen containing analytes of interest will be retained and which does not inhibit evaporation of the solvent (e.g., water or other fluids) for storage or subsequent reconstitution and analysis of the analytes of interest applied thereto. The matrix of the invention comprises hydrophobic polyolefin surfaces of a porous nature to provide entrainment of the liquid suspension in the matrix. As used herein, the term “entrain” and derivatives thereof means that the liquid suspension of a polar solvent and analytes can be temporarily entrapped within the interstices, or pores, of the matrix without substantial reliance on chemical and/or physical interactions such that a polar solvent like water can evaporate and leave the suspended analytes remaining in the matrix.

A matrix suitable for this purpose includes, but is not limited to, a matrix that comprises or is composed of hydrophobic polyolefin homopolymers and copolymers. Particularly suited are polymers of ethylene alone, combined or copolymerized with an alpha-olefin polymer. Examples of the alpha-olefin polymer include, but are not limited to, propylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-hexene, 3-ethyl-1-hexene, 1-heptene, 2-heptene, 3-heptene, the four normal octenes, the four normal nonenes, or the five normal decenes. In another aspect, the alpha-olefin polymer may be selected from 1-butene, 1-pentene, 1-hexene, 1-octene, 1-decene, or styrene. In certain embodiments, the hydrophilic olefin polymers form the core, and hydrophobic polymers such as made with polyethylene form the outer sheath surface of each strand of the polyolefin fiber matrix of the invention.

Any ratio of polymers can be employed to prepare the suitable polyolefin polymer matrix for use herein. For example, ethylene can be used from about 5 to about 95 mole percent for the outer sheath surface of each strand, and any of the suitable monomers can constitute the balance of the mole percent of the alpha olefins for the core of each strand. Thus, ethylene can be used from about 5, 10, 15, 20, 25, 30, 35, 40, 45, 50, 55, 60, 65, 70, 75, 80, 85, 90, or 95 mole percent to prepare suitable material, with any of the suitable monomers can constitute the balance of the mole percent of the alpha olefins. Alternatively, ethylene can be used from about 5 to about 95 mole percent, about 15 to about 85 mole percent, or about 25 to about 75, about 35 to about 65, or about 45 to about 55 mole percent, with any of the suitable monomers making up the balance of the mole percent of the alpha olefins. In certain embodiments, polyethylene is used for the outer sheath surface, and polypropylene is used for the core, of each strand within the polyolefin fiber matrix of the invention. Polyolefin polymers can be low density or high density, highly branched or substantially unbranched, and the like, as long as the polymer can withstand the methods used to prepare and use the disclosed devices and methods. In certain embodiments, the density of the resulting polyolefin fiber matrix of the invention is about 0.077 grams/cc.

Thus, the polyolefin fiber matrix of the invention has an ability to absorb a liquid suspension readily and quickly, as well as to release the biological specimen containing analytes of interest consistently, efficiently, and precisely. In certain embodiments, the polyolefin fiber matrix can absorb at least 0.05 ml, 0.1 ml, 0.2 ml, 0.3 ml, 0.4 ml, 0.5 ml, 0.6 ml, 0.7 ml, 0.8 ml, or 0.9 ml, 1.0 ml, 1.5 ml, 2.0 ml, 2.5 ml, 3.0 ml, or greater, sample of a liquid suspension of a biological specimen containing an analyte of interest. The term “absorb” and “adsorb” are used interchangeably, and means that the liquid suspension is incorporated into or onto the polyolefin fiber matrix in such a way as to be readily removed from the matrix leaving the analytes of interest behind.

The volume of the polyolefin matrix may or may not expand upon absorption of the liquid suspension, and may or may not contract upon drying. However, a liquid saturated matrix can be compressed to release entrained fluid containing analyte, due to its porosity, by at least about 10%, 20%, 30%, 40%, 50%, 60%, 70%, 75%, 80%, 90%, or more of its saturated volume. Volumetric compression is one convenient technique for release of the reconstituted biological specimen, however, any other means, such as centrifugation or vacuum pressure, can alternatively be employed to release the biological specimen from the matrix.

Therefore, as used herein, the term “compress,” “compressable,” “compression,” and other derivatives of the word “compress” means that the volume of the saturated matrix is reduced as compared to the original volume of the saturated matrix while a force or a pressure is applied to the matrix. As used herein, the term “a portion of the biological specimen” means at least some of the biological specimen contained in the liquid suspension is released from the matrix. In certain embodiments, the matrix is compressed until the maximum volume of the reconstituted biological specimen is released from the matrix.

In certain embodiments, the polyolefin fiber matrix is three-dimensional in a shape such as cylinder, cube, sphere, pyramid or cone. In certain embodiments, the matrix is in the shape of a cylinder about 21 mm in length and 9 mm in diameter, with a weight of about 0.103 grams. However, the matrix can be widened, lengthened, or shortened to achieve any needed volume capacity. Polyolefin fiber sizes can vary, but are generally about 1-100μ or 20-25 microns.

In certain embodiments, for reconstitution and recovery of the analytes the matrix is mounted or placed within a container or syringe barrel into which is received a plunger, wherein the matrix is compressed by applying force to the plunger against the matrix to release reconstituted biological suspension through a port for example. In yet other embodiments, the matrix can be removable from the enclosed container and the plunger. As used herein, the term “removable” means that the matrix can be detached or separated from the container and the plunger.

As used herein, the term “liquid suspension” refers to any liquid medium and mixture containing biological specimens. This includes, for example, water, saline; cell suspensions of humans, animals and plants; extracts or suspensions of bacteria, fungi, plasmids, viruses; extracts or suspensions of parasites including helminthes, protozoas, spirochetes; liquid extracts or homogenates of human or animal body tissues, e.g., bone, liver, kidney, brain; media from DNA or RNA synthesis; mixtures of chemically or biochemically synthesized DNA or RNA, and any other sources in which any biological specimen is or can be in a liquid medium.

As used herein, the term “biological specimen” refers to samples, either in liquid or solid form, having dissolved, suspended, mixed or otherwise contained therein, any analytes of interest, for example, genetic material. As used herein, the term “genetic material” refers to nucleic acids that include either or both deoxyribonucleic acid (DNA) or ribonucleic acid (RNA). The term “biological specimen” also refers to whole blood, plasma, serum lymph, synovial fluid, bone marrow, cerebrospinal cord fluid, semen, saliva, urine, feces, sputum, vaginal lavage, skin scrapings, hair root cells, or the like of humans or animals, physiological and pathological body liquids, such as secretions, excretions, exudates and transudates; any cells or cell components of humans, animals, plants, bacteria, fungi, plasmids, viruses, parasites, or the like that contain analytes of interest, and any combination thereof.

As used herein, the term “analytes of interest” refers to any micro- or macro-molecules in the biological specimen that are interested to be detected or analyzed. These include, for example, nucleic acids, polynucleotides, oligonucleotides, proteins, polypeptides, oligopeptides, enzymes, amino acids, receptors, carbohydrates, lipids, cells, any intra- or extra-cellular molecules and fragments, virus, viral molecules and fragments, or the like. In certain embodiments, the analytes of interest are nucleic acids including either or both DNA or RNA. As used herein, the term “nucleic acids” or “polynucleotide” refers to RNA or DNA that is linear or branched, single or double stranded, a hybrid, or a fragment thereof. The term also encompasses RNA/DNA hybrids. The term also encompasses coding regions as well as upstream or downstream noncoding regions. In addition, polynucleotides containing less common bases, such as inosine, 5-methylcytosine, 6-methyladenine, hypoxanthine, and other are also encompassed. Other modifications, such as modification to the phosphodiester backbone, or the 2′-hydroxy in the ribose sugar group of the RNA are also included. The nucleic acids/polynucleotides may be produced by any means, including genomic preparations, cDNA preparations, in vitro synthesis, RT-PCR, and in vitro or in vivo transcription. In certain embodiment, the nucleic acids are either or both viral DNA or RNA, for example, DNA or RNA from human immunodeficiency virus (HIV), hepatitis B virus (HBV), hepatitis C virus (HCV), or any other human or animal viral pathogen.

In certain embodiments, the compression device provided by the present invention may optionally include a desiccant, either a natural or synthetic desiccant, inside the container to maintain the dried state of the matrix and integrity of the analytes of interest on the matrix within the enclosed container. In certain embodiments, the desiccant is in vaporous communication with the matrix in the compression device having a dye indicator reactive with moisture whereby the desiccant changes to a bright color when exposed to humidity or moisture. In certain embodiments, the desiccant is in vaporous communication with the matrix so that an air permeable barrier is formed in-between the desiccant and the matrix inside the container. The desiccant used in the device is commonly known in the art, including but is not limited to montmorillonite clay, lithium chloride, activated alumina, alkali alumino-silicate, DQ11 Briquettes, silica gel, molecular sieve, calcium sulfate, and calcium oxide. The desiccant can be provided with a colorimetric indicator of water content. A desiccant may not be needed inside the device with the hydrophobic polyolefin fiber matrix of the invention.

The polyolefin fiber matrix of the invention may optionally include a composition absorbed to the matrix wherein the composition protects against degradation of the analytes of interest contained in the biological specimens. As used herein, the term “protects against degradation of the analytes of interest” means that a matrix in the device of the invention maintains the stored analytes of interest contained in the biological specimens in a substantially nondegraded form, providing that the analytes of interest are suitable for many different types of subsequent analytical procedures. Protection against degradation may include protection against substantial damaging of analytes of interest caused by chemical or biological agents including action of bacteria, free radicals, nucleases, ultraviolet radiation, oxidizing agent, alkylating agents, or acidic agents (e.g., pollutants in the atmosphere). In certain embodiments, the composition absorbed on the matrix of the invention may include one or more of a weak base, a chelating agent, a protein denaturing agent such as a detergent or surfactant, a nuclease inhibitor, and a free radical trap. In the case where the stored analyte of interest is RNA, particularly unstable RNA, the composition may include RNase inhibitors and inactivators, genetic probes, complementary DNA or RNA (or functionally equivalent compounds), proteins and organic moieties that stabilise RNA or prevent its degradation.

Another composition which protects against degradation which may be optionally used is an oxygen scavenger element. As used herein, the term “oxygen scavenging element” refers to is a substance that consumes, depletes or reduces the amount of oxygen from a given environment without negatively affecting the samples of interests. Suitable oxygen scavenging elements are well-known to those skilled in the art. Non-limiting examples of oxygen scavenging elements include but are not limited to compositions comprising metal particulates reactive with oxygen such as transition metals selected from the first, second or third transition series of the periodic table of the elements, and include manganese II or III, iron II or III, cobalt II or III, nickel II or III, copper I or II, rhodium II, III or IV, and ruthenium. The transition metal is preferably iron, nickel or copper. An example of an iron oxygen scavenging element is D500 from Multisorb. Other commercially available oxygen scavengers may also be purchased from companies such as Mitsubishi, Dow, or the like. Other examples of oxygen scavenging element may be enzymes which consumes, depletes or reduces the amount of oxygen from the given environment without negatively affecting the samples of interests.

In other embodiments, the compression device may optionally comprise a modified atmosphere such as nitrogen or argon through a well-known gas purging process prior to sealing, shipping, or storing. The term “modified atmosphere” refers to any replacing or altering normal atmospheric gas compositions with at least one inert gas or gas which does not degrade the sample of interests.

As used herein, a “weak base” suitable for the composition of the invention may be a Lewis base which has a pH of about 6 to 10, preferably about pH 8 to 9.5. The weak base suitable for the composition of the invention may, in conjunction with other components of the composition, provide a composition pH of 6 to 10, preferably, about pH 8.0 to 9.5. Suitable weak bases according to the invention include organic and inorganic bases. Suitable inorganic weak bases include, for example, an alkali metal carbonate, bicarbonate, phosphate or borate (e.g., sodium, lithium, or potassium carbonate). Suitable organic weak bases include, for example, tris-hydroxymethyl amino methane (Tris), ethanolamine, triethanolamine and glycine and alkaline salts of organic acids (e.g., trisodium citrate). A preferred organic weak base is a weak monovalent organic base, for example, Tris. The weak base may be either a free base or a salt, for example, a carbonate salt. It is believed that the weak base may provide a variety of functions, such as protecting the analytes of interest from degradation, providing a buffer system, ensuring proper action of the chelating agent in binding metal ions, and preventing the action of acid nucleases which may not be completely dependent on divalent metal ions for functioning.

As used herein, a “chelating agent” is any compound capable of complexing multivalent ions including Group II and Group III multivalent metal ions and transition metal ions (e.g., Cu, Fe, Zn, Mn, etc). In certain embodiments, the chelating agent is ethylene diamine tetraacetic acid (EDTA), citrate or oxalate. It is believed that one function of the chelating agent is to bind multivalent ions which if present with the stored biological specimen may cause damage to the analytes of interest, especially to nucleic acids. Ions which may be chelated by the chelating agent include multivalent active metal ions, for example, magnesium and calcium, and transition metal ions, for example, iron. Both calcium and magnesium are known to promote nucleic acid degradation by acting as co-factors for enzymes which may destroy nucleic acids (e.g., most known nucleases). In addition, transition metal ions, such as iron, may readily undergo oxidation and reduction and damage nucleic acids by the production of free radicals or by direct oxidation.

The composition can further include a protein denaturing agent if the analytes of interest are nucleic acids. As used herein, a “protein denaturing agent” functions to denature non-nucleic acids compounds, for example, nucleases. If the protein denaturing agent is a detergent or a surfactant, the surfactant may also act as a wetting agent to facilitate the uptake of a sample by the dry solid matrix. The terms “surfactant” and “detergent” are synonymous and may be used interchangeably throughout the specification. Any agent that denatures proteins without substantially affecting the nucleic acids of interest may be suitable for the invention. In certain embodiments, protein denaturing agents include detergents. As used herein “detergents” include ionic detergents, preferably anionic detergents. An anionic detergent suitable for the invention may have a hydrocarbon moiety, such as an aliphatic or aromatic moiety, and one or more anionic groups. Particularly, suitable anionic detergents include sodium dodecyl sulphate (SDS) and sodium lauryl sarcosinate (SLS). The ionic detergent causes inactivation of a microorganism which has protein or lipid in its outer membranes or capsids, for example, fungi, bacteria or viruses. This includes microorganisms which may be pathogenic to humans or which may cause degradation of nucleic acids. It is believed that inactivation of a microorganism by a detergent is a result of destruction of the secondary structure of the organisms external proteins, internal proteins, protein containing membranes, or any other protein necessary for viability. However, the detergent may not inactivate some forms of organisms, for example, highly resistant bacterial spores and extremely stable enteric virions.

The composition may optionally include a free radical trap. As used herein, a “free radical trap” is a compound which is sufficiently reactive to be preferred, over a DNA molecule or a component thereof, as a reactant with a free radical, and which is sufficiently stable not to generate damaging free radicals itself. Examples of a suitable free radical trap include: uric acid or a urate salt, mannitol, benzoate (Na, K, Li or tris salt), 1-3 dimethyl uric acid, guanidine, guanine, thymine, adenine, cytosine, in N-acetyl-histidine, histidine, deferoxamine, dimethyl sulfoxide, 5′5′ dimethyl pyrroline-N-oxide, thiocyanate salt and thiourea. Suitable free radical traps include mannitol, thiocyanate salts, uric acid or a urate salt. It is believed that the longer the period of time for which the nucleic acid is to be stored the more likely that a free radical trap may be advantageously included in the composition absorbed to the solid matrix. Even if the nucleic acid is only to be stored for a matter of minutes, a free radical trap may still be incorporated into the composition. It is believed that one function of the free radical trap may be to trap nucleic acid damaging free radicals. For example, when the free radical trap used is uric acid or urate salt it may be converted to allantoin which may also act as a free radical trap that accepts free radicals that would otherwise damage nucleotide bases, for example, guanine. In certain embodiments, the free radical trap reacts with free radicals regardless of source (including free radicals present in the air). Free radicals may be generated through oxidation or reduction of iron in biological specimen, such as blood. Typically, free radicals are believed to be generated by spontaneous oxidation of the groups which are present, for example, in denatured serum protein of blood. Free radicals may also be generated by radiation such as UV light, x-rays and high-energy particles. In addition, free radical traps which are also a weak acid, e.g. uric acid, may also function as a component of the buffering system provided by the weak base discussed above. Also, the free radical trap may enhance removal of a stored sample of nucleic acids if in situ processing is not desired.

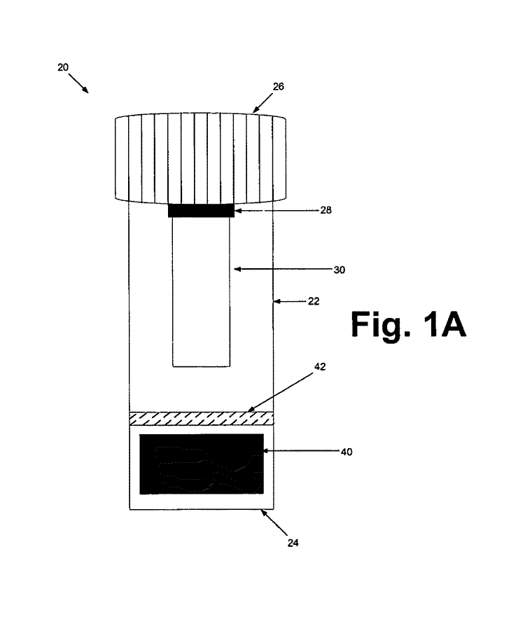

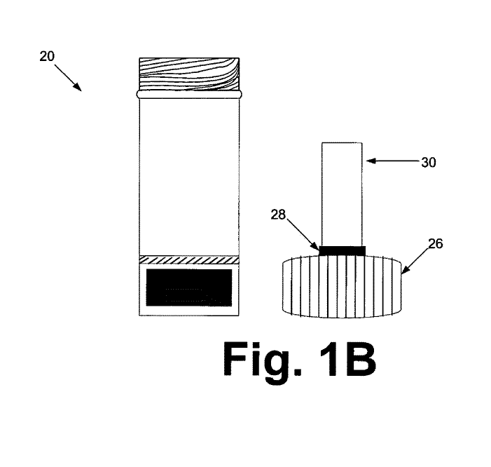

Referring to FIGS. 1A & 1B, an exemplary compression device of the invention for preserving liquid suspension of biological specimen containing analytes of interest is shown. The container 20 is cylindrical and has side walls 22, a bottom 24 and an openable lid 26, which sealingly engages the container 20 opening. The lid 26 has an extension 28 that holds a removable matrix 30 inside the container 20. The polyolefin fiber matrix 30 is a cylinder capable of absorbing 1 ml of a liquid suspension of a biological specimen and compress by at least 50% of the volume of the saturated matrix to release a portion of the biological specimen. A desiccant 40 may be optionally placed inside the container 20, separated with the matrix 30 by an optional air permeable barrier 42, for in vaporous communication with the matrix 30 to control humidity or moisture therein.

The invention further provides a method for preserving and recovering a biological specimen comprising: (a) providing a dried biological specimen in a device comprising a container defining an interior space having side walls, a bottom and an openable and sealable lid with an absorbent three-dimensional polyolefin matrix mounted inside the container, wherein the polyolefin matrix comprises a plurality of interstices with a hydrophobic polyolefin surface and has contained therein the dried biological specimen obtained from an evaporated volume of at least 0.1 ml of a liquid suspension comprising a solvent and the biological specimen absorbed and dried on the matrix; (b) reconstituting the biological specimen on the polyolefin matrix with a controlled volume of a reconstitution media; and (c) removing the biological specimen and reconstitution media from the polyolefin matrix by compressing the matrix. Any suitable and/or commonly available drying methods, such as vacuum dry, low heat dry, low pressure dry, and fan dry, can be used in the inventive method.

In certain embodiments, the polyolefin matrix comprises a plurality of fibers having a substantially hydrophobic surface. In certain embodiments, the fibers within the polyolefin matrix have a polyethylene surface. In other embodiments, the fibers within the polyolefin matrix comprise polypropylene coated with polyethylene. In certain embodiments, the polypropylene and polyethylene are present in approximately equal amounts in each fiber strand.

Referring to FIG. 1B, the lid 26 of the container 20 has a lid extension 28 holding a polyolefin fiber matrix 30 which may be permanently mounted in a cup that is attached to a plunger contained within the second enclosed container. A liquid suspension of any biological specimen containing analytes of interest is added on the top of the polyolefin fiber matrix 30 and is allowed to fully absorb into the matrix 30 (FIG. 3). The lid 26 with the matrix 30 having bound biological specimen thereon is allowed to air-dry, and then reassembled with the container 20 for preservation at ambient temperature.

The method of the invention further optionally includes an intermediate step of applying a stabilizing composition to the polyolefin fiber matrix to protect the analytes of interest against degradation. Depending upon the analytes of interest, the stabilizing composition, as discussed above, may include but is not limit to one or more of a weak base, a chelating agent, a protein denaturing agent such as a detergent or surfactant, a nuclease inhibitor, and a free radical trap. Particularly for protection of unstable RNA, the stabilizing composition may include RNase inhibitors and inactivators, genetic probes, complementary DNA or RNA (or functionally equivalent compounds), proteins and organic moieties that stabilise RNA or prevent its degradation.

The invention further provides a method for recovering from the polyolefin fiber matrix in the compression device the biological specimen containing analytes of interest. In certain embodiments, the method includes the following steps: a) applying reconstitution medium to the matrix to rehydrate the bound biological specimen containing analytes of interest, and b) compressing the matrix to release a portion of the biological specimen. According to the present invention, the reconstitution medium is molecular-grade water. In other embodiments, the reconstitution medium includes the components of 1× phosphate buffered saline (PBS) or nuclease-free water optionally with the addition of sodium azide or other antimicrobial agent. The reconstitution medium may also include any number or combinations of available biological preservatives or blood anticoagulants including but not limited to ethylenediaminetetraacetic acid (EDTA), sodium citrate, and heparin. PBS or nuclease-free water serves as the sterile and neutral medium for the rehydration, resuspension, and recovery of the analyte(s) of interest from the matrix. When included, antimicrobial agents such as sodium azide prevent microbial growth and subsequent contamination with RNases. When included, biological preservatives such as EDTA, sodium citrate, and heparin serve as anticoagulants and or chelating agents.

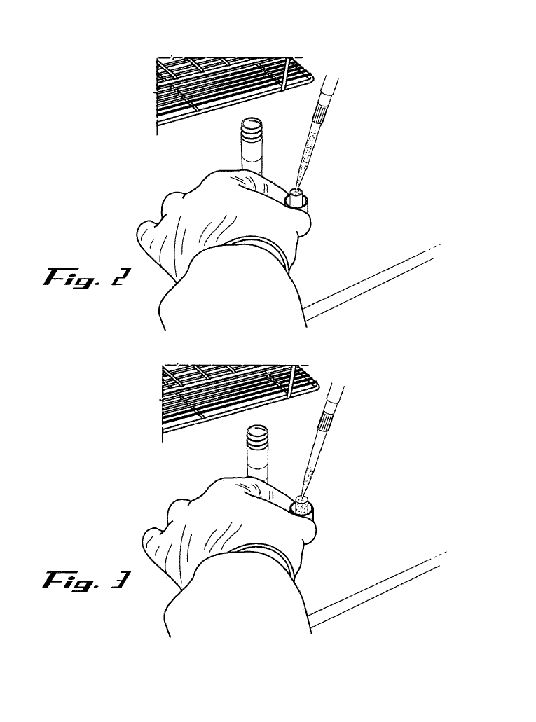

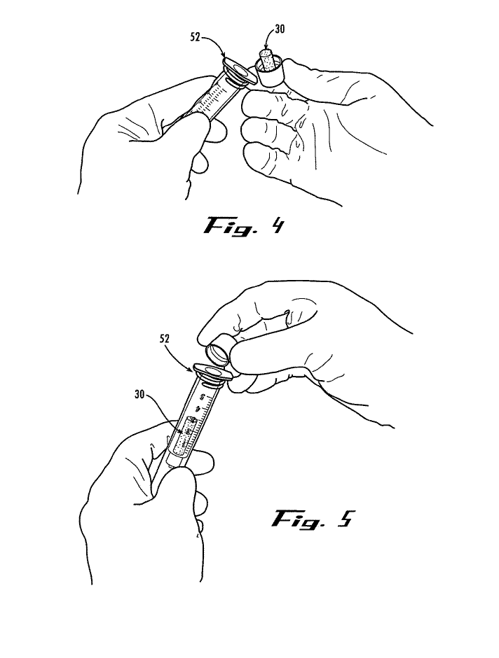

In the embodiments shown in FIGS. 4-7, the biological sample is prepared for analysis. FIG. 4 is a perspective view of preparing to transfer the polyolefin fiber matrix 30 of the device to an empty syringe barrel 52. FIG. 5 is a perspective view of completed delivery of the polyolefin fiber matrix 30 into the syringe barrel 52.

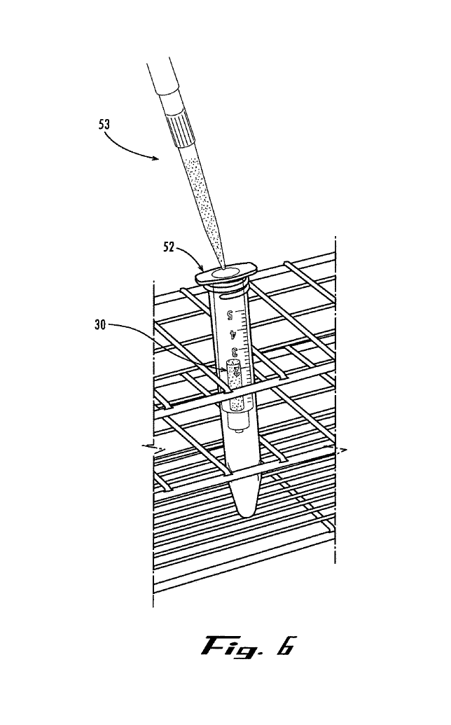

FIG. 6 illustrates rehydration of the polyolefin fiber matrix 30 by a pipette tip 53 gently placed on the top of the matrix 30 and slowly dispensing reconstitution buffer. FIG. 7A illustrates insertion of the plunger 54 into the syringe barrel 54. FIG. 7B illustrates application of pressure to the syringe plunger 42. FIG. 7C illustrates compression of the matrix 30. FIG. 7D illustrates completion of sample recovery from the matrix 30.

In certain embodiments, the analytes of interest are nucleic acids including either or both DNA or RNA molecules. In certain embodiments, the liquid suspension of biological specimen contains at least about 5 attograms or 1 μg isolated DNA or RNA molecules. As used herein, the term “isolated,” “isolation,” and other derivatives of the word “isolate” means that the DNA or RNA molecules are substantially free from some of the other cellular material with which it is naturally associated, or culture medium when produced by recombinant techniques, or chemical precursors or other chemicals when chemically synthesized.

The invention further provides that the analytes of interest contained in the biological specimen recovered from the polyolefin fiber matrix of the device into the reconstitution medium, such as molecular-grade water, are subject to subsequent analysis. As used herein, the term “subsequent analysis” includes any analysis which may be performed on recovered biological specimens stored in reconstitution medium. Alternatively, the analytes of interest contained in the biological specimen may be isolated, purified or extracted prior to analysis using methods known in the art. The analytes of interest may be subjected to chemical, biochemical or biological analysis. In one of the preferred embodiments, the analytes of interest are nucleic acids including either or both DNA or RNA molecules that can be detected or analyzed with or without prior extraction, purification or isolation. DNA or RNA extraction, purification or isolation, if necessary, is performed based on methods known in the art. Examples of subsequent analysis include polymerase chain reaction (PCR), ligase chain reaction (LCR), reverse transcriptase initiated PCR, DNA or RNA hybridization techniques including restriction fragment length polymorphism (RFLP), viral DNA or RNA detection and quantification, viral load tests, DNA or RNA genotyping, etc. “Subsequent analysis” also includes other techniques using genetic probes, genomic sequencing, enzymatic assays, affinity labeling, methods of detection using labels or antibodies and other similar methods.

The invention also provides a kit for preserving a liquid suspension of biological specimen containing analytes of interest. The kit of the invention provides a compression device disclosed herein including one or more containers, one or more polyolefin fiber matrixes, and optionally desiccant, and instructions for the use thereof to preserve biological specimens. The kit may optionally include a stabilising solution. Kits of the invention can further include a reconstitution medium, a compression device and further protocols for rehydration and recovery of the biological specimen. The container of the kit may be any container suitable for use during application of a liquid suspension of biological specimen containing analytes of interest to the matrix or during application and one or more phases of subsequent processing of a sample of the biological specimen. Therefore, in certain embodiments, a liquid suspension of biological specimen may be applied, stored, transported and further processed all in the same kit. Alternatively, a liquid suspension may be applied to the matrix where the matrix is removed from the kit container for processing in a different container.

The kit may also include one or more of any of the polyolefin fiber matrix disclosed herein. This includes one or more polyolefin fiber matrix with or without compositions for protection of analytes of interest contained in the biological specimen. One aspect of the kit of the invention is that the reconstituted biological specimen containing analytes of interest is released by compressing the matrix. This procedure avoids vortexing and centrifuging the sample, providing decreased chance of sample damage, human labor costs and matrix contamination of the sample. A compression device of the kit of the present invention may be any device that is used to provide a force or pressure on the matrix to compress it. In certain embodiments, the compression device comprising a plunger permanently attached to the polyolefin fiber matrix, wherein the matrix is compressed by applying force to the plunger against the matrix in the same kit container(s) where biological specimens are prepared and stored in. Alternatively, the compression device comprises a syringe separate from the polyolefin fiber matrix, wherein the matrix is removed from the container and placed in the syringe barrel and the force or pressure is applied to the plunger of the syringe to compress the matrix to release the reconstituted biological specimen.

Throughout this application, various publications are referenced. The disclosures of all of these publications and those references cited within those publications in their entireties are hereby incorporated by reference into this application in order to more fully describe the state of the art to which this invention pertains.

It should also be understood that the foregoing relates to certain embodiments of the present invention and that numerous changes may be made therein without departing from the scope of the invention. The invention is further illustrated by the following examples, which are not to be construed in any way as imposing limitations upon the scope thereof. On the contrary, it is to be clearly understood that resort may be had to various other embodiments, modifications, and equivalents thereof, which, after reading the description herein, may suggest themselves to those skilled in the art without departing from the spirit of the present invention and/or the scope of the appended claims.

### EXAMPLES

### Example 1

### One (1.0) ml Sample Preparation and Device Recovery Kit

### Kit Components:

This example provides a kit for the preparation, transportation, and recovery of thirty-six (36) dry biological specimens from bodily fluids or tissue. Materials and reagents for the preparation and recovery of thirty-six (36) one (1.0) ml samples for dried ambient transportation include the following:

| Component | Quantity |
|---|---|
| Device Kit containers (tubes) | 36 each |
| Reconstitution Buffer | 3 × 13 ml |
| Disposable 3 ml Syringes | 36 each |
| 15 ml Conical Centrifuge Tubes | 36 each |

### Storage and Handling:

Upon receipt, all kit components are stored dry at room temperature (15-25° C.). Only use device container tubes when the indicating desiccant is blue in color. The device kit container tubes should not be if the indicating desiccant appears white or pink in color. Materials, such as 1000 μl pipette, 1000 μl sterile DNase-free, RNase-free pipette tips with aerosol barrier, rack for holding 15 ml conical tubes, safety glasses, laboratory coat, powder-free disposable gloves and biohazard waste container, are also required but are not provided by the kit Safety Precautions: Disposable powder-free gloves are used to handle all materials as though capable of transmitting infectious agents. Utilise good laboratory practices and universal precautions relating to the prevention of transmission of blood borne pathogens (Centers for Disease Control. Update: Universal precautions for prevention of transmission of human immunodeficiency virus, hepatitis B virus and other blood borne pathogens in healthcare settings. MMWR, 1988; 37: 377-82, 387-8; National Committee for Clinical Laboratory Standards. Protection of laboratory workers from infectious disease transmitted by blood, body fluids, and tissue; approved guideline. NCCLS Document M29-A Villanova (PA): NCCLS; 1997 December 90p; Federal Occupational Safety and Health Administration. Bloodborne Pathogens Standard, 29 CFR 1910, 1030). Any spills suspected of potentially containing infectious agents were immediately cleaned up with 0.5% w/v sodium hypochlorite (10% v/v bleach). Dispose of all specimens and materials coming into contact with specimens as though they contain infectious agents. In the event that materials known or suspected of containing infectious agents are ingested or come in contact with open lacerations, lesions, or mucous membranes (eyes, nasal passages, etc.), consult a physician immediately.

### Example 2

### Sample Preparation Using the Device Kit

The sample preparation steps were performed within a biological safety cabinet using sterile technique and universal precautions relating to the handling of potentially infectious materials. Before beginning the sample preparation process, the protocol of using the device kit that is illustrated in FIGS. 1A & 1B should be familiarized.

Before loading a sample liquid suspension of biological specimen containing analytes of interest, the cap from the device container was unscrewed, inverted and placed on a clean working surface with the absorbent matrix facing upwards (FIGS. 1A & 1B). About up to 1 ml of sample fluid was slowly added to the top of the matrix plug and allowed it to fully absorb into the matrix. The device kit matrix loaded with the sample fluid was allowed to air-dry. In general, air-drying within a biological safety cabinet takes approximately 4.5 to 5 hours. Once the sample is completely dry, the cap holding the dried specimen-containing matrix was carefully reattached back to the device kit container tube. The specimen is now ready for shipment or storage at ambient temperature.

### Example 3

### Sample Recovery Using the Device Kit

The sample recovery steps were also performed within a biological safety cabinet using sterile technique and universal precautions relating to the handling of potentially infectious materials. Basically, a sterile 3 or 5 ml disposable LUER-LOK syringe (provided by the kit) was inserted into a 15 ml collection tube (also provided by the kit). The plunger was removed from the syringe barrel. The absorbent matrix containing the dried specimen was transferred into the syringe barrel by pressing the matrix against the sterile inside of the syringe barrel's mouth with just enough pressure to break it free from the attached cap and allow it to fall freely to the bottom of the syringe (FIGS. 4 & 5). The syringe barrel with detached matrix plug was placed into a 15 ml conical collection tube, which is further placed into a rack. About 1 ml of Reconstitution Buffer (supplied by the kit) was applied slowly and directly to the top of the matrix plug to gently re-hydrate the dried specimen absorbed inside the matrix (FIG. 6). It is necessary to inspect the absorption rate and adjust the application speed as needed while adding the reconstitution buffer, and try not to allow buffer to collect at the bottom of the syringe without first being absorbed into the matrix because failing to fully absorb the reconstitution buffer may result in lower recovery yields. The re-hydrating specimen was allowed to incubate for at least 10 minutes at room temperature prior to adding an additional 175 μl of Reconstitution Buffer to the top of the matrix plug.

The syringe plunger was re-inserted into the syringe barrel and depressed with firm even pressure until the plunger has completely compressed the matrix plug and a maximum volume of approximately 1 ml is collected inside the 15 ml collection tube (FIG. 7A, 7B, 7C, & 7D). The syringe barrel, the plunger and the compressed matrix plug were then removed from the 15 ml collection tube and discarded into an appropriate waste receptacle. The 15 ml collection tube containing the newly recovered specimen was sealed with the provided screw cap. The reconstituted sample is ready for storage, testing, or further subsequent analysis.

### Example 4

### ViveST Device Matrix Comparison Study

### 1. Purpose

The purpose of this study was to compare performance of the ViveST devices with the cellulose matrix to the ViveST devices of the invention with the synthetic hydrophobic polyolefin fiber matrix using the Abbott REALTIME HBV assay. HBV infectious samples (3 levels, 5 replicates each) were loaded and stored for 7 days at ambient conditions on both matrixes. Specimens recovered from the matrixes were run simultaneously with frozen samples.

### 2. Methodology

All testing on the Abbott REALTIME HBV assay was performed according to the FDA approved protocol (0.5 mL) with no modifications. 1 mL HBV infectious plasma was loaded onto each matrix, stored for 7 days at ambient temperature and recovered in 1 mL molecular grade water.

HBV viral load results of frozen samples (3 levels, 5 replicates each) were compared to specimen recovered from the ViveST devices with cellulose matrix and the ViveST devices of the invention having the hydrophobic polyolefin fiber matrix.

### 3. Equipment and Reagents

The following commercially available products/equipments were utilised in the course of this study: ViveST sample storage and transportation devices of the invention (Catalogue No. VST-1E, ViveBio LLC, Alpharetta, Ga.), and the ViveST devices with the cellulose matrix (ViveBio, LLC, Alpharetta, Ga.); BD 3 mL syringe-LUER-LOK Tip: Ref 3096567 (Becton Dickenson; Franklin Lakes, N.J.); General lab consumables and equipment (centrifuge tubes, sterile aerosol resistant pipette tips, pipettes, vortex, centrifuge, etc.; HYCLONE HYPURE molecular biology grade water (Catalogue No.: SH30538.02, HyClone Laboratory Inc., Logan, Utah); Human plasma (Tennessee blood services; Memphis, Term.); Abbott sample preparation system (4×24 Preps), List number: 06K12-024 (Abbott Molecular Inc; Des Plaines, Ill.); Abbott REALTIME HBV AMP kit (Catalogue number: 02N40-90, Abbott Molecular Inc; Des Plaines, Ill.); Abbott REALTIME HBV Control kit (Catalogue number: 02N40-80, Abbott Molecular Inc; Des Plaines, Ill.); Abbott REALTIME HBV Calibration kit (Catalogue number: 02N40-70, Abbott Molecular Inc; Des Plaines, Ill.); Abbott m2000sp System including m2000rt (Abbott Molecular Inc; Des Plaines, Ill.), and associated materials.

### 4. Experimental Design

A high titer HBV infectious plasma sample was diluted in normal human plasma to yield 3 concentrations (˜5 LOG, ˜4 LOG and ˜3 LOG). 5 replicates of each concentration (n=15 total) were loaded onto each of the ViveST devices with the cellulose matrix and the ViveST devices of the invention with the polyolefin fiber matrix. Identical aliquots (3 levels, 5 replicates) were stored frozen (−80° C.). All matrixes were dried overnight in a laminar flow hood, capped the following day and stored at ambient conditions for 7 days. Specimens were recovered from both sets of matrixes and analyzed concurrently with the frozen specimens in a single assay run as outlined in the Abbott REALTIME HBV assay package insert and in accordance with the bioMONTR Research Method (RM-008.00, Quantitation of HBV RNA using the Abbott REALTIME HBV assay).

### 5. Results—A Summary of the Abbott REALTIME HBV Viral Load Results is Provided in Table 1 Below.

TABLE 1
Summary of ViveST Matrix Comparison Study Data

| | | | | Achieved HBV Concentration | | |
|---|---|---|---|---|---|---|
| | | | | (LOG IU/mL) | | |
| | Target HBV | Target HBV | | | 2^{nd} | 1^{st} |
| | Concentration | Concentration | | | Generation | Generation |
| Level | (LOG IU/mL) | (IU/mL) | Replicate | Frozen | Matrix | Matrix |
| 1 | 5.00 | 100,000 | a | 4.94 | 4.93 | 4.69 |
| | | | b | 4.90 | 4.93 | 4.69 |
| | | | c | 5.02 | 4.91 | 4.55 |
| | | | d | 5.00 | 4.89 | 4.73 |
| | | | e | 4.99 | 4.90 | 4.54 |
| | | | Average | 4.97 | 4.91 | 4.64 |
| | | | Std Dev | 0.05 | 0.02 | 0.09 |
| | | | 95% CI | 0.04 | 0.02 | 0.08 |
| 2 | 4.00 | 10,000 | a | 3.96 | 3.86 | 3.76 |
| | | | b | 3.93 | 3.92 | 3.73 |
| | | | c | 3.93 | 3.86 | 3.59 |
| | | | d | 3.88 | 3.86 | 3.80 |
| | | | e | 3.84 | 3.87 | 3.64 |
| | | | Average | 3.91 | 3.87 | 3.70 |
| | | | Std Dev | 0.05 | 0.03 | 0.09 |
| | | | 95% CI | 0.04 | 0.02 | 0.08 |
| 3 | 3.00 | 1,000 | a | 2.81 | 2.90 | 2.78 |
| | | | b | 2.94 | 2.93 | 2.74 |
| | | | c | 2.85 | 2.90 | 2.80 |
| | | | d | 2.97 | 2.87 | 2.67 |
| | | | e | 2.94 | 2.88 | 2.61 |
| | | | Average | 2.90 | 2.90 | 2.72 |
| | | | Std Dev | 0.07 | 0.02 | 0.08 |
| | | | 95% CI | 0.06 | 0.02 | 0.07 |

Results of this example demonstrated an average reduction across all concentrations of: a) 0.03 LOG IU/mL between the frozen plasma and the plasma samples stored on the ViveST devices of the invention with the polyolefin fiber matrix; and b) 0.24 LOG IU/mL between the frozen plasma and the plasma samples stored on the ViveST devices with the cellulose matrix. The Standard Deviations (LOG IU/mL) across all concentrations were: a) <0.07 for the frozen plasma; b) <0.03 for the plasma samples stored on the ViveST devices of the invention with the polyolefin fiber matrix; and c) <0.09 for the plasma samples stored on the ViveST devices with the cellulose matrix.

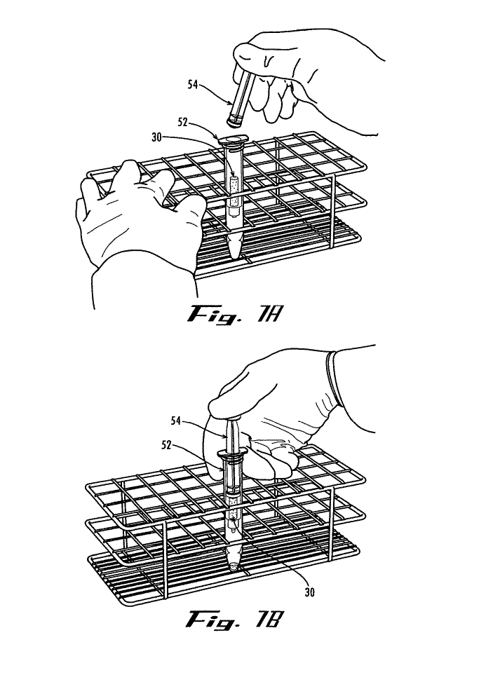

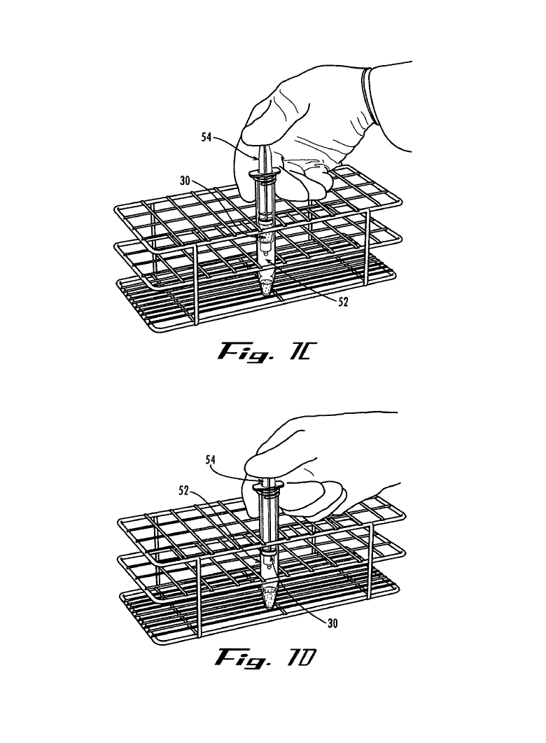

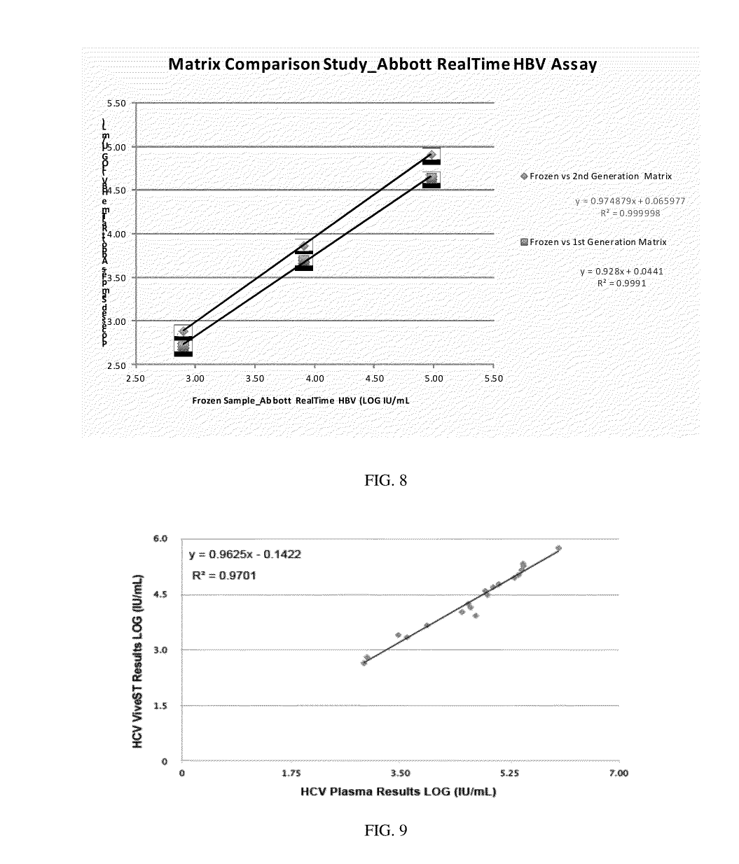

As shown in FIG. 8, the linear regression analysis yielded: a) R²=0.999998 for the frozen plasma as compared to the plasma samples stored on the ViveST devices of the invention with the polyolefin fiber matrix; and b) R²=0.9991 for the frozen plasma as compared to the plasma samples stored on the ViveST devices with the cellulose matrix.

### 6. Final Conclusion

Therefore, this example provides that HBV infectious plasma samples stored on the ViveST devices of the invention with the polyolefin fiber matrix were recovered and yielded results similar to the frozen plasma. There was minimal loss (0.03 LOG IU/mL) when compared to frozen plasmas and very high reproducibility across all concentrations (Std Dev<0.03). In contrast, HBV infectious plasma samples stored on the ViveST devices with the cellulose matrix exhibited greater loss as compared to the frozen plasma (0.24 LOG IU/mL) and a higher variability across all concentrations (Std Dev<0.09).

Therefore, the ViveST devices of the invention with the polyolefin fiber matrix provide better and superior sample recovery and minimized sample loss, as well as providing reproducibility across all concentration, as compared to the devices with the cellulose matrix, suggesting that the polyolefin fiber matrix retains analytes and suspended particles inside the matrix better than the cellulose matrix, and allows the solvents to evaporate more consistently and efficiently.

### Example 5

### Extracted RNA Versus Intact Virus

### 1. Experimental Design

The purpose of this experiment was to evaluate polyolefin matrix ViveST devices' binding and releasing properties of nucleic acid as compared to intact virus. 1 mL aliquots of HCV infectious plasma samples (N=20), stored at −80° C., were used for the study and were designated as follows:

A=RNA was extracted using the EasyMAG system and loaded on the ViveST devices with the cellulose fiber matrix, and then recovered with water and analyzed with the Abbott REALTIME HCV assay;

B=RNA was extracted using the EasyMAG system and loaded on the ViveST devices of the invention with the polyolefin fiber matrix, and then recovered with water and analyzed with the Abbott REALTIME HCV assay;

C=Sample loaded on the ViveST devices with the cellulose fiber matrix, and recovered with water and analyzed with the Abbott REALTIME HCV assay; and

D=Sample loaded on the ViveST devices of the invention with the polyolefin fiber matrix, and recovered with water and analyzed with the REALTIME Abbott HCV assay.

2.1 Procedure—Nucleic acid isolation using EasyMAG followed by processed through either the ViveST devices with the cellulose fiber matrix or the polyolefin fiber matrix.

a). Removed 1 mL plasma aliquots designated as “1A, 2A . . . 20A” and “1B, 2B . . . 20B” from −80° C., thawed at room temperature;

b). Vortexed each sample to ensure adequate mixing;

c). Following the EasyMAG standard nucleic acid extraction protocol, processed the 40 samples +2 negative controls, after extraction, all samples were diluted 1 mL volume using EasyMAG elution buffer;

d). Obtained 42 ViveST devices and labeled the cap of each with the sample designations (i.e., 1A-20A, 1B-20B, neg control—old matrix, neg control—new matrix);

e). Loaded 1 ViveST device for each sample;

f). Dried the loaded matrix in the ViveST devices in a laminar flow hood for at least 12 hours but not more than 36 hours;

g). Recovered samples from the dried ViveST devices using water; and

h). Froze the recovered samples at −80° C. prior to proceeding to the Abbott REALTIME HCV assay.

2.2 Procedure—Sample processed through the ViveST devices with cellulose fiber matrix or the polyolefin fiber matrix

a) Removed 1 mL plasma aliquots designated as “1C, 2C . . . 20C” and “1D, 2D . . . 20D” from −80° C., thawed at room temperature;

b) Vortexed each sample to ensure adequate mixing;

c) Obtained 42 ViveST devices and labeled the cap of each with the sample designations (i.e., 1C-20C, 1D-20D, neg control—cellulose matrix, neg control—polyolefin fiber matrix);

d) Loaded 1 ViveST device for each sample;

e) Dried the loaded matrixes of the ViveST devices in a laminar flow hood for at least 12 hours but not more than 36 hours;

f) Recovered samples from the dried ViveST devices using water; and

g) Froze the recovered samples at −80° C. prior to proceeding to the Abbott's REALTIME HCV assay.

2.3. Procedure—Abbott REALTIME HCV Assay: Processed the samples following the Abbott REALTIME HCV package insert.

### 3. Results: The Results are Provided in the Following Table 2.

TABLE 2

| | Aliquot A | Aliquot B | | Aliquot C | Aliquot D | |
|---|---|---|---|---|---|---|
| | Extracted RNA loaded | Extracted RNA loaded | | Plasma sample loaded | Plasma sample loaded | |
| | on ViveST (old matrix), | on ViveST (new matrix), | | on ViveST (old matrix), | on ViveST (old matrix), | |
| | recovered and analyzed | recovered and analyzed | | recovered and analyzed | recovered and analyzed | |
| | with Abbott RealTime | with Abbott RealTime | Recovery of | with Abbott RealTime | with Abbott RealTime | Recovery of |
| | HCV Assay | HCV assay | Extracted RNA | HCV Assay | HCV Assay | Whole Virus |
| | HCV Results | HCV Results | % Difference | HCV Results | HCV Results | % Difference |
| Sample | LOG (IU/mL) | LOG (IU/mL) | (new vs old) | LOG (IU/mL) | LOG (IU/mL) | (new vs old) |
| Neg | TND | TND | | TND | TND | |
| Control | | | | | | |
| 1 | 3.22 | 2.85** | Not Calculated | 3.72 | 3.69 | −0.81 |
| 3 | 3.71 | 3.84 | 3.39 | 3.86 | 3.63 | −6.34 |
| 5 | 3.56 | 3.69 | 3.52 | 3.45 | 3.72 | 7.26 |
| 7 | 4.02 | 4.32 | 6.94 | 4.22 | 3.70 | −14.05 |
| 8 | 4.22 | 4.48 | 5.80 | 4.30 | 4.15 | −3.61 |
| 9 | 3.42 | 4.14 | 17.39 | 4.17 | 3.91 | −6.65 |
| 10 | 2.01 | 2.40 | 16.25 | 2.73 | 2.36 | −15.68 |
| 11 | 5.24 | 5.31 | 1.32 | 5.23 | 4.96 | −5.44 |
| 12 | 4.24 | 4.55 | 6.81 | 4.58 | 4.17 | −9.83 |
| 13 | Error | 4.09 | Not Calculated | 3.64 | 3.67 | 0.82 |
| 14 | 4.52 | 4.64 | 2.59 | 4.58 | 4.46 | −2.69 |
| 16 | 4.54 | 4.47 | −1.57 | 4.46 | 4.45 | −0.22 |
| 17 | 3.85 | 4.39 | 12.30 | 4.38 | 4.49 | 2.45 |
| 19 | 4.24 | 4.53 | 6.40 | 4.33 | 4.12 | −5.10 |
| 20 | 4.44 | 4.50 | 1.33 | 4.46 | 4.13 | −7.99 |
| 21 | 4.65 | 4.74 | 1.90 | 4.61 | 4.60 | −0.22 |
| 22 | 4.49 | 4.64 | 3.23 | 4.58 | 4.57 | −0.22 |
| 23 | 4.20 | 4.58 | 8.30 | 4.61 | 4.54 | −1.54 |
| 24 | 4.29 | 4.46 | 3.61 | 4.29 | 4.11 | −4.38 |
| 25 | 3.03 | 3.50 | 13.43 | 3.37 | 3.12 | −8.01 |
| Average | 3.99 | 4.28 | 6.62 | 4.18 | 4.03 | −3.75 |

**Sample Error on first m2000 run. The extracted RNA was rerun on the m2000. Data not included in calculations.

### 4. Conclusions

On average, for Extracted RNA, the polyolefin fiber matrix yielded higher recovery than the cellulose matrix (0.29 log IU/mL higher). Near the clinically significant cut-off to support that polyolefin matrix performs better for extracted RNA than the cellulose matrix.

On average, the polyolefin fiber matrix yielded higher recovery for extracted RNA as compared to the fresh plasma (0.25 log IU/mL higher). Near the clinically significant cut-off to support that polyolefin matrix performs better for extracted RNA than the fresh plasma.

Based on these data, the polyolefin fiber matrix is superior as compared to the cellulose matrix for absorption, preservation, stabilisation, and subsequent recovery of nucleic acid. These surprising results are perhaps due to the properties of the embedded hydrophobic pockets within the polyolefin matrix. These pockets may provide a reservoir and ‘safe haven’ for the nucleic acid to reside while excluding the water from the nucleic acid providing a stable environment for the nucleic acid during storage.

### Example 6

### HCV Evaluation for Samples Processed Through the ViveST Devices of the Invention

### 1. Experimental Design

1 ml aliquots of HCV infectious plasma samples (N=19), stored at −80° C., was used for each part of the analysis and was designated as follows:

A=sample analyzed with the Abbott REALTIME HCV assay

B=sample processed through the ViveST devices of the invention with the polyolefin fiber matrix (elute with water) and analyzed with the Abbott REALTIME HCV assay

C=sample analyzed with the Abbott HCV GT assay

D=sample processed through the ViveST devices of the invention with the polyolefin fiber matrix (elute with water) and analyzed with the Abbott HCV GT assay.

Additional aliquots of each plasma sample were maintained at −80° C. for additional testing.

2.1 Procedure—Sample processed through the ViveST devices of the Invention

a) Removed plasma aliquots designated as “1B, 2B . . . 19B” and “1D, 2D . . . 19D” from −80° C., thawed at room temperature;

b) Vortexed each sample to ensure adequate mixing;

c) Obtained 38 ViveST devices of the invention with the polyolefin fiber matrix and labeled the cap of each with the sample designations (i.e., 1B-19B, 1D-19D), obtained 2 additional ViveST devices and labeled each as negative controls;

d) Loaded 1 ViveST device of the invention with the polyolefin fiber matrix for each sample, loaded 1 mL normal (HCV negative) human plasma on the ViveST devices labeled as negative controls;

e) Dried the loaded matrix of the ViveST device in a laminar flow hood for at least 12 hours but not more than 36 hours;

f) Recovered samples from the dried ViveST devices using water; and

g) Froze recovered samples at −80° C.

2.2 Procedure—Abbott m2000 REALTIME HCV assay

a) Removed plasma aliquots designated as “1A, 2A . . . 19A” and the recovered aliquots from the ViveST devices of the invention with the polyolefin fiber matrix as “1B, 2B . . . 19B and Neg Control” from −80° C., thawed at room temperature; and

b) Processed the samples following the Abbott REALTIME HCV package insert.

2.3. Procedure—Abbott m2000 HCV GT Assay

a) Removed plasma aliquots designated as “1C, 2C . . . 19C” and the recovered aliquots from the ViveST device of the invention with the polyolefin fiber matrix as “1D, 2D . . . 19D and Neg Control” from −80° C., thawed at room temperature; and

b) Processed the samples following the Abbott HCV GT package insert.

### 3. Results—A Summary of the Results is Provided in Tables 3 and 4 Below.

TABLE 3
Summary of the Abbot REALTIME HCV and HCV GT Assay Results

| | | Aliquot B | | Aliquot D |
|---|---|---|---|---|
| | | Process plasma | | Process plasma samples |
| | Aliquot A | samples through | Aliquot C | through ViveST (elute |
| | Analyze plasma with | ViveST (elute with | Analyze plasma samples | with water) and analyze |
| | Abbott REALTIME | water) and analyze | with | with Abbott HCV GT |
| | HCV Assay | with Abbott | Abbott HCV GT Assay | Assay |
| | HCV Results LOG | HCV Results LOG | Results Genotype | Results Genotype |
| Sample | (IU/mL) | (IU/mL) | Interpretation | Interpretation |
| 1 | 3.92 | 3.66 | 2 | 2 |
| 2 | 5.46 | 5.32 | 1, 1a | 1, 1a |
| 3 | 4.58 | 4.24 | 1, 1a | 1, 1a |
| 4 | 3.6 | 3.34 | 1, 1a | 1, 1a |
| 5 | 4.62 | 4.14 | 1, 1a | 1, 1a |
| 6 | 4.7 | 3.92 | 1, 1a | 1, 1a |
| 7 | 5.39 | 5.02 | 1, 1a | 1, 1a |
| 8 | 4.85 | 4.59 | 1, 1a | 1, 1a |
| 9 | 4.98 | 4.69 | 1, 1a | 1, 1a |
| 10 | 2.96 | 2.8 | 2 | 2 |
| 11 | 6.03 | 5.74 | 3 | 3 |
| 12 | 5.44 | 5.15 | 1, 1a | 1, 1a |
| 13 | 4.48 | 4.02 | 3 | 3 |
| 14 | 5.07 | 4.77 | 3 | 3 |
| 15 | 3.46 | 3.4 | 1, 1a | 1, 1a |
| 16 | 5.32 | 4.94 | 1, 1a | 1, 1a |
| 17 | 5.47 | 5.26 | 1, 1b | 1, 1b |
| 18 | 2.91 | 2.64 | 1, 1a | 1, 1a |
| 19 | 4.89 | 4.48 | 1 | 1 |
| Neg | — | Not Detected | — | Not Detected |
| Control | | | | |

TABLE 4
Results of Comparative Analysis Using the Abbott's REALTIME HCV
Testing (Fresh Plasma versus Samples Processed through the ViveST
Device of the Invention)

| | |
|---|---|
| Fresh Plasma, Mean Viral Load LOG IU/mL (n = 19) | 4.64 |
| ViveST, Mean Viral Load LOG IU/mL (n = 19) | 4.32 |
| Mean Difference, LOG IU/mL (Fresh vs. ViveST) | −0.32 |
| Std. Dev. LOG IU/mL | 0.15 |
| Correlation Cofficient (R) | 0.98 |

### 4. Conclusion

HCV genotyping results demonstrated 100% concordance between the plasma samples recovered from the ViveST devices of the invention as compared to the frozen plasma with HCV genotypes 1, 1a, 1b, 2, and 3 being tested (Table 3). HCV viral load results showed an average reduction of 0.32 log for the plasma removed from the ViveST devices of the invention as compared to the frozen plasma (Table 4 and FIG. 9).

Based on dried blood/plasma spot data previously published, one expects approximately 0.5-0.7 log reduction between quantitation from fresh plasma versus a dried collection device (Amellal et al., 2007, HIV Med. 8:396-400, discussing the median loss was significant and equivalent to 0.64 log copies/mL; Hamers et al., 2009, Antiviral Therapy 14:619-29, discussing the median difference between DPS and plasma were 0.077 to 0.64 log copies/mL). Here, this study demonstrated that the average viral RNA recovered from the plasma samples processed through the ViveST devices of the invention with the polyolefin matrix was surprising higher and more reproducible than previously expected values based on published literature.

### Example 7

HIV-1 and ViroSeq HIV-1 Genotyping Evaluation for Samples Processed through the ViveST Devices of the Invention

### 1. Experimental Design

1 ml aliquots of HIV-1 positive plasma samples (N=20), stored at −80° C., was used for each part of the analysis and was designated as follows:

A=sample analyzed with the Abbott REALTIME HIV-1 assay;

B=sample processed through the ViveST devices of the invention with the polyolefin fiber matrix (elute with water) and analyzed with the Abbott REALTIME HIV-1 assay;

C=sample processed through the ViveST devices of the invention with the polyolefin fiber matrix (elute with mLysis buffer) and analyzed with the Abbott REALTIME HIV-1 assay;

D=sample analyzed with the ViroSeq HIV-1 Pro & RT Genotypic assay;

E=sample processed through the ViveST devices of the invention with the polyolefin fiber matrix (elute with water) and analyzed with the ViroSeq HIV-1 Pro & RT Genotypic assay.

Additional aliquots of each plasma sample were maintained at −80° C. for additional testing.

### 2.1 Procedure—Sampled Processed Through the ViveST Devices of the Invention

a) Removed plasma aliquots designated as “1B, 2B . . . 20B”, “1C, 2C . . . 20C” and “1E, 2E . . . 20E” from −80° C., thawed at room temperature;

b) Vortexed each sample to ensure adequate mixing;

c) Obtained 60 ViveST devices of the invention with the polyolefin fiber matrix and labeled the cap of each with the sample designations (i.e., 1b-20b, 1c-20c, 1e-20e), obtained 2 additional ViveST devices and labeled each as Negative Control;

d) Loaded 1 ViveST device for each sample, loaded 1 mL normal (HIV-1 negative) human plasma on the ViveST devices labeled as Negative Controls;

e) Dried the loaded matrix in the ViveST devices in a laminar flow hood for at least 12 hours but not more than 36 hours;

f) Recovered samples “1b-20b”, “1e-20e” and “Neg Ctrl-water” from the dried ViveST devices using water, recovered samples “1c-20c” and “NegCtrl-lysis” with lysis buffer; and

g) Froze recovered samples at −80° C.

2.2. Procedure—Abbott m2000 REALTIME HIV-1 Assay

a) Removed plasma aliquots designated as “1A, 2A . . . 20A”, and the recovered aliquots from the ViveST devices as “1B, 2B . . . 20B”, “1C . . . 2C . . . 20C”, “Neg Ctrl-water” and “Neg Ctrl-lysis” from −80° C., thawed at room temperature; and

b) Processed the samples following the Abbott REALTIME HIV-1 assay package insert.

### 2.3 Procedure—ViroSeq HIV-1 Pro & RT Genotypic Assay

a) Removed plasma aliquots designated as “1D, 2D . . . 20D” and the recovered aliquots from the ViveST devices as “1E, 2E . . . 20E” from −80° C., thawed at room temperature; and

b) Processed the samples following the ViroSeq HIV-1 Pro & RT Genotypic assay package insert.

### 3. Results—A Summary of the Results are Provided in Tables 5 and 6 Below.

TABLE 5
Summary of Abbott REALTIME HIV-1 and ViroSeq HIV-1 Genotyping Results

| | | | Aliquot B | Aliquot C | | |
|---|---|---|---|---|---|---|
| | | | Process plasma | Process plasma | | Aliquot E |
| | | | samples through | samples through | Aliquot D | Process plasma |
| | | Aliquot A | ViveST (elute with | ViveST (elute with | Analyze plasma | samples through |
| | | Analyze plasma | water) and analyze | lysis) and analyze | samples with | ViveST and analyze |
| | | with Abbott | with Abbott | with Abbott | ViroSeq HIV-1 | with ViroSeq HIV-1 |
| | | RealTime | RealTime | RealTime | Pro & RT | Pro & RT |
| | | HIV-1 Assay | HIV-1 Assay | HIV-1 Assay | Genotypic Assay | Genotypic Assay |
| bioMONTR | Sample | HIV-1 Results | HIV-1 Results | HIV-1 Results | Genotypic Results | Genotypic Results |
| ID | ID | LOG (c/mL) | LOG (c/mL) | LOG (c/mL) | (see attached report) | (see attached report) |
| b1208 | 1 | 5.45 | 4.68 | 4.61 | NRTI: M41L, E44D, D67N, | NRTI: M41L, E44D, D67N, |
| | | | | | L74V, V118I, M184V, | L74V, V118I, M184V, |
| | | | | | L210W, T215Y, K219N | L210W, T215Y, K219N |
| | | | | | NNRTI: V108I, Y181C, | NNRTI: V108I, Y181C, |
| | | | | | Y181L | Y181L |
| | | | | | PI: L10I, V32I, M46I, | PI: L10I, V32I, M46I, |
| | | | | | F53L, I54V, Q58E, A71V, | F53L, I54V, Q58E, A71V, |
| | | | | | V82A, L90M | V82A, L90M |
| b1210 | 2 | 3.46 | 2.84 | 3.11 | NRTI: M41L, E44D, D67N, | NRTI: M41L, E44D, D67N, |
| | | | | | K70R, M184V, L210W, | K70R, M184V, L210W, |
| | | | | | T215Y, K219E | T215Y, K219E |
| | | | | | PI: L10I, I54V, V82A | PI: L10I, I54V, V82A |
| b1211 | 3 | 6.07 | 5.6 | 5.75 | NRTI: M41L, T215Y | NRTI: M41L, T215Y |
| b1213 | 4 | 5.09 | 4.61 | 5.05 | NRTI: M41L, E44D, L47V, | NRTI: M41L, E44D, L47V, |
| | | | | | L210W, T215Y | L210W, T215Y |
| | | | | | NNRTI: Y188L | NNRTI: Y188L |
| | | | | | PI: M46I, A71T, L90M | PI: M46I, A71T, L90M |
| b1214 | 5 | 3.54 | 3.15 | 3.07 | NRTI: M41L, E44D, D67N, | NRTI: M41L, E44D, D67N, |
| | | | | | T69D, V118I, | T69D, V118I, |
| | | | | | PI: L90M | PI: L90M |
| b1215 | 6 | 3.16 | 2.64 | 2.97 | NRTI: M184V | No amplification |
| b1215 | 7 | 2.12 | 1.57 | 2.03 | Not analyzed due to | Not analyzed due to |
| (diluted) | | | | | low viral load | low viral load |
| b1216 | 8 | 4.57 | 4.14 | 4.37 | Deletion @ T69 | Deletion @ T69 |
| | | | | | (no report) | (no report) |
| b1217 | 9 | 2.87 | 2.54 | 3.41 | No amplification | No amplification |
| b1217 | 10 | 2.22 | 1.29 | 2.28 | Not analyzed due to | Not analyzed due to |
| (diluted) | | | | | low viral load | low viral load |
| b1218 | 11 | 4.72 | 4.15 | 4.3 | NNRTI: K103N | NNRTI: K103N, K238T |
| b1219 | 12 | 4.17 | 3.67 | 3.79 | NRTI: T69D | NRTI: T69D |
| | | | | | NNRTI: K103N | NNRTI: K103N |
| b1220 | 13 | 4.44 | 3.84 | 4.05 | NRTI: V75I | No mutations Identified |
| b1221 | 14 | 3.24 | 2.67 | 2.88 | NRTI: D67N, M184V, | NRTI: D67N, M184V, |
| | | | | | T215Y | T215C/T215Y |
| | | | | | NNRTI: K101Q, K103R, | NNRTI: K101Q, K103R, |
| | | | | | V179D, Y181C, G190A | V179D, Y181C, G190A |
| | | | | | PI: L10F, M461V, I54L, | PI: L10F, M461V, I54L, |
| | | | | | I84V, L90M | I84V, L90M |
| b1221 | 15 | 2.32 | 1.5 | 1.92 | Not analyzed due to | Not analyzed due to |
| (diluted) | | | | | low viral load | low viral load |
| b1222 | 16 | 4.18 | 3.65 | 3.78 | PI: A71V | PI: A71V |
| b1223 | 17 | 2.7 | 2.04 | 3.06 | No amplification | No amplification |
| b1224 | 19 | 3.83 | 3.26 | 3.54 | No Mutations Identified | No Mutations Identified |
| b1225 | 19 | 4.19 | 3.41 | 3.77 | NRTI: D67N, L74V, V118I, | NRTI: D67N, L74V, V118I, |
| | | | | | T215F, K219Q | T215F, K219Q |
| | | | | | NNRTI: L100I, K103N | NNRTI: L100I, K103N |
| | | | | | PI: L10I, G48V, I54V, | PI: L10I, G48V, I54V, |
| | | | | | A71V, V82A, L90M | A71V, V82A, L90M |
| b1227 | 20 | 2.47 | 1.84 | 1.83 | No amplification | No amplification |

*All results are provided for RESEARCH USE ONLY and should not be used for diagnostic purposes.

TABLE 6
Results of Comparative Analysis Using the Abbott's REALTIME HIV-1
Testing (Fresh Plasma versus Samples Processed through the ViveST
Devices)

| Fresh Plasma, Mean LOG c/mL | 3.74 | |
|---|---|---|
| (n = 20) | | |
| | Recovery with | Recovery with |
| | mLysis | Water |
| ViveST, Mean LOG c/mL (n = 20) | 3.48 | 3.15 |
| Mean Difference, LOG c/mL | −0.26 | −0.59 |
| (Fresh vs ViveST) | | |
| Std Dev, LOG c/mL | 0.31 | 0.15 |
| Correlation Cofficient (R) | 0.96 | 0.99 |

### 4. Conclusions

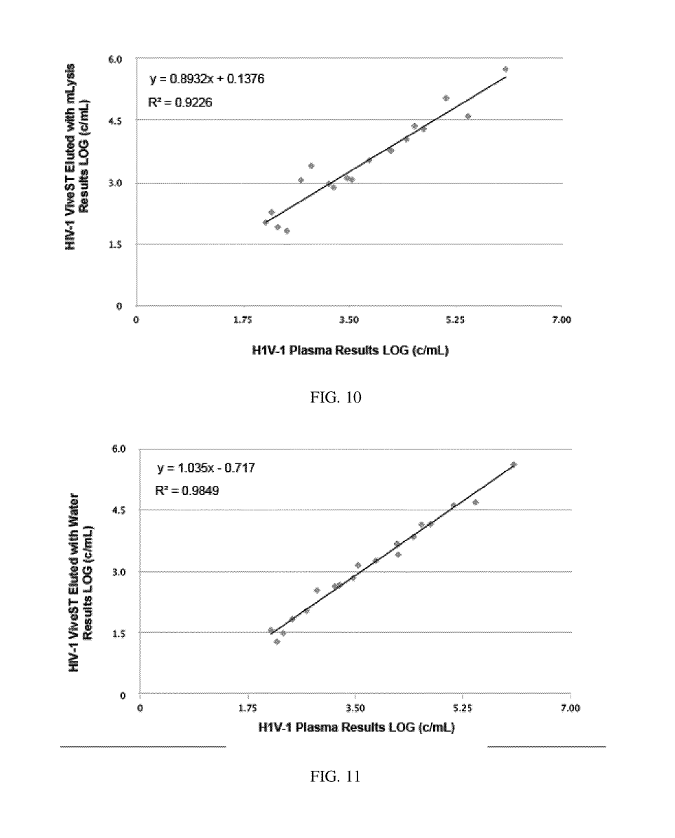

HIV-1 viral load results showed an average reduction of 0.26 log for the plasma samples recovered from the ViveST devices of the invention with the polyolefin fiber matrix using mLysis buffer and 0.59 log reduction using water (FIG. 10, FIG. 11 and Table 6).

HIV-1 drug resistance mutations were identified in 10/17 pairs (59%) and demonstrated 100% concordance between the plasma samples recovered from the ViveST devices as compared to the frozen plasma. A mixture T215Y/C was identified in 1/17 in the sample recovered from the ViveST device while corresponding plasma reported a mutation T215Y. A mutation at V75I was identified for 1/17 in the plasma sample while the paired sample recovered from the ViveST device was wild type. 1/17 pair demonstrated deletion at T69 preventing generation of ViroSeq report. 1/17 plasma sample had M184V but results were not generated for corresponding processed sample through the ViveST device due to low viral load. No genotypic results were generated for 3/17 paired samples due to low viral loads (Table 5).

Based on dried blood/plasma spot data previously published, one expects approximately 0.5-0.7 log reduction between quantitation from fresh plasma versus a dried collection device (Amellal et al., 2007, HIV Med. 8:396-400, discussing the median loss was significant and equivalent to 0.64 log copies/mL; Hamers et al., 2009, Antiviral Therapy 14:619-29, discussing the median difference between DPS and plasma were 0.077 to 0.64 log copies/mL). Additionally, based on published data, one expects not to obtain sufficient integrity (quality and quantity) of amplicons for valid genotypic analysis results especially from low viremia HIV samples (Lofgren et al., 2009, AIDS 23: 2459-66, providing that performance was best for samples from patients with plasma RNA levels about 5,000 copies/mL for detecting virologic failure; Hamers et al., 2009, Antiviral Therapy 14:619-29, providing that overall amplification success rates high for high VL (>3.0 to 4.0 log copies/mL), but reduced for lower VL (<3.0 log, reduced sensitivity due to small volume used in spot, compared to 140 mL for plasma).

Here, this study demonstrated the average viral RNA recovered from the ViveST device of the invention with the polyolefin matrix was surprisingly higher (recovered 0.26 log) and more reproducible than previously expected values based on published literature. Additionally, results were obtained in 14/17 pairs analyzed (82%) across a broad viral RNA range, is a greater genotyping success rate than expected.

### Example 8

### HCV Validation (Linearity and Precision) for Samples Processed Through the ViveST Devices of the Invention

### 1. Experimental Design

The purpose of this study was to validate the analytical measurement range and the precision for the samples processed through the ViveST devices of the invention with the polyolefin matrix using the Abbott REALTIME HCV assay. This example describes the verification of the analytical measurement range (linear range) and precision.

### 2. Precision (Inter and Intra-Assay Precision)

Three samples of varying viral load values (low, mid, and high viral load) stored in ViveST devices of the invention were tested in triplicate on three separate assays performed by two different operators on different days (N=27 samples). Table 7 describes the nomenclature of the experimental design for the precision validation assays.

### 3. Analytical Measurement Range

For testing analytical measurement range, a high titer sample (4E6 IU/mL) was serially diluted in normal human plasma to yield dilutions of 1:2, 1:20, 1:200, 1:2,000, 1:20,000 and 1:200,000, and processed through the ViveST devices of the invention with the polyolefin fiber matrix. Each dilution is tested in triplicate in a single run on the m2000 platform (N=21). Table 8 describes the nomenclature of the experimental design for the analytical measurement range validation assays. Additional aliquots of each plasma sample were maintained at −80° C. for additional testing.

### 4. Procedures

a) Samples for the precision assays were HCV positive samples of known concentrations. Samples for the analytical measurement range assay were prepared as follows: high titer samples were diluted to make 6 serial dilutions resulting in seven samples with a concentration range of 1.3-6.6 log 10 IU/mL. The samples were prepared in triplicate as indicated in Table 8;

b) Vortexed each sample to ensure adequate mixing;

c) Obtained 51 ViveST devices with the polyolefin fiber matrix and labeled the cap of each with the sample designations (Table 7);

d) Loaded 1 ViveST device for each sample (1.0 mL each), loaded 1 mL normal (HCV negative) human plasma on the ViveST devices labeled as Negative Controls;

e) Dried the loaded matrixes in the ViveST devices in a laminar flow hood for at least 12 hours but not more than 36 hours;

f) Recovered samples from the dried ViveST devices using water; and

g) Processed the samples following the Abbott REALTIME HCV assay package insert.

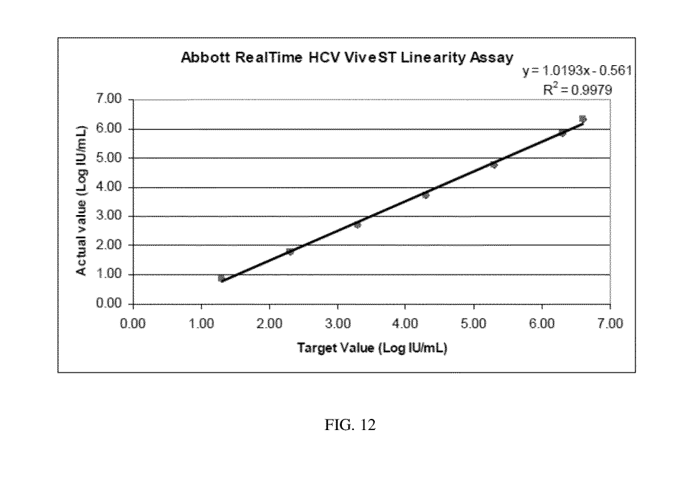

Results for the HCV precision assay are provided in Tables 7 and 9. Results for the HCV analytical measurement range determination are provided in Table 8 and FIG. 12.

TABLE 7
HCV Precision Data using the Abbott REALTIME HCV Assay
ViveST Abbott HCV Reproducibility Data Summary

| | | | HCV titre results |
|---|---|---|---|
| Assay | Sample ID | Level | (log₁₀ IU/mL) |
| Day 1 | RLAV1A | Low | 2.16 |
| | RLAV1B | | 2.18 |
| | RLAV1C | | 2.30 |
| | RMAV1A | Med | 3.67 |
| | RMAV1B | | 3.71 |
| | RMAV1C | | 3.74 |
| | RHAV1A | High | 5.15 |
| | RHAV1B | | 5.17 |
| | RHAV1C | | 5.18 |
| Day 2 | RLAV2A | Low | 2.15 |
| | RLAV2B | | 2.21 |
| | RLAV2C | | 2.18 |
| | RMAV2A | Med | 3.58 |
| | RMAV2B | | 3.58 |
| | RMAV2C | | 3.62 |
| | RHAV2A | High | 6.04 |
| | RHAV2B | | 6.08 |
| | RHAV2C | | 4.98 |
| Day 3 | RLAV3A | Low | 2.31 |
| | RLAV3B | | 2.23 |
| | RLAV3C | | 2.11 |
| | RMAV3A | Med | 3.61 |
| | RMAV3B | | 3.64 |
| | RMAV3C | | 3.85 |
| | RHAV3A | High | 5.08 |
| | RHAV3B | | 5.19 |
| | RHAV3C | | 5.11 |

TABLE 8
Data for HCV Analytical Measurement Range Determination
using the Abbott REALTIME HCV Assay

| | | | Target | |
|---|---|---|---|---|
| | | | Concentration | HCV titre |
| | | | HCV titre | (Log₁₀ |
| Sample ID | Dilution | Replicate | (log₁₀ IU/mL) | IU/mL) |
| LAV7A | 1 | A | 1.3 | 0.87 |
| LAV7B | 1 | B | | 0.86 |
| LAV7C | 1 | C | | 0.27 |
| LAV6A | 2 | A | 2.3 | 1.78 |
| LAV6B | 2 | B | | 1.78 |
| LAV6C | 2 | C | | 1.61 |
| LAV5A | 3 | A | 3.3 | 2.73 |
| LAV5B | 3 | B | | 2.73 |
| LAV5C | 3 | C | | 2.73 |
| LAV4A | 4 | A | 4.3 | 3.74 |
| LAV4B | 4 | B | | 3.64 |
| LAV4C | 4 | C | | 3.74 |
| LAV3A | 5 | A | 5.3 | 4.77 |
| LAV3B | 5 | B | | 4.71 |
| LAV3C | 5 | C | | 4.78 |
| LAV2A | 6 | A | 6.3 | 5.84 |
| LAV2B | 6 | B | | 5.82 |
| LAV2C | 6 | C | | 5.87 |
| LAV1A | 7 | A | 6.6 | 6.32 |
| LAV1B | 7 | B | | 6.23 |
| LAV1C | 7 | C | | 6.14 |

TABLE 9
HCV Inter-assay and Intra-assay Precision Determination using the Abbott REALTIME HCV Assay
ViveST Abbott HCV Intra-assay and Inter-assay Precision

| | Intra-assay precision | | | | | | | | | Inter-assay precision | | |
|---|---|---|---|---|---|---|---|---|---|---|---|---|
| | Concentration: | | | | | | | | | | | |
| | Low | | | Medium | | | High | | | | | |
| Timepoint (Day) | 1 | 2 | 3 | 1 | 2 | 3 | 1 | 2 | 3 | Low | Medium | High |
| Replicates (n) | 3 | 3 | 3 | 3 | 3 | 3 | 3 | 3 | 3 | 9 | 9 | 9 |
| Mean (log₁₀ IU/mL) | 2.21 | 2.18 | 2.22 | 3.71 | 3.63 | 3.63 | 5.16 | 5.03 | 5.10 | 2.20 | 3.66 | 5.10 |
| Standard Deviation | 0.08 | 0.03 | 0.10 | 0.04 | 0.05 | 0.02 | 0.01 | 0.05 | 0.02 | 0.07 | 0.05 | 0.06 |
| Coefficent of variation (% CV) | 0.04 | 0.01 | 0.05 | 0.02 | 0.02 | 0.01 | 0.00 | 0.02 | 0.01 | 0.06 | 0.05 | 0.06 |

### 5. Conclusions

This study determined that the analytical measurement range of HCV positive samples processed through the ViveST devices of the invention is 201 U/mL-4,000,000 IU/mL or 1.3-6.6 log 10 IU/mL. Linear regression analysis R² value is 0.9979 for the analytical measurement range samples. The standard deviation for all precision assays was <±0.2 log 10 IU/mL indicating robust reproducibility. The coefficient of variation (% CV) at a 95% confidence level for inter-assay precision was <0.06% for all time points for all sample concentrations. The coefficient of variation (% CV) at a 95% confidence level for intra-assay precision was <0.05% for all time points for all sample concentrations.

Previously published dried blood spot and dried plasma spot data indicated at least 0.5 log. Standard Deviation for precision leading to highly variable recovery and reduced reproducibility for viral load analysis (Andreotti et al., 2010, Clin. Virol. 47: 4-7, discussing that 10% cases (n=13) DBS RNA not detectable while measurable in plasma (between 2.1 and 3.04 log). One DBS gave 2.74 log while corresponding plasma level was <1.67 log. In all other cases, undetectable RNA in plasma was not detectable in DBS (n=18)). Here, this study demonstrated surprising reproducibility across a broad viral load range indicating very robust storage and recovery of nucleic acid using the ViveST devices of the invention with the polyolefin matrix.

### Example 9

### HCV Evaluation for Samples Processed through the ViveST Devices of the Invention using the Roche TaqMan HCV Assay

### 1. Experimental Design

The purpose of this study was to evaluate HCV in samples processed through the ViveST devices of the invention with the polyolefin matrix using the Roche COBAS AmpliPrep/COBAS TaqMan HCV assay. For analysis using the Roche COBAS AmpliPrep/COBAS TaqMan HCV assay, 1.2 mL aliquots of HCV positive plasma samples (N=20), were used for the analysis. Additional aliquots of each plasma sample were maintained at −80° C. for additional testing.

### 2. Procedure

a) High titer samples were diluted in HCV negative normal human plasma to generate samples as described in Table 10;

b) Vortexed each sample to ensure adequate mixing;

c) 1.2 mL of each sample was stored frozen at −80° C. (pending analysis) or processed through the ViveST devices of the invention as indicated in Table 10;

d) Obtained 20 ViveST devices and labeled the cap of each with the sample designations (Table 10);

e) Load 1 ViveST device for each sample (1.2 mL each);

f) Dried the loaded matrixes in the ViveST devices in a laminar flow hood for at least 12 hours but not more than 36 hours;

g) Recovered samples from the ViveST devices using 1.2 mL water; and

h) Froze the recovered samples at −80° C.;

i) Recovered samples, and stored frozen plasma aliquots were analyzed using the Roche COBAS AmpliPrep/COBAS TaqMan HCV assay.

3. Results—Results are provided in Table 10 below.

TABLE 10
Samples/Results for the Roche COBAS AmpliPrep/
COBAS TAQMAN HCV Assay

| | | | Process plasma | |
|---|---|---|---|---|
| | | | samples through | |
| | | | ViveST (elute with | |
| | | Analyze plasma with | water) and analyze | |
| | | Roche COBAS ® | with Roche COBAS ® | Difference (plasma |
| | | AmpliPrep/COBAS ® | AmpliPrep/COBAS ® | sample processed |
| | Target | TaqMan ® HCV assay | TaqMan ® HCV assay | through ViveST vs. |
| | Concentration | HCV Results | HCV Results | plasma sample) |
| Sample ID | (log₁₀ IU/mL) | log₁₀ IU/mL | log₁₀ IU/mL | log₁₀ IU/mL |
| 1a | 6.6 | 6.45 | 6.37 | −0.08 |
| 1b | | 6.39 | 6.39 | 0.00 |
| 2a | 6.3 | 6.11 | 6.06 | −0.05 |
| 2b | | 6.13 | 6.00 | −0.13 |
| 3a | 5.3 | 4.97 | 4.83 | −0.14 |
| 3b | | 4.93 | 4.85 | −0.08 |
| 4a | 4.3 | 4.12 | 3.89 | −0.23 |
| 4b | | 4.05 | 3.75 | −0.30 |
| 5a | 3.3 | 3.12 | 2.87 | −0.25 |
| 5b | | 3.13 | 2.85 | −0.28 |
| 6a | 2.3 | 2.08 | 1.05 | −1.03 |
| 6b | | 2.16 | 1.48 | −0.68 |
| 7a | 1.3 | <1.18 | <1.18 | ND |
| 7c | | <1.18 | <1.18 | ND |
| La | 2.76 | 3.03 | 2.27 | −0.76 |
| Lb | | 2.91 | 2.62 | −0.29 |
| Ma | 4.48 | 4.55 | 3.89 | −0.88 |
| Mb | | 4.51 | 3.95 | −0.56 |
| Ha | 6.07 | 6.01 | 5.92 | −0.09 |
| Hb | | 5.97 | 5.90 | −0.07 |

| | |
|---|---|
| Mean Difference (log₁₀ IU/mL): | −0.32 |

ND = Difference not determined as result values were <15 IU/mL.

### 4. Conclusions

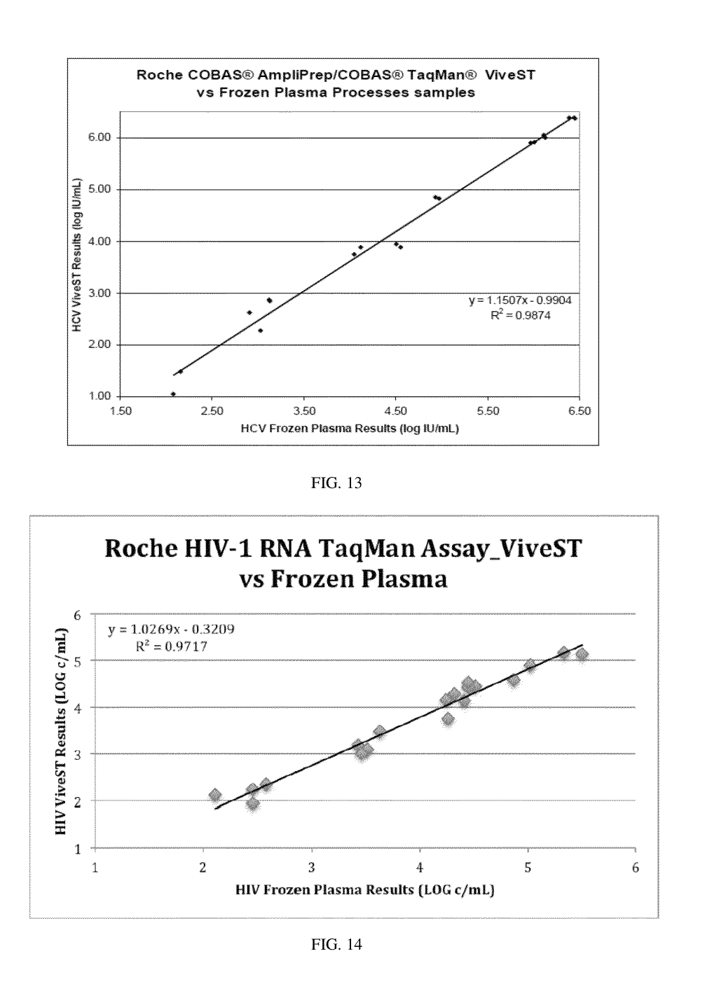

Average loss of HCV RNA observed when plasma was processed through the ViveST devices of the invention in the Roche COBAS AmpliPrep/COBAS TaqMan HCV assay is 0.32 log 10 IU/mL (Table 10). The linearity when the plasma samples were compared with the plasma samples processed through the ViveST devices of the invention over the concentration range of 2.3-6.6 log 10 IU/mL had a linear regression analysis value (R²) of 0.9874 (FIG. 13).

Based on dried blood/plasma spot data previously published, one expects approximately 0.5-0.7 LOG reduction between quantitation from fresh plasma versus a dried collection device (Amellal et al., 2007, HIV Med. 8:396-400, discussing the median loss was significant and equivalent to 0.64 log copies/mL; Hamers et al., 2009, Antiviral Therapy 14:619-29, discussing the median difference between DPS and plasma were 0.077 to 0.64 log copies/mL). Here, this study demonstrated that the average viral RNA recovered using the ViveST devices of the invention with the polyolefin matrix was surprising higher and more reproducible than previously expected values based on published literature.

### Example 10

### HIV Evaluation for Samples Processed through the ViveST Devices of the Invention using the Roche HIV1 RNA TagMan Assay

### 1. Experimental Design

The purpose of this study was to evaluate HIV in the samples processed through the ViveST devices of the invention using the Roche HIV1 RNA TaqMan assay. For analysis using the Roche assay, 1.2 mL aliquots of HIV-1 positive plasma samples (N=20), stored at −80° C., were used and aliquots were designated as follows:

p=plasma sample analyzed with Roche HIV-1 RNA TaqMan assay

v=plasma sample processed through the ViveST devices with polyolefin fiber matrix (elute with water) and analyzed with the Roche HIV-1 RNA TaqMan assay.

Additional aliquots of each plasma sample were maintained at −80° C. for additional testing.

### 2. Procedures

a) Removed plasma aliquots to be processed through the ViveST devices from −80° C., thawed at room temperature;

b) Vortexed each sample to ensure adequate mixing;

c) Obtained 20 ViveST devices and labeled the cap of each with the sample designations (Table 11);

d) Loaded 1 ViveST device for each sample (1.2 mL each);

e) Dried the loaded matrixes in the ViveST devices in a laminar flow hood for at least 12 hours but not more than 36 hours;

f) Recovered samples from the ViveST devices using water (1.2 mL each);

g) Froze recovered samples at −80° C.; and

h) Recovered samples and stored frozen plasma aliquots were analyzed using the Roche HIV-1 RNA TaqMan assay.

### 3. Results—Results are Provided in Table 11 Below and FIG. 14.

TABLE 11
Samples/Results for the Roche HIV-1 RNA TaqMan Assay

| | Aliquot ‘p’ | Aliquot ‘v’ | |
|---|---|---|---|
| | Roche HIV | Roche HIV | Difference |
| | Plasma Results | ViveST Results | (ViveST − |
| Sample ID | LOG (c/mL) | LOG (c/mL) | Plasma) |
| b1209-21 | 4.41 | 4.13 | −0.28 |
| b1210-2 | 3.51 | 3.09 | −0.42 |
| b1208-1 | 5.5 | 5.14 | −0.36 |
| b1212-23 | 2.58 | 2.34 | −0.24 |
| b1213-4 | 5.33 | 5.17 | −0.16 |
| b1214-5 | 3.63 | 3.48 | −0.15 |
| b1215-7 | 2.38 | <1.68 | ND |
| b1215-24 | 3.43 | 3.18 | −0.25 |
| b1216-8 | 4.51 | 4.45 | −0.06 |
| b1217-10 | 2.46 | 1.94 | −0.52 |
| b1218-11 | 4.87 | 4.59 | −0.28 |
| b1219-12 | 4.32 | 4.29 | −0.03 |
| b1220-13 | 4.45 | 4.42 | −0.03 |
| b1221-15 | 2.11 | 2.12 | 0.01 |
| b1222-16 | 4.45 | 4.53 | 0.08 |
| b1223-17 | 3.46 | 3.01 | −0.45 |
| b1224-18 | 4.24 | 4.15 | −0.09 |
| b1225-19 | 4.26 | 3.75 | −0.51 |
| b1226-22 | 5.02 | 4.9 | −0.12 |
| b1227-20 | 2.46 | 2.24 | −0.22 |
| AVERAGE | 3.87 | 3.73 | −0.21 |

ND = Difference not determined as results values were <1.68 LOG c/mL.

### 4. Conclusions

Average loss of HIV RNA observed when the plasma sample was processed through the ViveST devices in the Roche HIV-1 RNA TaqMan assay is 0.21 log c/mL (Table 11). The linearity when the plasma samples were compared with the plasma samples processed through the ViveST devices over the concentration range of ˜2.1-5.5 log c/mL has a linear regression analysis value (R²) of 0.9717 (FIG. 14).

Based on dried blood/plasma spot data previously published, one expects approximately 0.5-0.7 log reduction between quantitation from fresh plasma versus a dried collection device (Amellal et al., 2007, HIV Med. 8:396-400, discussing the median loss was significant and equivalent to 0.64 log copies/mL; Hamers et al., 2009, Antiviral Therapy 14:619-29, discussing the median difference between DPS and plasma were 0.077 to 0.64 log copies/mL). Here, this study demonstrated that the average viral RNA recovered using the ViveST devices of the invention with the polyolefin matrix was surprising higher and more reproducible than previously expected values based on published literature.

### Example 11

### HIV-1 Assay Validation (Linearity and Precision) for Samples Processed through the ViveST Devices of the Invention

### 1. Experimental Design

The purpose of this study was to validate the analytical measurement range and the precision for the samples processed through the ViveST devices of the invention using the Abbott REALTIME HIV-1 assay. This example describes the verification of the analytical measurement range (linear range) and precision.

### 2. Precision (Inter and Intra-Assay Precision)

Three samples of varying viral load values (low, mid, and high viral load) stored in the ViveST devices were tested in triplicate (at a minimum) on three separate assays on different days.

### 3. Analytical Measurement Range

For testing analytical measurement range, a high titer sample (−8 log copies/mL) was serially diluted in normal human plasma to yield dilutions of 1:10, 1:100, 1:1,000, 1:10,000, 1:100,000, 1:1,000,000, and 1:10,000,000 and processed through the ViveST devices of the invention with the polyolefin fiber matrix. Each dilution was tested in triplicate on a single run on the m2000 platform (N=21). Serial dilutions were frozen, thawed, and analyzed on the m2000 platform (N=21) for comparison. Additional aliquots of each plasma sample were maintained at −80° C. for additional testing.

### 4. Procedure

a) Samples for the precision assays were diluted from a HIV-1 positive sample with concentration of ˜8 log copies/mL. Serial dilutions were made with negative human plasma to yield samples with concentrations of ˜5 log copies/mL, ˜4 log copies/mL, and ˜3 log copies/mL. Samples for the analytical measurement range assay were prepared as follows: a high titer sample was serially diluted 7 times resulting in seven samples with a concentration range of 1-7 log copies/mL. The samples were prepared in triplicate;

b) Vortexed each sample to ensure adequate mixing;

c) Obtained the appropriate number of ViveST devices and labeled the cap of each with the sample designations;

d) Loaded 1 ViveST device for each sample (1.15 mL each), loaded 1.15 mL normal (HIV-1 negative) human plasma on the ViveST devices labeled as Negative Controls. NOTE: The Abbott REALTIME HIV-1 0.6 mL application requires 1.1 mL sample; therefore, 1.15 mL sample was loaded/recovered on the ViveST devices to ensure adequate recovery;

e) Dried the loaded matrixes in the ViveST devices in a laminar flow hood for at least 12 hours but not more than 36 hours, designated the load/recovery dates on the assay worksheet, once dried, capped the ViveST devices and stored at ambient laboratory conditions;

f) Recovered samples from the dried ViveST devices using water (1.15 mL each); and

g) Processed the samples following the Abbott REALTIME HIV-1 package insert (0.6 mL application).

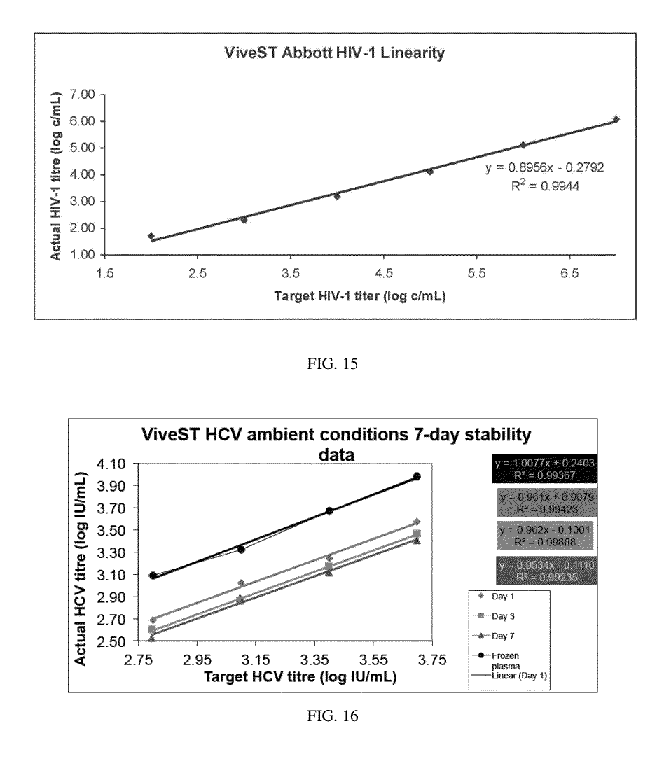

Results for the HIV-1 precision assay are provided in Table 12. Results for the HIV-1 analytical measurement range determination are provided in Table 13, and FIG. 15.

TABLE 12
HIV-1 Inter-Assay and Intra-Assay Precision Determination using the Abbott REALTIME HIV-1 Assay
Abbott HIV-1 Intra-Assay and Inter-Assay Precision

| | Intra-assay precision | | | | | | | | | Inter-assay precision | | |
|---|---|---|---|---|---|---|---|---|---|---|---|---|
| | Concentration: | | | | | | | | | | | |
| | Low | | | Medium | | | High | | | | | |
| Days stored on ViveST | 7 | 10 | 1 | 7 | 10 | 1 | 7 | 10 | 1 | Low | Medium | High |
| Replicates (n) | 5 | 5 | 5 | 5 | 5 | 5 | 5 | 5 | 5 | 15 | 15 | 15 |
| Mean | 2.71 | 2.56 | 2.66 | 3.64 | 3.56 | 3.60 | 4.72 | 4.61 | 4.62 | 2.65 | 3.61 | 4.65 |
| Standard Deviation | 0.06 | 0.08 | 0.11 | 0.06 | 0.03 | 0.06 | 0.03 | 0.09 | 0.05 | 0.10 | 0.06 | 0.07 |
| % CV | 0.08 | 0.10 | 0.14 | 0.07 | 0.04 | 0.08 | 0.03 | 0.11 | 0.06 | 0.07 | 0.04 | 0.05 |

TABLE 13
HIV-1 Analytical Measurement Range Determination
using the Abbott REALTIME HIV-1 Assay

| | Samples | | |
|---|---|---|---|
| | processed | Frozen | |
| | through | Samples | |
| Target HIV- | Actual HIV- | Actual HIV- | |
| 1 titre | 1 titre | 1 titre | |
| (log10 c/mL) | [symbol] | [symbol] | Difference |
| 1 | <1.6 | ND | Not Calculated |
| | <1.6 | ND | Not Calculated |
| | ND | <1.6 | Not Calculated |
| 2 | <1.6 | 1.88 | Not Calculated |
| | 1.70 | <1.6 | Not Calculated |
| | <1.6 | ND | Not Calculated |
| 3 | 2.32 | 2.81 | −0.49 |
| | 2.48 | 2.70 | −0.22 |
| | 2.10 | 2.75 | −0.65 |
| 4 | 3.13 | 3.71 | −0.58 |
| | 3.32 | 3.70 | −0.38 |
| | 3.07 | 3.67 | −0.60 |
| 5 | 4.13 | 4.80 | −0.67 |
| | 4.24 | 4.80 | −0.56 |
| | 4.00 | 4.76 | −0.76 |
| 6 | 5.06 | 5.84 | −0.78 |
| | 5.24 | 5.80 | −0.56 |
| | 5.08 | 5.76 | −0.68 |
| 7 | 6.10 | 6.74 | −0.64 |
| | 6.04 | 6.75 | −0.71 |
| | 6.11 | 6.79 | −0.68 |

| | |
|---|---|
| Average difference: | −0.60 |

ND = Target Not Detected
Not Calculated = Difference could not be calculated due to Target not detected or Result of <1.6 log c/mL. [symbol]
indicates data missing or illegible when filed

### 5. Conclusions

All analysis was performed using the Abbott REALTIME HIV-1 assay (0.6 mL application). This study determined that the analytical measurement range of HIV-1 positive samples processed through the ViveST devices of the invention is 2 log copies/mL-7 log copies/mL or 100 copies/mL-10,000,000 copies/mL. Linear regression analysis R2 value is 0.9944 for the analytical measurement range samples. A mean loss of 0.60 was observed for the HIV-1 samples processed through and recovered from the ViveST devices when compared to the frozen HIV-1 samples analyzed using the Abbott REALTIME HIV-1m2000 system.

For the precision analysis: The standard deviation for all assays was <±0.2 log copies/mL indicating robust reproducibility. The coefficient of variation (% CV) at a 95% confidence level for inter-assay precision was <0.07% for all time points for all sample concentrations. The coefficient of variation (% CV) at a 95% confidence level for intra-assay precision was <0.14% for all time points for all sample concentrations.

### Example 12

### 7-Day Stability Studies for HCV Using the Abbott HCV Assay

### 1. Experimental Design

The purpose of this study was to assess the ViveST devices of the invention with the polyolefin fiber matrix for storage of HCV infectious samples at ambient conditions over a seven day period. HCV infectious samples at four concentrations were added to the ViveST devices of the invention on Day 0 and dried overnight. The ViveST devices were then be sealed by capping and stored at ambient conditions. Samples were recovered and analyzed with the Abbott REALTIME HCV assay on Day 1 (4 replicates each level), Day 3, and Day 7 (5 replicates each level). As a control, one frozen plasma sample of each level was analyzed on Day 1. Negative controls were included with each time point. The assay design is shown in Table 14.

TABLE 14
Assay Design for HCV 7-Day Stability Studies at
Ambient Conditions

| Time point | HCV titre level | Replicates |
|---|---|---|
| Day 1 | 1 | 4 |
| | 2 | 4 |
| | 3 | 4 |
| | 4 | 4 |
| | 0 | 1 |
| Day 3 | 1 | 5 |
| | 2 | 5 |
| | 3 | 5 |
| | 4 | 5 |
| | 0 | 1 |
| Day 7 | 1 | 5 |
| | 2 | 5 |
| | 3 | 5 |
| | 4 | 5 |
| | 0 | 1 |

### 2. Procedures

a) Prepared HCV positive samples Levels 1-4 by linear dilution (Table 15), used HCV negative plasma for negative controls;

b) Vortexed each sample to ensure adequate mixing;

c) Obtained 60 ViveST devices and labeled the cap of each with the sample designations, obtained additional 3 ViveST devices for negative controls as described in Table 14;

d) Loaded 1 ViveST device for each sample (1.0 mL each) and 1 mL negative human plasma onto each negative control;

e) Dried the loaded matrixed in the ViveST devices in a laminar flow hood for at least 12 hours but not more than 36 hours;

f) Recovered samples from the ViveST devices using water; and

g) Processed the samples following the Abbott REALTIME HCV assay package insert.

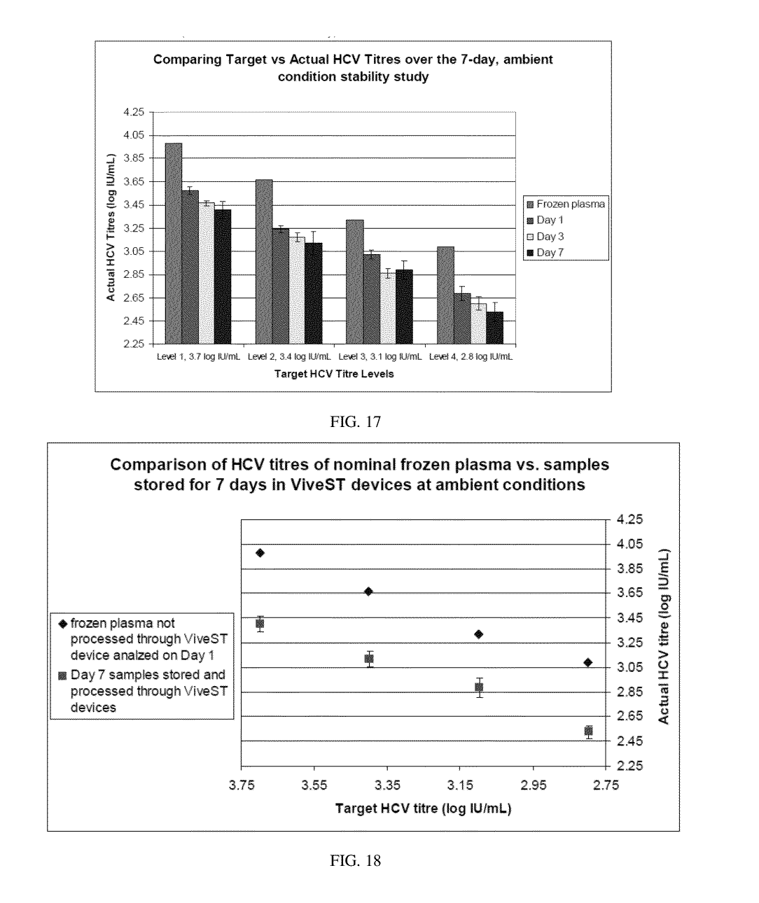

Results for the HCV 7-day stability studies at ambient conditions are provided in Tables 15-16 below and FIGS. 16-18.

TABLE 15
Raw Data for HCV 7-Day Stability Studies at Ambient
Conditions using the Abbott REALTIME HCV Assay

| Assay parameters | | | | | | | |
|---|---|---|---|---|---|---|---|
| | | Target | Target | | | Results | |
| | HCV titre | concentration | concentration | | | HCV titre | HCV titre |
| Time point | level | (IU/mL) | (log IU/mL) | Replicates | Nomenclature | log IU/mL | IU/mL |
| Day 1 | Frozen plasma | | | 1 | 1-1-A | 3.98 | 9525 |
| | 1 | 500 | 3.70 | 4 | 1-1-B | Error | Error |
| | | | | | 1-1-C | 3.60 | 4007 |
| | | | | | 1-1-D | 3.57 | 3683 |
| | | | | | 1-1-E | 3.55 | 3530 |
| | Frozen plasma | | | 1 | 1-2-A | 3.67 | 4712 |
| | 2 | 2500 | 3.40 | 4 | 1-2-B | 3.25 | 1771 |
| | | | | | 1-2-C | 3.27 | 1874 |
| | | | | | 1-2-D | 3.23 | 1710 |
| | | | | | 1-2-E | 3.22 | 1662 |
| | Frozen plasma | | | 1 | 1-3-A | 3.32 | 2068 |
| | 3 | 1250 | 3.10 | 4 | 1-3-B | 2.99 | 974 |
| | | | | | 1-3-C | 3.02 | 1045 |
| | | | | | 1-3-D | 3.07 | 1196 |
| | | | | | 1-3-E | 3.00 | 994 |
| | Frozen plasma | | | 1 | 1-4-A | 3.09 | 1226 |
| | 4 | 625 | 2.80 | 4 | 1-4-B | 2.82 | 656 |
| | | | | | 1-4-C | 2.63 | 424 |
| | | | | | 1-4-D | 2.59 | 390 |
| | | | | | 1-4-E | 2.71 | 509 |
| | 0 = neg | 0 | 0 | 1 | 1-NEG | not detected | |
| Day 3 | 1 | 5000 | 3.70 | 5 | 3-1-A | 3.48 | 3003 |
| | | | | | 3-1-B | 3.44 | 2740 |
| | | | | | 3-1-C | 3.47 | 2940 |
| | | | | | 3-1-D | 3.48 | 3024 |
| | | | | | 3-1-E | 3.45 | 2799 |
| | 2 | 2500 | 3.40 | 5 | 3-2-A | 3.20 | 1593 |
| | | | | | 3-2-B | 3.16 | 1434 |
| | | | | | 3-2-C | 3.16 | 1444 |
| | | | | | 3-2-D | 3.13 | 1336 |
| | | | | | 3-2-E | 3.20 | 1582 |
| | 3 | 1250 | 3.10 | 5 | 3-3-A | 2.81 | 647 |
| | | | | | 3-3-B | 2.86 | 724 |
| | | | | | 3-3-C | 2.86 | 719 |
| | | | | | 3-3-D | 2.90 | 794 |
| | | | | | 3-3-E | 2.87 | 735 |
| | 4 | 625 | 2.80 | 5 | 3-4-A | 2.66 | 455 |
| | | | | | 3-4-B | 2.62 | 421 |
| | | | | | 3-4-C | 2.55 | 351 |
| | | | | | 3-4-D | 2.55 | 353 |
| | | | | | 3-4-E | 2.63 | 430 |
| | 0 = neg | 0 | 0 | 1 | 3-NEG | not detected | |
| Day 7 | 1 | 5000 | 3.70 | 5 | 7-1-A | 3.46 | 2856 |
| | | | | | 7-1-B | 3.32 | 2082 |
| | | | | | 7-1-C | 3.43 | 2721 |
| | | | | | 7-1-D | 3.42 | 2627 |
| | | | | | 7-1-E | 3.40 | 2500 |
| | 2 | 2500 | 3.40 | 5 | 7-2-A | 3.15 | 1424 |
| | | | | | 7-2-B | 2.98 | 960 |
| | | | | | 7-2-C | 3.13 | 1346 |
| | | | | | 7-2-D | 3.15 | 1414 |
| | | | | | 7-2-E | 3.18 | 1526 |
| | 3 | 1250 | 3.10 | 5 | 7-3-A | 2.85 | 714 |
| | | | | | 7-3-B | 2.82 | 656 |
| | | | | | 7-3-C | 2.97 | 940 |
| | | | | | 7-3-D | 2.87 | 745 |
| | | | | | 7-3-E | 2.93 | 852 |
| | 4 | 625 | 2.80 | 5 | 7-4-A | 2.45 | 280 |
| | | | | | 7-4-B | 2.55 | 353 |
| | | | | | 7-4-C | 2.59 | 393 |
| | | | | | 7-4-D | 2.47 | 294 |
| | | | | | 7-4-E | 2.570 | 371 |

| | | | | | |
|---|---|---|---|---|---|
| 0 = neg | 0 | 0 | 1 | 7-NEG | not detected |

TABLE 16
Result Summary for the HCV 7-day Stability Studies at Ambient Conditions Using the Abbott REALTIME HCV Assay

| | | | | | | Mean | | | |
|---|---|---|---|---|---|---|---|---|---|
| | | | | | Mean | difference(%) | Mean loss | Mean loss (log | Mean loss |
| | Target HCV | Mean HCV | HCV titre | | Difference(%) | VivtST from | (%) ViveST | IU/mL) ViveST | (log IU/mL) |
| | titre (log | titre results | Standard | | ViveST vs | Initial | from initial | from initial | ViveST from |
| Time point | IU/mL) | (log IU/mL) | Deviation | % CV | frozen plasma | timepoint | timepoint | timepoint | frozen plasma |
| Frozen | 3.70 | 3.96 | N/A, n = 1 | | Nominal | Not applicable | | | |
| Plasma | 3.40 | 3.67 | | | | | | | |
| | 3.10 | 3.32 | | | | | | | |
| | 2.80 | 3.09 | | | | | | | |
| Day 1 | 3.70 | 3.57 | 0.03 | 0.04 | 90 | 1st time point | | | −0.41 |
| | 3.40 | 3.24 | 0.03 | 0.04 | 88 | | | | −0.43 |
| | 3.10 | 3.02 | 0.04 | 0.05 | 91 | | | | −0.30 |
| | 2.80 | 2.69 | 0.06 | 0.09 | 87 | | | | −0.40 |
| Day 3 | 3.70 | 3.46 | 0.02 | 0.02 | 87 | 97 | −3.1 | −0.11 | −0.52 |
| | 3.40 | 3.17 | 0.03 | 0.04 | 86 | 98 | −2.2 | −0.07 | −0.50 |
| | 3.10 | 2.86 | 0.03 | 0.04 | 86 | 95 | −5.3 | −0.16 | −0.46 |
| | 2.80 | 2.6 | 0.05 | 0.06 | 84 | 97 | −3.2 | −0.09 | −0.49 |
| Day 7 | 3.70 | 3.41 | 0.05 | 0.07 | 86 | 95 | −4.7 | −0.17 | −0.57 |
| | 3.40 | 3.12 | 0.08 | 0.10 | 85 | 96 | −3.8 | −0.12 | −0.55 |
| | 3.10 | 2.689 | 0.06 | 0.08 | 87 | 96 | −4.4 | −0.13 | −0.43 |
| | 2.80 | 2.53 | 0.06 | 0.08 | 82 | 94 | −6.0 | −0.16 | −0.56 |
| Minimum | 2.80 | 2.53 | 0.02 | 0.02 | 82 | 94 | −6.0 | −0.17 | −0.57 |
| Maximum | 3.70 | 3.98 | 0.08 | 0.10 | 91 | 98 | −2.2 | −0.07 | −0.43 |

### 3. Conclusions

A maximum loss of 0.57 log IU/mL was recorded (Table 16 and FIG. 18) between the frozen plasma as compared to the plasma samples stored on the ViveST devices of the invention over a seven day period at ambient temperature. A linear fit (R²>0.99) was retained over the course of the 7-day study as indicated by linear regression analysis of each level across all time points (FIG. 16): R² value of 0.9942 for Day 1 samples; R² value of 0.9987 for Day 3 samples; and R² value of 0.9924 for Day 7 samples. The remarkable result here is the fact that regardless of the level of viral RNA loaded onto the polyolefin matrix in the ViveST devices of the invention, a very reproducible, predicable, and quantifiable loss was demonstrated over time with R² values at each viral RNA level >0.99.

### Example 13

### 21-Day Stability Studies for HCV with the Storage Condition Comparison

### 1. Experimental Design

The purpose of this study was to assess the ViveST devices of the invention for storage of HCV infectious samples at various storage conditions over a 21-day period. HCV infectious samples at four concentrations were added to the ViveST devices of the invention on Day 0 and dried overnight. The ViveST devices were then sealed by capping and moved stored at ambient conditions (lab bench), 4° C. (refrigerator), and 40° C./75% RH (microclimate chamber). Samples (5 replicates each level) were recovered from the ViveST devices and analyzed with the Abbott REALTIME HCV assay on Day 1, Day 3, Day 7, Day 10, Day 14, and Day 21. As a control, frozen plasma samples (5 replicates each level) were analyzed on Day 1. Negative controls were included with each time point. The assay design is shown in Table 17.

TABLE 17
Assay Design for HCV 21-Day Stability Studies
with Storage Condition Comparisons

| Storage | Days in | Level | Level | Level | Level | Neg |
|---|---|---|---|---|---|---|
| Condition | Storage | 1 | 2 | 3 | 4 | Control |
| Frozen | 0 | 5 | 5 | 5 | 5 | 1 |
| Ambient | 1 | 5 | 5 | 5 | 5 | 1 |
| | 3 | 5 | 5 | 5 | 5 | 1 |
| | 7 | 5 | 5 | 5 | 5 | 1 |
| | 10 | 5 | 5 | 5 | 5 | 1 |
| | 14 | 5 | 5 | 5 | 5 | 1 |
| | 21 | 5 | 5 | 5 | 5 | 1 |
| | EXTRA* | 5 | 5 | 5 | 5 | 1 |
| 4° C. | 1 | 5 | 5 | 5 | 5 | 1 |
| | 3 | 5 | 5 | 5 | 5 | 1 |
| | 7 | 5 | 5 | 5 | 5 | 1 |
| | 10 | 5 | 5 | 5 | 5 | 1 |
| | 14 | 5 | 5 | 5 | 5 | 1 |
| | 21 | 5 | 5 | 5 | 5 | 1 |
| | EXTRA* | 5 | 5 | 5 | 5 | 1 |
| MicroClimate | 1 | 5 | 5 | 5 | 5 | 1 |
| Chamber | 3 | 5 | 5 | 5 | 5 | 1 |
| (40 C./75% RH) | 7 | 5 | 5 | 5 | 5 | 1 |
| | 10 | 5 | 5 | 5 | 5 | 1 |
| | 14 | 5 | 5 | 5 | 5 | 1 |
| | 21 | 5 | 5 | 5 | 5 | 1 |
| | EXTRA* | 5 | 5 | 5 | 5 | 1 |

*= In the event of a run failure, one extra set of samples was made for each storage condition. If not used, these samples were stored for future analysis.

### 2. Procedure

a) Prepared HCV positive samples Levels 1-4 by diluting a high titer HCV infectious plasma sample into HCV negative (normal) human plasma (Table 17), use HCV negative plasma for negative controls;

b) Vortexed each sample to ensure adequate mixing;

c) Obtained 441 ViveST devices of the invention and labeled the cap of each with the sample designations, 21 of these ViveST devices were used for negative controls as described in Table 17, additional aliquots (5 for each level+1 negative control) were stored at −80° C. and tested concurrently with the Day 1 samples;

d) Loaded 1 ViveST device for each sample (1.0 mL each) and 1 mL negative human plasma onto each negative control;

e) Dried the loaded matrixes in the ViveST devices in a laminar flow hood for at least 12 hours but not more than 36 hours, designated the load/recovery dates/times on the assay worksheet;

f) Recovered samples from the ViveST devices using water; and

g) Processed the samples following the Abbott REALTIME HCV assay package insert.

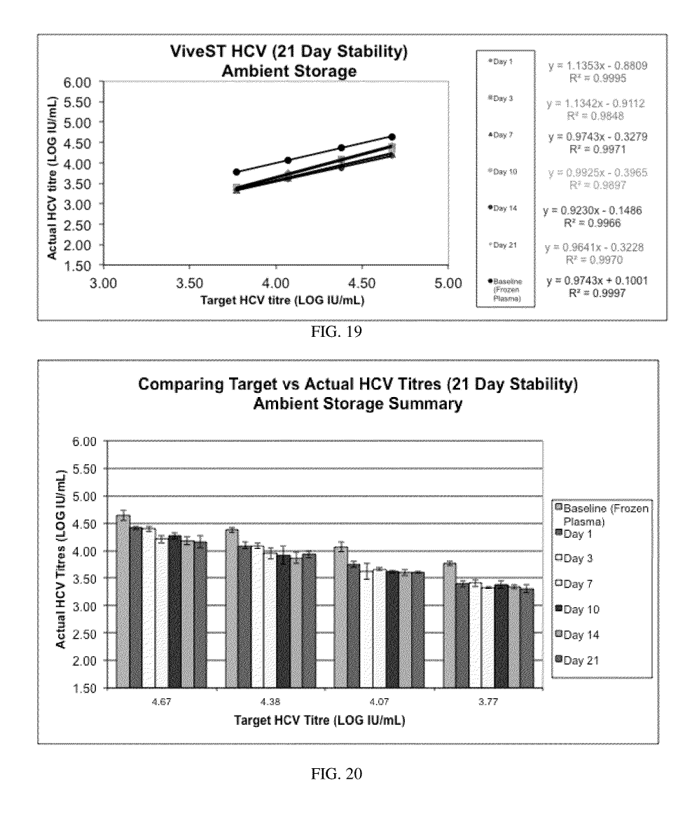

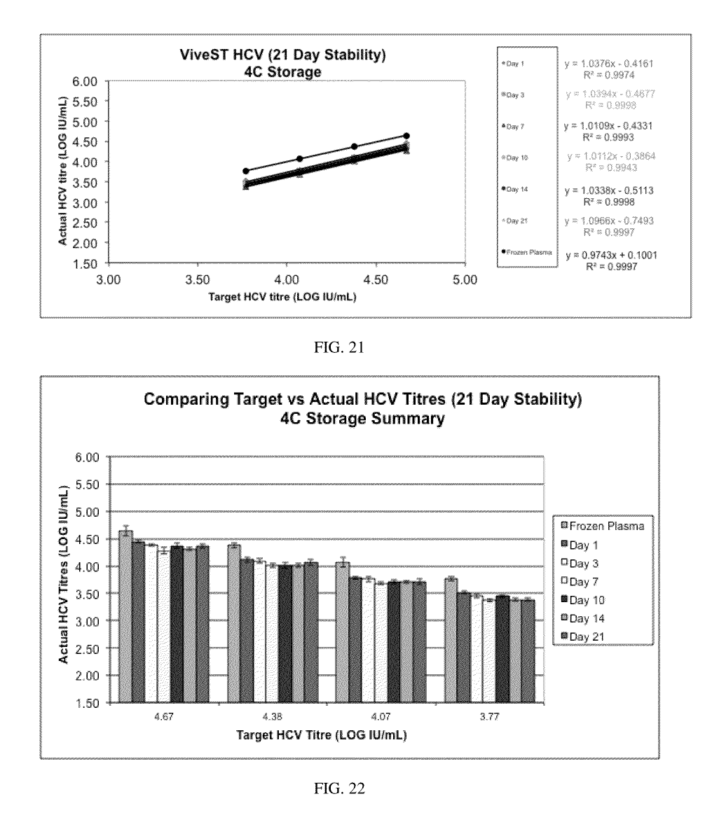

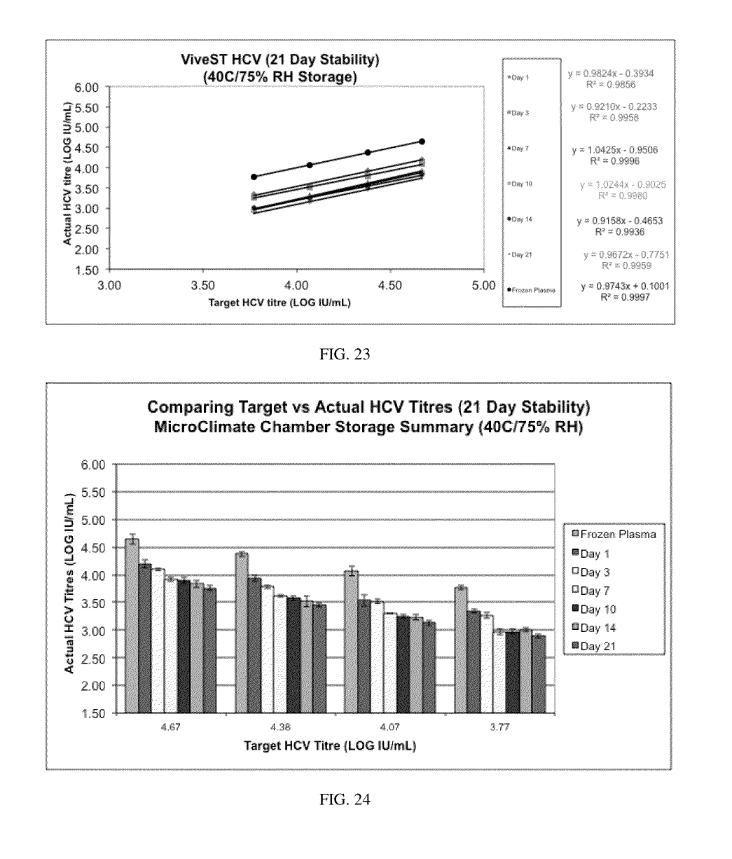

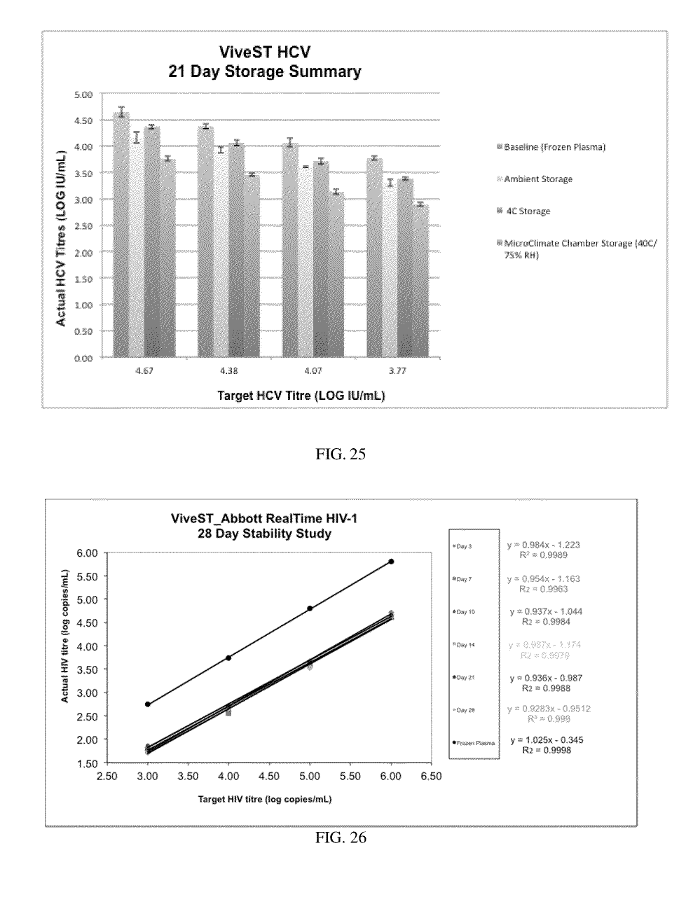

### 3. Results—Results are Provided in Table 18-Table 20 and FIG. 19-FIG. 25.

TABLE 18
Results Summary for the HCV 21-Day Stability Study at Ambient
Storage Condition using the Abbott REALTIME HCV Assay

| Target | | | | | | | |
|---|---|---|---|---|---|---|---|
| HCV titre | Mean Results - Ambient Storage (Days) | | | | | | |
| (log IU/mL) | Frozen | 1 | 3 | 7 | 10 | 14 | 21 |
| 4.67 | 4.64 | 4.42 | 4.39 | 4.21 | 4.27 | 4.18 | 4.16 |
| 4.38 | 4.38 | 4.09 | 4.09 | 3.95 | 3.91 | 3.87 | 3.93 |
| 4.07 | 4.07 | 3.75 | 3.63 | 3.66 | 3.61 | 3.60 | 3.60 |
| 3.77 | 3.77 | 3.39 | 3.41 | 3.33 | 3.38 | 3.35 | 3.30 |

TABLE 19
Results Summary for the HCV 21-Day Stability Study at 4°
C. Storage Condition using the Abbott REALTIME HCV Assay

| Target | | | | | | | |
|---|---|---|---|---|---|---|---|
| HCV titre | Mean Results - 4° C. Storage (Days) | | | | | | |
| (log IU/mL) | Frozen | 1 | 3 | 7 | 10 | 14 | 21 |
| 4.67 | 4.64 | 4.45 | 4.38 | 4.28 | 4.36 | 4.32 | 4.37 |
| 4.38 | 4.38 | 4.11 | 4.09 | 4.01 | 4.01 | 4.01 | 4.06 |
| 4.07 | 4.07 | 3.79 | 3.76 | 3.68 | 3.71 | 3.70 | 3.71 |
| 3.77 | 3.77 | 3.51 | 3.45 | 3.37 | 3.45 | 3.38 | 3.38 |

TABLE 20
Results Summary for the HCV 21-Day Stability Study at 40°
C./75% RH Storage Condition using the Abbott REALTIME HCV Assay

| Target | Mean Results - MIcroClimate Chamber Storage, | | | | | | |
|---|---|---|---|---|---|---|---|
| HCV titre | 40° C./75% RH (Days) | | | | | | |
| (log IU/mL) | Frozen | 1 | 3 | 7 | 10 | 14 | 21 |
| 4.67 | 4.64 | 4.20 | 4.10 | 3.91 | 3.89 | 3.84 | 3.76 |
| 4.38 | 4.38 | 3.93 | 3.78 | 3.62 | 3.58 | 3.52 | 3.45 |
| 4.07 | 4.07 | 3.54 | 3.52 | 3.30 | 3.25 | 3.24 | 3.13 |
| 3.77 | 3.77 | 3.35 | 3.26 | 2.97 | 2.98 | 3.01 | 2.89 |

### 4. Conclusions

For samples stored at ambient temperature, a maximum loss of 0.51 LOG IU/mL (range −0.23 to −0.51 LOG IU/mL) was recorded between the frozen plasma and the plasma samples stored on the ViveST devices of the invention over a 21-day period. The Standard Deviation across all levels/all test points ranged from 0.01 to 0.17. For samples stored at 4° C., a maximum loss of 0.40 LOG IU/mL (range −0.20 to −0.40 LOG IU/mL) was recorded between the frozen plasma and the plasma samples stored on the ViveST devices of the invention over a 21-day period. The Standard Deviation across all levels/all test points ranged from 0.02 to 0.09. For samples stored in the microclimate chamber at 40° C./75% RH, a maximum loss of 0.93 LOG IU/mL (range −0.42 to −0.93 LOG IU/mL) was recorded between the frozen plasma and the plasma samples stored on the ViveST devices of the invention over a 21-day period. The Standard Deviation across all levels/all test points ranged from 0.01 to 0.11.

A linear fit (R²>0.98) was retained over the course of the 21-day study as indicated by linear regression analysis across all test points and all storage conditions (FIGS. 19, 21, and 23). A summary of linear regression results for Day 21 analysis is: R² value of 0.9970 for ambient storage; R² value of 0.9997 for 4° C. storage; and R² value of 0.9959 for 40° C./75% RH storage.

### Example 14

### 28-Day Stability Studies for HIV at Ambient Conditions using the Abbott REALTIME Using HIV-1 Assay

### 1. Experimental Design

The purpose of this study was to assess the ViveST devices of the invention for storage of HIV-1 infectious samples at ambient conditions over at least a twenty-eight day period.

HIV-1 infectious samples at four concentrations were added to the ViveST devices of the invention on Day 0 and dried overnight. The ViveST devices were then sealed by capping and stored at ambient conditions. Samples were recovered and analyzed with the Abbott REALTIME HIV-1 assay on Days 1, 3, 7, 10, 14, 21, and 28. Five replicates of four concentration levels of ˜3, ˜4, ˜5, and ˜6 log copies/mL were analyzed at each test point. Negative controls were included with each time point. Additional aliquots of each plasma sample will be maintained at −80° C. for additional testing.

### 2. Procedures

a) Prepared HIV-1 positive samples Levels 1-4 by linear dilution (Table 21), used HIV-1 negative plasma for negative controls;

b) Vortexed each sample to ensure adequate mixing;

c) Obtained 140 ViveST devices of the invention and labeled the cap of each with the sample designations, obtained an additional 7 ViveST devices for negative controls;

d) Load 1 ViveST for each sample (1.15 mL each) and 1.15 mL negative human plasma onto each negative control; the Abbott REALTIME HIV-1 0.6 mL application requires 1.1 mL sample, therefore, 1.15 mL sample was loaded/recovered on the ViveST devices to ensure adequate recovery;

e) Dried the loaded matrixes in the ViveST devices in a laminar flow hood for at least 12 hours but not more than 36 hours, designated the load/recovery dates on the assay worksheet; once dried, capped the ViveST devices and stored at ambient laboratory conditions;

f) Recovered samples from the ViveST devices using water (1.15 mL each); and

g) Processed the samples following the Abbott REALTIME HIV-1 assay package insert (0.6 mL application).

### 3. Results—Results are Provided in Table 21, Table 22, FIG. 26, and FIG. 27.

TABLE 21
Mean HIV-1 Titers for HIV-1 Stability Studies at Ambient
Conditions using the Abbott REALTIME HIV-1 Assay

| Target | | | | | | | |
|---|---|---|---|---|---|---|---|
| HIV-1 titre | Test points (Days Stored on the ViveST Devices) | | | | | | |
| (log c/mL) | Nominal | 3 | 7 | 10 | 14 | 21 | 28 |
| 3 | 2.74 | 1.75 | 1.77 | 1.81 | 1.72 | 1.86 | 1.87 |
| 4 | 3.73 | 2.71 | 2.56 | 2.66 | 2.66 | 2.71 | 2.71 |
| 5 | 4.80 | 3.64 | 3.58 | 3.60 | 3.53 | 3.67 | 3.70 |
| 6 | 5.80 | 4.72 | 4.61 | 4.62 | 4.62 | 4.66 | 4.63 |

Note:
Results of storage on the ViveST device for 1 Day were not presented. There was a fatal run error on the Abbott m2000sp resulting in the loss of all samples and no results were obtained.

TABLE 22
Result Summary for the HIV-1 Stability Studies at Ambient
Conditions using the Abbott REALTIME HIV-1 Assay

| | Target | Mean HIV | | | Mean loss |
|---|---|---|---|---|---|
| | HIV | titre | HIV titre | | (log c/mL) |
| | titre (log | results | Standard | | ViveST from |
| Test point | c/mL) | (log c/mL) | Deviation | % CV | frozen plasma |
| Frozen | 3.00 | 2.74 | 0.16 | 0.20 | Not |
| Plasma | 4.00 | 3.73 | 0.04 | 0.05 | applicable |
| | 5.00 | 4.80 | 0.03 | 0.03 | |
| | 6.00 | 5.80 | 0.05 | 0.06 | |
| Day 3 | 3.00 | 1.75 | 0.05 | 0.07* | −0.99 |
| | 4.00 | 2.71 | 0.06* | 0.08 | −1.02 |
| | 5.00 | 3.64 | 0.06 | 0.07 | −1.15 |
| | 6.00 | 4.72 | 0.03 | 0.03 | −1.08 |
| Day 7 | 3.00 | 1.77 | 0.28 | 0.36* | −0.97 |
| | 4.00 | 2.56 | 0.08 | 0.10 | −1.17 |
| | 5.00 | 3.58* | 0.03 | 0.04 | −1.22* |
| | 6.00 | 4.61 | 0.09 | 0.11 | −1.19 |
| Day 10 | 3.00 | 1.81 | 0.13 | 0.16 | −0.94* |
| | 4.00 | 2.66 | 0.11 | 0.14 | −1.07 |
| | 5.00 | 3.60 | 0.06 | 0.08 | −1.20 |
| | 6.00 | 4.62 | 0.05 | 0.06 | −1.18 |
| Day 14 | 3.00 | 1.72 | 0.10 | 0.14 | −1.03* |
| | 4.00 | 2.66 | 0.13 | 0.16 | −1.07 |
| | 5.00 | 3.53 | 0.15 | 0.19 | −1.27 |
| | 6.00 | 4.62 | 0.05 | 0.07 | −1.18 |
| Day 21 | 3.00 | 1.86 | 0.17 | 0.21 | −0.88 |
| | 4.00 | 2.71 | 0.04 | 0.04 | −1.02 |
| | 5.00 | 3.67 | 0.05 | 0.06 | −1.13 |
| | 6.00 | 4.66 | 0.04 | 0.04 | −1.14 |
| Day 28 | 3.00 | 1.87 | 0.21 | 0.26 | −0.87 |
| | 4.00 | 2.71 | 0.06 | 0.07 | −1.02 |
| | 5.00 | 3.70 | 0.08 | 0.10 | −1.10 |
| | 6.00 | 4.63 | 0.06 | 0.07 | −1.17 |
| Minimum | 3.00 | 1.72 | 0.03 | 0.03 | −1.27 |
| Maximum | 6.00 | 5.80 | 0.28 | 0.36 | −0.87 |

| | |
|---|---|
| Mean Loss (log c/mL) ViveST Compared to | −1.09 |
| Frozen Plasma | |

*= Data previously reported incorrectly. Data has been corrected here-in

### 4. Conclusions

All analysis was performed using the Abbott REALTIME HIV-1 assay (0.6 mL application). For the analytical measure range testing, samples stored on the ViveST devices for 1 day resulted in a mean loss of 0.60 log c/mL when compared to frozen samples (Example 11, HIV-1 Validation (Linearity and Precision)).

A mean loss of 1.09 log c/mL (Range=−0.87 log c/mL-1.27 log copies/mL) was recorded (Table 22) between the frozen plasma and the plasma samples stored on the ViveST devices of the invention over a 28-day period at ambient temperature. A linear fit (R²>0.9963) was retained over the course of the 28 day study as indicated by linear regression analysis of each level across all time points (FIG. 26): R² value of 0.9989 for Day 3 samples; R² value of 0.9963 for Day 7 samples; R² value of 0.9984 for Day 10 samples; R² value of 0.9979 for Day 14 samples; R² value of 0.9988 for Day 21 samples; and R² value of 0.999 for Day 28 samples.

### Example 15

### 62-Day Stability Studies for HCV with the Storage Condition Comparisons

### 1. Experimental Design

This study served to supplement the HCV 21-day stability studies in Example 13 with additional data collected after 62 days of storage. During the original study, one extra set of samples were loaded onto the ViveST devices of the invention for each storage condition. These samples were not utilised during the original 21 day study; therefore, they remained stored at the relevant storage condition and were analyzed after 62 days. The purpose of this study was to assess the ViveST devices of the invention for storage of HCV infectious samples at various storage conditions over a 60+ day period.

HCV infectious samples at four concentrations were added to the ViveST devices of the invention on Day 0 and dried overnight. The ViveST devices were then sealed by capping and moved stored at ambient conditions (lab bench), 4° C. (refrigerator), and 40° C./75% RH (microclimate chamber). Samples (5 replicates each level) were recovered from the ViveST devices and analyzed with the Abbott REALTIME HCV Assay on Day 1, Day 3, Day 7, Day 10, Day 14, Day 21, and Day 62. As a control, frozen plasma samples (5 replicates each level) were analyzed on Day 1. Negative controls were included with each time point. The assay design is shown in Table 23.

TABLE 23
Assay Design for HCV 62-Day Stability Studies
with Storage Condition Comparisons

| Storage | Days in | Level | Level | Level | Level | Neg |
|---|---|---|---|---|---|---|
| Condition | Storage | 1 | 2 | 3 | 4 | Control |
| Frozen | 0 | 5 | 5 | 5 | 5 | 1 |
| Ambient | 1 | 5 | 5 | 5 | 5 | 1 |
| | 3 | 5 | 5 | 5 | 5 | 1 |
| | 7 | 5 | 5 | 5 | 5 | 1 |
| | 10 | 5 | 5 | 5 | 5 | 1 |
| | 14 | 5 | 5 | 5 | 5 | 1 |
| | 21 | 5 | 5 | 5 | 5 | 1 |
| | 62 | 5 | 5 | 5 | 5 | 1 |
| 4° C. | 1 | 5 | 5 | 5 | 5 | 1 |
| | 3 | 5 | 5 | 5 | 5 | 1 |
| | 7 | 5 | 5 | 5 | 5 | 1 |
| | 10 | 5 | 5 | 5 | 5 | 1 |
| | 14 | 5 | 5 | 5 | 5 | 1 |
| | 21 | 5 | 5 | 5 | 5 | 1 |
| | 62 | 5 | 5 | 5 | 5 | 1 |
| MicroClimate | 1 | 5 | 5 | 5 | 5 | 1 |
| Chamber | 3 | 5 | 5 | 5 | 5 | 1 |
| (40 C./75% RH) | 7 | 5 | 5 | 5 | 5 | 1 |
| | 10 | 5 | 5 | 5 | 5 | 1 |
| | 14 | 5 | 5 | 5 | 5 | 1 |
| | 21 | 5 | 5 | 5 | 5 | 1 |
| | 62 | 5 | 5 | 5 | 5 | 1 |

### 2. Procedure

a) Prepared HCV positive samples Levels 1-4 by diluting a high titer HCV infectious plasma sample into HCV negative (normal) human plasma (Table 23), used HCV negative plasma for negative controls;

b) Vortexed each sample to ensure adequate mixing;

c) Obtained 441 ViveST devices of the invention and labeled the cap of each with the sample designations, 21 of these ViveST devices were used for negative controls as described in Table 23, additional aliquots (5 for each level+1 negative control) were stored at −80° C. and tested concurrently with the Day 1 samples;

d) Loaded 1 ViveST device for each sample (1.0 mL each) and 1 mL negative human plasma onto each negative control;

e) Dried the loaded matrixes in the ViveST devices in a laminar flow hood for at least 12 hours but not more than 36 hours, designated the load/recovery dates/times on the assay worksheet;

f) Recovered samples from the ViveST devices using water; and

g) Processed the samples following the Abbott REALTIME HCV package insert.

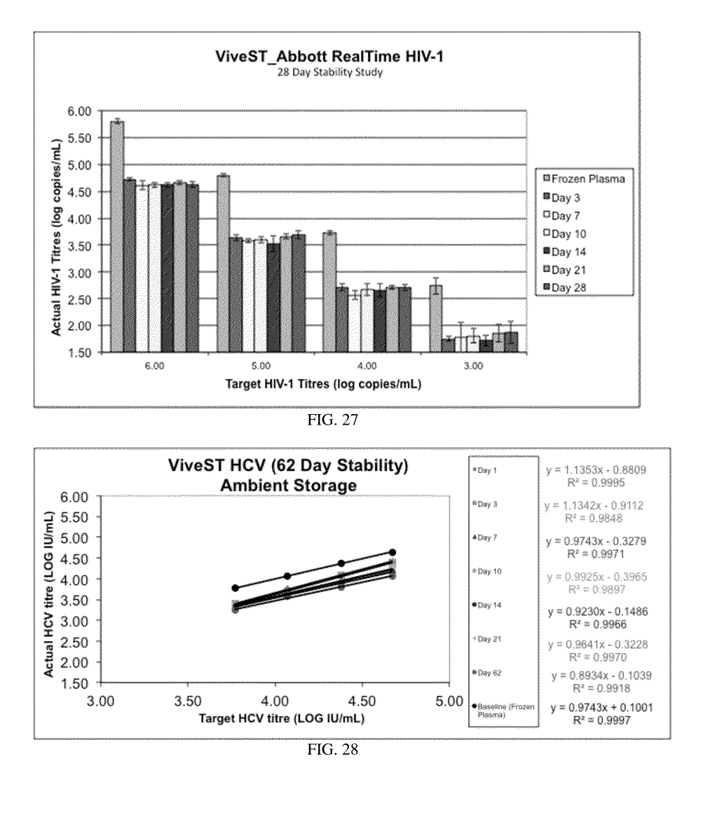

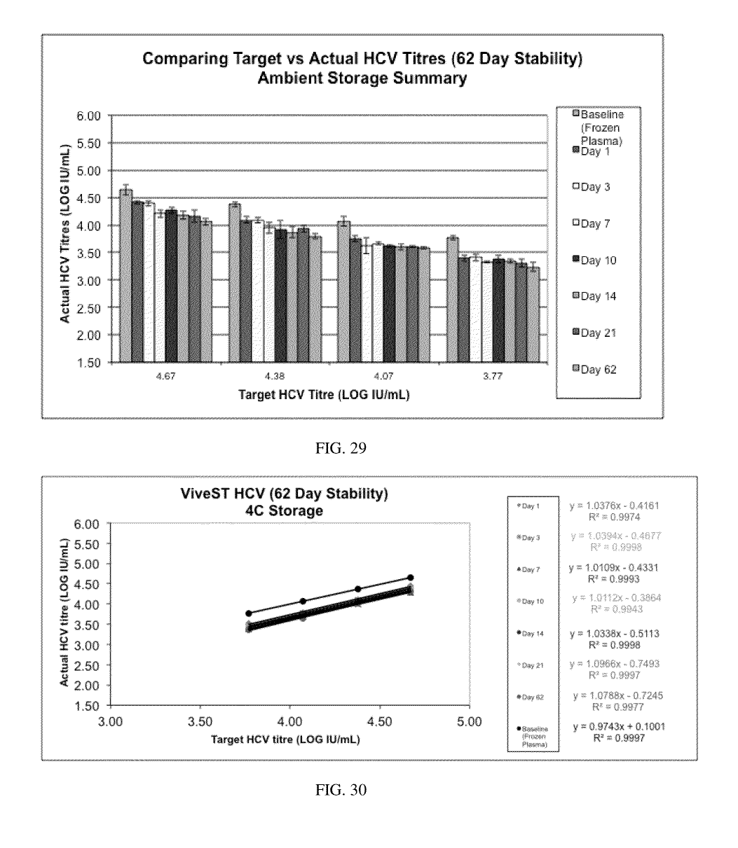

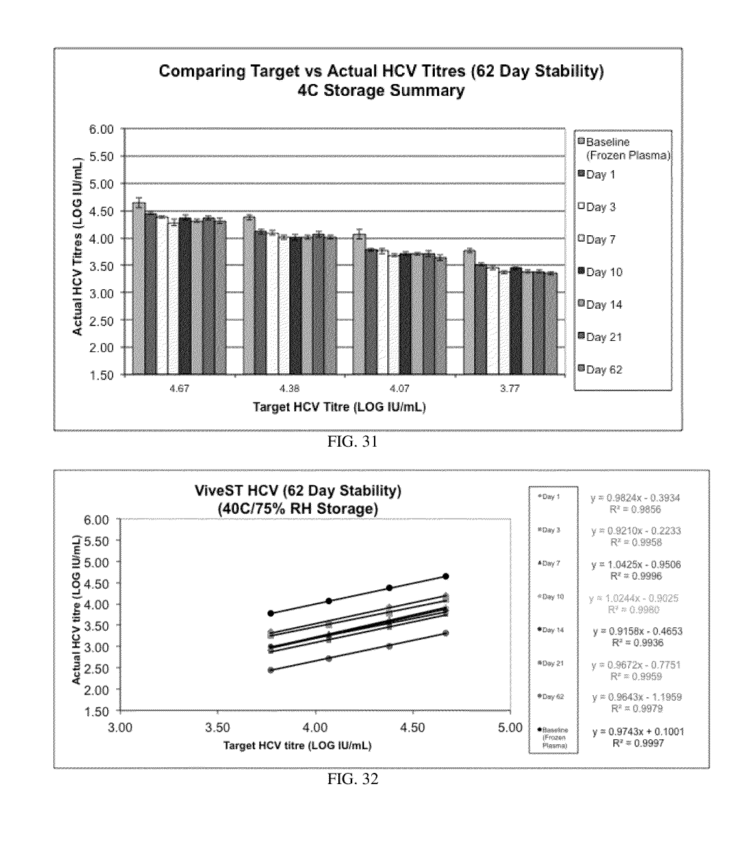

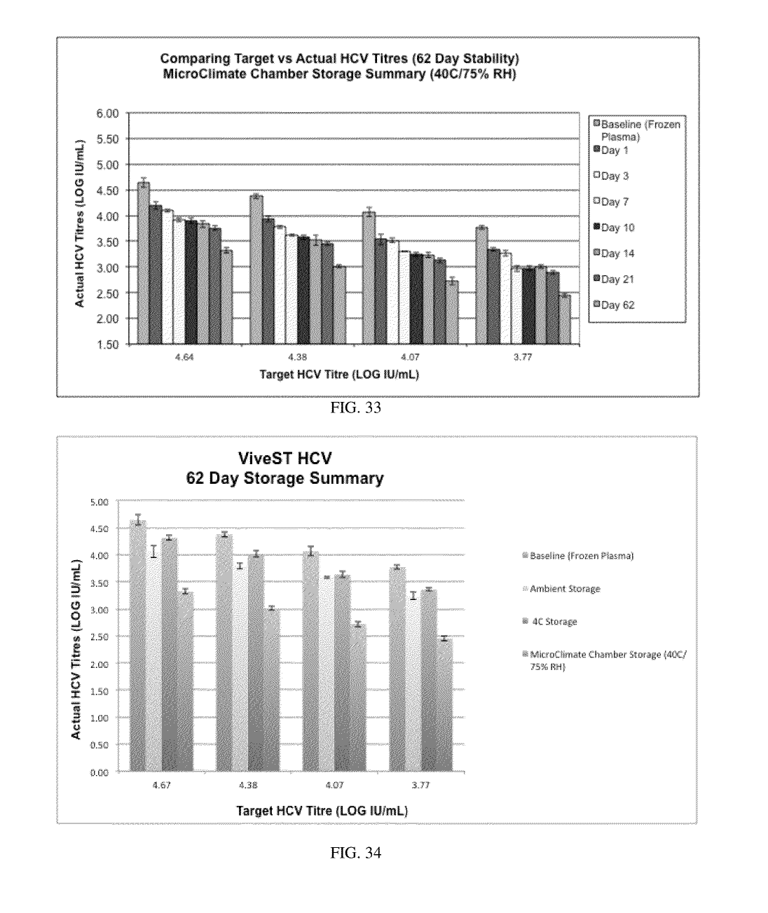

### 3. Results—Results are Provided in Table 24-Table 26 and FIG. 28-FIG. 34.

TABLE 24
Results Summary for the HCV 62-Day Stability Studies at Ambient
Storage Condition using the Abbott REALTIME HCV Assay

| Target | | | | | | | | |
|---|---|---|---|---|---|---|---|---|
| HCV titre | Mean Results - Ambient Storage | | | | | | | |
| (log IU/mL) | Frozen | 1 | 3 | 7 | 10 | 14 | 21 | 62 |
| 4.67 | 4.64 | 4.42 | 4.39 | 4.21 | 4.27 | 4.18 | 4.16 | 4.06 |
| 4.38 | 4.38 | 4.09 | 4.09 | 3.95 | 3.91 | 3.87 | 3.93 | 3.80 |
| 4.07 | 4.07 | 3.75 | 3.63 | 3.66 | 3.61 | 3.60 | 3.60 | 3.58 |
| 3.77 | 3.77 | 3.39 | 3.41 | 3.33 | 3.38 | 3.35 | 3.30 | 3.24 |

TABLE 25
Results Summary for the HCV 62-Day Stability Studies at 4°
C. Storage Condition using the Abbott REALTIME HCV Assay

| Target | | | | | | | | |
|---|---|---|---|---|---|---|---|---|
| HCV titre | Mean Results - 4° C. Storage | | | | | | | |
| (log IU/mL) | Frozen | 1 | 3 | 7 | 10 | 14 | 21 | 62 |
| 4.67 | 4.64 | 4.45 | 4.38 | 4.28 | 4.36 | 4.32 | 4.37 | 4.31 |
| 4.38 | 4.38 | 4.11 | 4.09 | 4.01 | 4.01 | 4.01 | 4.06 | 4.02 |
| 4.07 | 4.07 | 3.79 | 3.76 | 3.68 | 3.71 | 3.70 | 3.71 | 3.64 |
| 3.77 | 3.77 | 3.51 | 3.45 | 3.37 | 3.45 | 3.38 | 3.38 | 3.36 |

TABLE 26
Results Summary for the HCV 62-Day Stability Studies at 40°
C./75% RH Storage Condition using the Abbott REALTIME HCV Assay

| Target | Mean Results - MIcroClimate Chamber Storage | | | | | | | |
|---|---|---|---|---|---|---|---|---|
| HCV titre | (40° C./75% RH) | | | | | | | |
| (log IU/mL) | Frozen | 1 | 3 | 7 | 10 | 14 | 21 | 62 |
| 4.67 | 4.64 | 4.20 | 4.10 | 3.91 | 3.89 | 3.84 | 3.76 | 3.32 |
| 4.38 | 4.38 | 3.93 | 3.78 | 3.62 | 3.58 | 3.52 | 3.45 | 3.01 |
| 4.07 | 4.07 | 3.54 | 3.52 | 3.30 | 3.25 | 3.24 | 3.13 | 2.72 |
| 3.77 | 3.77 | 3.35 | 3.26 | 2.97 | 2.98 | 3.01 | 2.89 | 2.45 |

### 4. Conclusions

For samples stored at ambient temperature, a maximum loss of 0.58 LOG IU/mL (range −0.23 to −0.58 LOG IU/mL) was recorded between the frozen plasma and the plasma samples stored on the ViveST devices of the invention over a 62-day period. The Standard Deviation across all levels/all test points ranged from 0.01 to 0.17. For samples stored at 4° C., a maximum loss of 0.43 LOG IU/mL (range −0.20 to −0.43 LOG IU/mL) was recorded between the frozen plasma and the plasma samples stored on the ViveST devices of the invention over a 62-day period. The Standard Deviation across all levels/all test points ranged from 0.02 to 0.09. For samples stored in the microclimate chamber at 40° C./75% RH, a maximum loss of 1.37 LOG IU/mL (range −0.42 to −1.37 LOG IU/mL) was recorded between the frozen plasma and the plasma samples stored on the ViveST devices of the invention over a 62-day period. The Standard Deviation across all levels/all test points ranged from 0.01 to 0.11. For samples stored in the microclimate chamber, an average loss of 0.88 LOG IU/mL was recorded between the samples stored on the ViveST devices of the invention for 1 day and samples stored for 62 days.

A linear fit (R²>0.98) was retained over the course of the 62-day study as indicated by linear regression analysis across all test points and all storage conditions (FIGS. 28, 30, and 32). A summary of linear regression results for Day 62 analysis is: R² value of 0.9918 for ambient storage; R² value of 0.9977 for 4° C. storage; and R² value of 0.9979 for 40° C./75% RH storage.

### Example 16

### 62-Day Stability Studies for HIV with Storage Condition Comparisons

### 1. Experimental Design

The purpose of this study was to assess the ViveST devices of the invention for storage of HIV-1 infectious samples at various storage conditions over a 62-day period.

HIV-1 infectious samples at four concentrations were added to the ViveST devices of the invention on Day 0 and dried overnight. The ViveST devices were then be sealed by capping and moved stored at ambient conditions (lab bench), 4° C. (refrigerator), and 40° C./75% RH (microclimate chamber). Samples (5 replicates each level) were recovered from the ViveST devices and analyzed with the Abbott REALTIME HIV-1 assay on Day 1, Day 3, Day 7, Day 10, Day 14, Day 21, and Day 62. As a control, frozen plasma samples (5 replicates each level) were analyzed on Day 1. Negative controls were included with each time point. The assay design is shown in Table 27.

TABLE 27
Assay Design for HIV-1 62-Day Stability Studies
with Storage Condition Comparisons

| Storage | Days in | Level | Level | Level | Level | Neg |
|---|---|---|---|---|---|---|
| Condition | Storage | 1 | 2 | 3 | 4 | Control |
| Frozen | 0 | 5 | 5 | 5 | 5 | 1 |
| Ambient | 1 | 5 | 5 | 5 | 5 | 1 |
| | 3 | 5 | 5 | 5 | 5 | 1 |
| | 7 | 5 | 5 | 5 | 5 | 1 |
| | 10 | 5 | 5 | 5 | 5 | 1 |
| | 14 | 5 | 5 | 5 | 5 | 1 |
| | 21 | 5 | 5 | 5 | 5 | 1 |
| | 62 | 5 | 5 | 5 | 5 | 1 |
| 4° C. | 1 | 5 | 5 | 5 | 5 | 1 |
| | 3 | 5 | 5 | 5 | 5 | 1 |
| | 7 | 5 | 5 | 5 | 5 | 1 |
| | 10 | 5 | 5 | 5 | 5 | 1 |
| | 14 | 5 | 5 | 5 | 5 | 1 |
| | 21 | 5 | 5 | 5 | 5 | 1 |
| | 62 | 5 | 5 | 5 | 5 | 1 |
| MicroClimate | 1 | 5 | 5 | 5 | 5 | 1 |
| Chamber | 3 | 5 | 5 | 5 | 5 | 1 |
| (40° C./75% RH) | 7 | 5 | 5 | 5 | 5 | 1 |
| | 10 | 5 | 5 | 5 | 5 | 1 |
| | 14 | 5 | 5 | 5 | 5 | 1 |
| | 21 | 5 | 5 | 5 | 5 | 1 |
| | 62 | 5 | 5 | 5 | 5 | 1 |

### 2. Procedures

a) Prepared HIV-1 positive samples Levels 1-4 by diluting a high titer HIV-1 infectious plasma sample into HIV-1 negative (normal) human plasma (Table 27), used HIV-1 negative plasma for negative controls;

b) Vortexed each sample to ensure adequate mixing;

c) Obtained 441 ViveST devices of the invention and labeled the cap of each with the sample designations, 21 of these ViveST devices were used for negative controls as described in Table 27, additional aliquots (5 for each level+1 negative control) were stored at −80° C. and tested concurrently with the Day 1 samples;

d) Loaded 1 ViveST device for each sample (1.1 mL each) and 1.1 mL negative human plasma onto each negative control, the Abbott REALTIME HIV-1 0.6 mL application requires 1.1 mL sample, therefore, 1.15 mL sample was loaded on each ViveST device to ensure adequate recovery volume;

e) Dried the loaded matrixes in the ViveST devices in a laminar flow hood for at least 12 hours but not more than 36 hours, designated the load/recovery dates/times on the assay worksheet;

f) Recovered samples from the ViveST devices using water (1.15 mL each); and

g) Processed the samples following the Abbott REALTIME HIV-1 assay package insert (0.6 mL application).

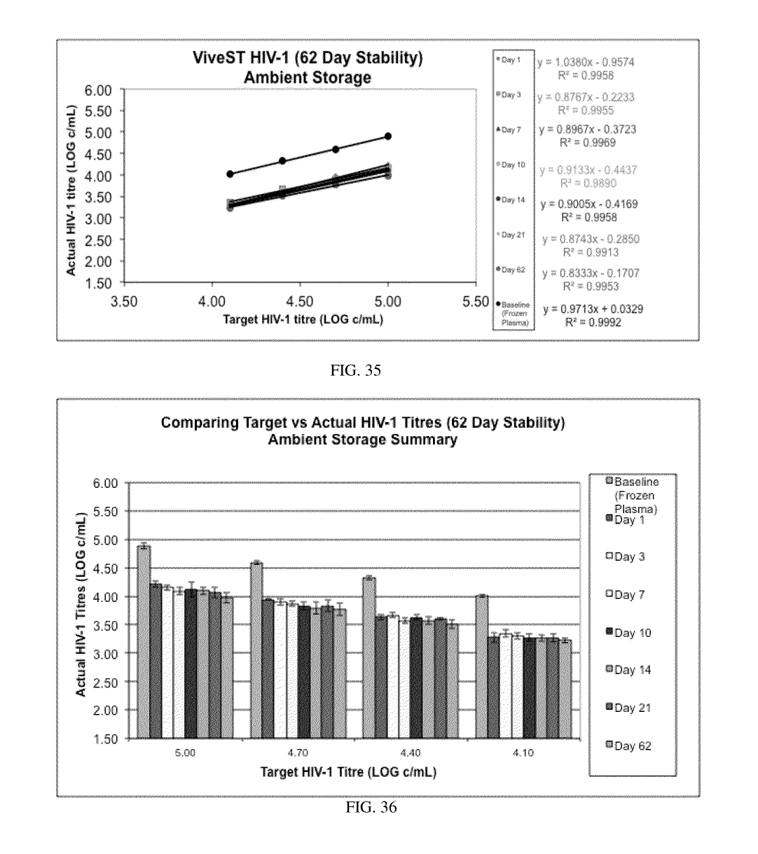

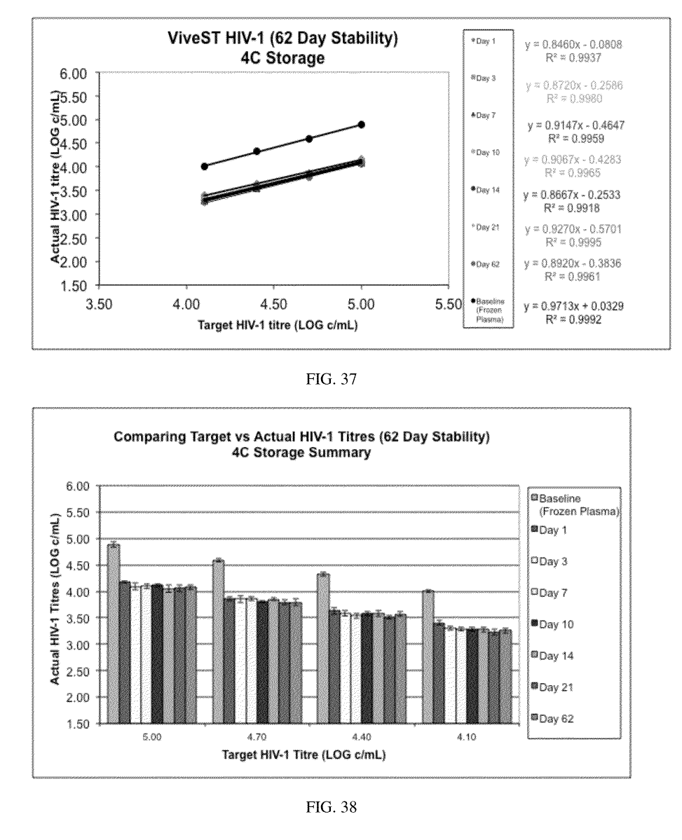

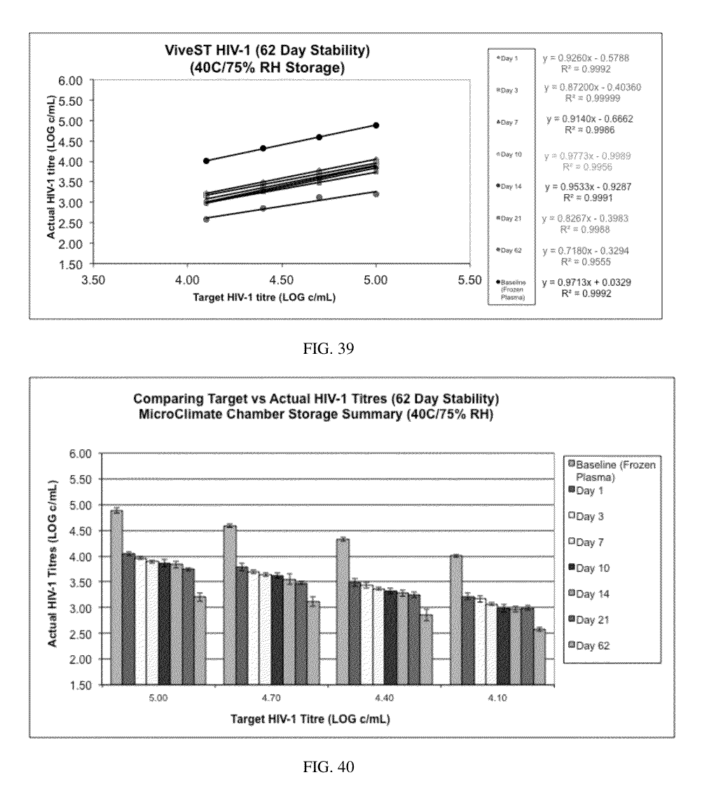

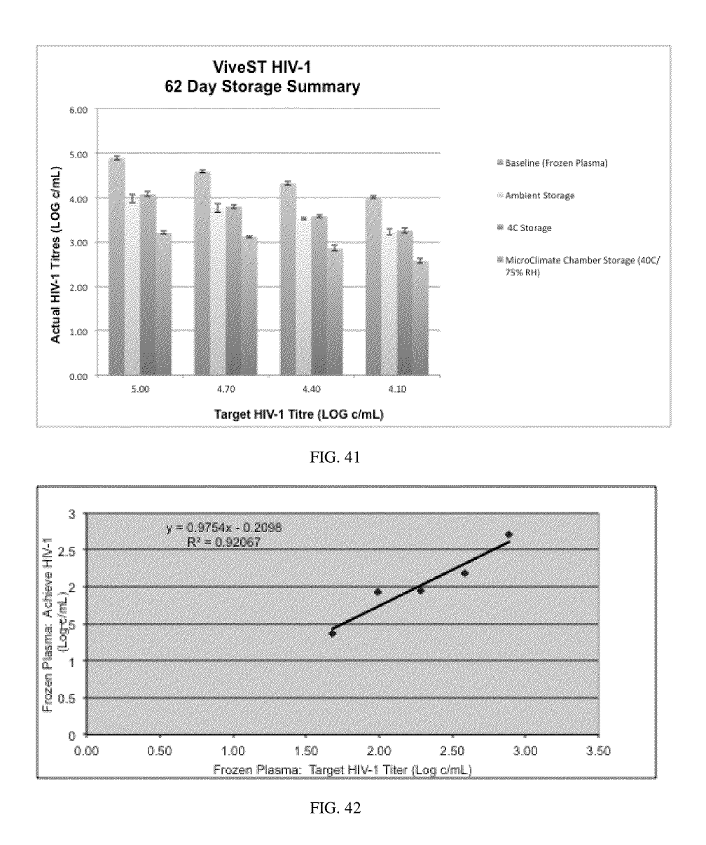

3. Results—Results are provided in Table 28-Table 30 and FIG. 35-FIG. 41.

TABLE 28
Results Summary for the HIV-1 62-Day Stability Studies at Ambient
Storage Condition using the Abbott REALTIME HIV-1 Assay

| Target | | | | | | | | |
|---|---|---|---|---|---|---|---|---|
| HIV-1 titre | Mean Results - Ambient Storage | | | | | | | |
| (log c/mL) | Frozen | 1 | 3 | 7 | 10 | 14 | 21 | 62 |
| 5.00 | 4.89 | 4.21 | 4.15 | 4.09 | 4.12 | 4.10 | 4.07 | 3.98 |
| 4.70 | 4.59 | 3.94 | 3.90 | 3.87 | 3.82 | 3.79 | 3.83 | 3.77 |
| 4.40 | 4.32 | 3.63 | 3.67 | 3.57 | 3.63 | 3.57 | 3.61 | 3.51 |
| 4.10 | 4.01 | 3.28 | 3.35 | 3.30 | 3.27 | 3.27 | 3.27 | 3.23 |

TABLE 29
Results Summary for the HIV-1 62-Day Stability Studies at 4°
C. Storage Condition using the Abbott REALTIME HIV-1 Assay

| Target | | | | | | | | |
|---|---|---|---|---|---|---|---|---|
| HIV-1 titre | Mean Results - 4° C. Storage | | | | | | | |
| (log c/mL) | Frozen | 1 | 3 | 7 | 10 | 14 | 21 | 62 |
| 5.00 | 4.89 | 4.17 | 4.09 | 4.10 | 4.11 | 4.05 | 4.06 | 4.08 |
| 4.70 | 4.59 | 3.86 | 3.85 | 3.86 | 3.81 | 3.85 | 3.79 | 3.79 |
| 4.40 | 4.32 | 3.63 | 3.59 | 3.54 | 3.58 | 3.58 | 3.52 | 3.57 |
| 4.10 | 4.01 | 3.40 | 3.30 | 3.29 | 3.28 | 3.28 | 3.22 | 3.26 |

TABLE 30
Results Summary for the HIV-1 62-Day Stability
Studies at 40° C./75% RH Storage Condition
using the Abbott REALTIME HIV-1 Assay

| Target | Mean Results - MIcroClimate Chamber Storage | | | | | | | |
|---|---|---|---|---|---|---|---|---|
| HIV-1 titre | (40° C./75% RH) | | | | | | | |
| (log c/mL) | Frozen | 1 | 3 | 7 | 10 | 14 | 21 | 62 |
| 5.00 | 4.89 | 4.04 | 3.96 | 3.89 | 3.86 | 3.83 | 3.74 | 3.20 |
| 4.70 | 4.59 | 3.79 | 3.70 | 3.64 | 3.62 | 3.55 | 3.47 | 3.12 |
| 4.40 | 4.32 | 3.49 | 3.43 | 3.37 | 3.31 | 3.28 | 3.25 | 2.86 |
| 4.10 | 4.01 | 3.22 | 3.17 | 3.07 | 2.99 | 2.97 | 2.99 | 2.57 |

### 4. Conclusions

For samples stored at ambient temperature, a maximum loss of 0.91 LOG c/mL (range −0.65 to −0.91 LOG c/mL) was recorded between the frozen plasma and the plasma samples stored on the ViveST devices of the invention over a 62-day period. The Standard Deviation across all levels/all test points ranged from 0.02 to 0.13. For samples stored at 4° C., a maximum loss of 0.84 LOG c/mL (range −0.60 to −0.84 LOG c/mL) was recorded between the frozen plasma and the plasma samples stored on the ViveST devices over a 62-day period. The Standard Deviation across all levels/all test points ranged from 0.02 to 0.07. For samples stored in the microclimate chamber at 40° C./75% RH, a maximum loss of 1.69 LOG c/mL (range −0.79 to −1.69 LOG c/mL) was recorded between the frozen plasma the plasma samples stored on the ViveST devices of the invention over a 62-day period. The Standard Deviation across all levels/all test points ranged from 0.02 to 0.12. For samples stored in the microclimate chamber, an average loss of 0.70 LOG c/mL was recorded between the samples stored on the ViveST devices of the invention for 1 day and samples stored for 62 days.

A linear fit (R²>0.95) was retained over the course of the 62-day study as indicated by linear regression analysis across all test points and all storage conditions (FIGS. 35, 37, and 39). A summary of linear regression results for Day 62 analysis is: R² value of 0.9953 for ambient storage; R² value of 0.9961 for 4° C. storage; and R² value of 0.9555 for 40° C./75% RH storage.

### Example 17

### HIV-1 Limited of Detection (LOD) Evaluation using the Abbott HCV Assay

### 1. Experimental Design

The purpose of this experiment was to evaluate the limit of detection (LOD) for the ViveST devices of the invention to store HIV-1 infectious plasma samples at ambient conditions over a seven day period.

HIV-1 infectious plasma samples at six linear concentrations (n=14 samples each level) were added to the ViveST devices of the invention (Day 0), placed in a laminar flow hood and dried overnight. The ViveST devices were then be sealed by capping and stored at ambient conditions for seven days. Samples were recovered from the ViveST devices on Day 7 and analyzed with the Abbott REALTIME HIV-1 assay. An additional aliquot of each concentration were stored frozen and analyzed concurrently with the recovered samples from the ViveST devices. The assay design is shown in Table 31. Additional aliquots of each plasma sample were maintained at −80° C. for additional testing. All lot numbers were recorded on the assay worksheet.

TABLE 31
Assay Design for HIV-1 LOD Studies
HIV-1 Evaluation: Limit of Detection (LOD) -
Abbott HCV Assay

| | Target Concentration | Target Concentration | |
|---|---|---|---|
| Level | (c/mL) | (LOG c/mL) | Replicates |
| 5 | 774 | 2.89 | 1 frozen |
| | | | 14 ViveST |
| 6 | 387 | 2.59 | 1 frozen |
| | | | 14 ViveST |
| 7 | 193 | 2.29 | 1 frozen |
| | | | 14 ViveST |
| 8 | 97 | 1.99 | 1 frozen |
| | | | 14 ViveST |
| 9 | 48 | 1.68 | 1 frozen |
| | | | 14 ViveST |
| 10 | 24 | 1.38 | 1 frozen |
| | | | 14 ViveST |

### 2.1 Procedures—Sample Processed Through the ViveST Devices of the Invention

a) Samples for the LOD assay were diluted from a HIV-1 positive sample with concentration of ˜8 LOG c/mL, serial dilutions were made with negative human plasma to yield samples with concentrations are described in Table 31, approximately 20 mL of each concentration was required;

b) Vortexed each sample concentration to ensure adequate mixing;

c) Obtained 84 ViveST devices of the invention and labeled the cap of each;

d) Loaded 14 ViveST devices for each sample concentration (1.15 mL each); the Abbott REALTIME HIV-1 0.6 mL application requires 1.1 mL sample, therefore, 1.15 mL sample was loaded on each ViveST device to ensure adequate recovery volume;

e) Pipetted 1.1 mL of each sample concentration into a sterile screw cap tube and stored at −80° C.;

f) Dried the loaded matrixes in the ViveST devices in a laminar flow hood for at least 12 hours but not more than 36 hours, designated the load/recovery dates/times on the assay worksheet;

g) Capped and sealed the loaded ViveST devices and stored at ambient laboratory conditions for 7 days; and

h) Recovered samples from the ViveST devices using water (1.15 mL each).

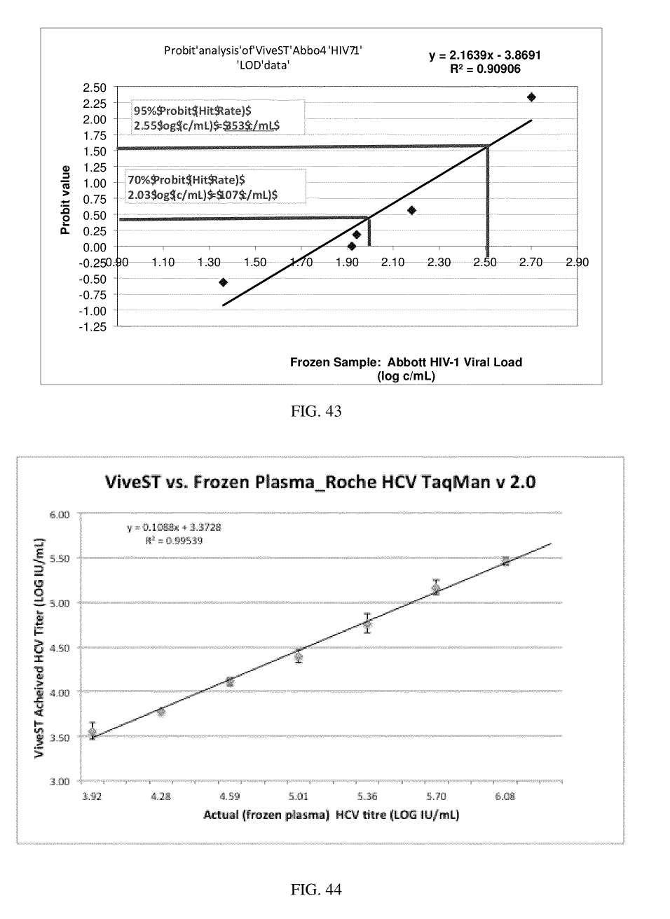

2.2 Procedure—Abbott m2000 REALTIME HCV Assay: Processed the frozen samples and the recovered samples from the ViveST devices following the Abbott REALTIME HIV-1 assay package insert (0.6 mL application).
3. Results—Results for the HIV-1 infectious frozen plasma samples not processed through the ViveST devices are presented in Table 32 and FIG. 42. Results of the HIV-1 infectious samples processed and recovered after storage on the ViveST devices for 7 days are presented in Table 33, Table 34 and FIG. 43.

TABLE 32
HIV-1 LOD Studies for Frozen Plasma Samples Not Processed
Through the ViveST Devices

| | Target | | | Achieved | Achieved |
|---|---|---|---|---|---|
| | titre | Target titre | | HIV-1 titre | HIV-1 titre |
| Level | (c/mL) | (LOG c/mL) | Sample ID | (LOG c/mL) | (c/mL) |
| 10 | 24 | 1.38 | frozen 10 | TND | TND |
| 9 | 48 | 1.68 | frozen 9 | 1.36 | 23 |
| 8 | 97 | 1.99 | frozen 8 | 1.92 | 83 |
| 7 | 193 | 2.29 | frozen 7 | 1.94 | 86 |
| 6 | 387 | 2.59 | frozen 6 | 2.18 | 150 |
| 5 | 774 | 2.89 | frozen 5 | 2.70 | 502 |

TABLE 33
Summary of the HIV-1 LOD Data (LOG c/mL) using the
Abbott REALTIME HIV-1 Assay

| | Frozen | | | | Calculated |
|---|---|---|---|---|---|
| | Sample | | | Percent | Mean |
| | Viral Load | Number | Number | Detected | Viral Load |
| Level | (LOG c/mL) | tested | Detected | (%) | (LOG c/mL) |
| 5 | 2.70 | 14 | 14 | 100% | 1.82 |
| 6 | 2.18 | 14 | 10 | 71% | 1.55 |
| 7 | 1.94 | 14 | 8 | 57% | 1.36 |
| 8 | 1.92 | 14 | 7 | 50% | 1.35 |
| 9 | 1.36 | 14 | 4 | 29% | 1.20 |
| 10 | TND | 14 | 0 | 0% | N/A |

TABLE 34
Summary of the HIV-1 LOD Data (c/mL) using the
Abbott REALTIME HIV-1 Assay

| | Frozen | | | | Calculated |
|---|---|---|---|---|---|
| | Sample | | | Percent | Mean |
| | Viral Load | Number | Number | Detected | Viral Load |
| Level | (c/mL) | tested | Detected | (%) | (c/mL) |
| 5 | 502 | 14 | 14 | 100% | 74 |
| 6 | 150 | 14 | 10 | 71% | 42 |
| 7 | 86 | 14 | 8 | 57% | 24 |
| 8 | 83 | 14 | 7 | 50% | 27 |
| 9 | 23 | 14 | 4 | 29% | 16 |
| 10 | TND | 14 | 0 | 0% | N/A |

### 4. Conclusions

A high titer HIV-1 positive sample was diluted in normal human plasma to yield dilutions of 6 concentrations. The diluted samples yielded slightly lower values than expected; however, linear regression analysis yielded an R² value of 0.92067, indicating the diluted samples were acceptable for use in this study (Table 32 & FIG. 42). A maximum loss of 0.88 LOG c/mL of HIV-1 RNA was observed for the plasma samples stored on the ViveST devices for 7 days when compared to the frozen plasma (Table 33 & Table 34). Based on the Probit analysis of the data, when the plasma sample with a HIV-1 concentration of 353 c/mL (2.55 LOG c/mL), was loaded on the ViveST device and stored (up to 7 days), that sample was detected with 95% probability (FIG. 43). For all analysis, results reported as <40 c/mL (<1.60 LOG c/mL) by the Abbott data analysis software were manually calculated using a stored HIV-1 calibration curve.

### Example 18

### Evaluation of Samples Processed through the ViveST Devices for Use in the Vitro Seq HIV-1 Genotyping System (v2.0)

### 1. Purpose

The purpose of this study was to evaluate the samples processed through the ViveST devices of the invention for use in the ViroSeq HIV-1 Genotyping System (v2.0). This example describes the results of accuracy as compared to the frozen plasma not processed through the ViveST devices.

### 2. Methodology

The ViroSeq HIV-1 Genotyping System (v2.0) is a qualitative RNA-based cycle sequencing assay that detects HIV-1 genomic mutations. The assay detects mutations in the entire protease region and two-thirds of the reverse transcriptase region of the HIV-1 pol gene. The assay is based on five major processes: reverse transcription (RT); polymerase chain reaction (PCR); cycle sequencing; automated sequence detection; and software analysis.

The protease and reverse transcriptase regions were amplified to generate a 1.8 kb amplicon. The amplicon were used as a sequencing template for seven primers that generate an approximately 1.3 kb consensus sequence. The ViroSeq HIV-1 Genotyping System (v2.8) software was used to compare the consensus sequence with the known HXB-2 reference sequence to determine mutations present in the sample.

### 3. Experimental Design

The performance of the samples processed through the ViveST devices of the invention in the ViroSeq HIV-1 Genotyping System (v2.0) was evaluated for accuracy as compared to the frozen plasma. Comparative genotypic analysis was performed on duplicate aliquots of ten (10) paired HIV-1 plasma samples (frozen vs. samples processed through the ViveST devices) with viral loads ranging from 3.58 to 5.17 LOG c/ml. To assess reproducibility, of the ten paired samples, replicates (neat, 1:2, and 1:4 dilutions) of two samples and replicates (neat and 1:4 dilution) of one sample were analyzed. Frozen plasma samples were extracted via EtOH (manual extraction per the FDA approved package insert). The plasma samples processed through the ViveST devices of the invention were extracted per bioMONTR's research method (RM-005.00, Sequencing of HIV-1 Pro/RT Region Using ViroSeq HIV-1 Genotyping System and the ABI Prism 3100/3130 Genetic Analyzer). This method utilises an automated RNA extraction, paramagnetic silica particles using NucliSENS easyMag platform (bioMérieux, Inc.). All HIV-1 sequencing reactions were processed on an ABI PRISM 3100 Genetic Analyzer capillary platform (Applied Biosystems) and data was analyzed using ViroSeq software (v2.8). HIV-1 sequence homology was analyzed via bioMONTR's proprietary bioConT sequence analysis tool.

### 4. Results

Drug resistance mutations were 100% concordant (10/10 pairs) in ViroSeq HIV-1 generated reports between the plasma samples processed through the ViveST devices of the invention and the frozen plasma. HIV-1 drug resistance mutations were identified in 4/10 pairs with WT virus detected in 6/10 paired specimens. For all of the paired samples, there was >99% concordance at the nucleotide level when comparing the plasma samples processed through the ViveST devices with the frozen plasma for the protease and reverse transcriptase regions (Table 35). For the replicate samples (neat, 1:2 and 1:4 dilutions), the plasma samples processed through the ViveST devices of the invention produced the identical drug resistance profile pattern regardless of the dilution analyzed.

TABLE 35
Results of ViroSeq Analysis

| | | | | | | | | | | | Concor- | |
|---|---|---|---|---|---|---|---|---|---|---|---|---|
| | | | | | | | | | | | dance | |
| | | | | | | | NanoDrop | | | | based | Concor- |
| Sample Information | | | | | | | Values | | | | on Drug | dance |
| | | | | Dilu- | | | purified | | | | Resis- | at the |
| | | | | tion | Viral Load | | PCR | | | | tance | Nucle- |
| Sam- | Lev- | Repli- | | Fac- | | LOG | product | Drug Resistance Mutations | | | Muta- | otide |
| ple | el | cate | Assay | tor | c/mL | c/mL | (ng/ul) | NRTI | NNRTI | PI | tions | Level |
| 1 | 1 | 1 | ETOH ViroSeq | 1 | 148,140 | 5.17 | 19 | No Mutations Identified | | | 100% | 99.92% |
| | | 4 | ViveST_easyMAG | | | | 14.1 | No Mutations Identified | | | | |
| | 2 | 1 | ETOH ViroSeq | 1:2 | 74,080 | 4.87 | 32.1 | No Mutations Identified | | | 100% | 100.00% |
| | | 2 | ViveST_easyMAG | | | | 12.7 | No Mutations Identified | | | | |
| | 3 | 1 | ETOH ViroSeq | 1:4 | 37,040 | 4.57 | 24.3 | No Mutations Identified | | | 100% | 99.92% |
| | | 2 | ViveST_easyMAG | | | | 10 | No Mutations Identified | | | | |
| 2 | 1 | 1 | ETOH ViroSeq | 1 | 134,424 | 5.13 | 18.3 | No Mutations Identified | | | 100% | 99.08% |
| | | 2 | ViveST easyMAG | | | | 1.7 | No Mutations Identified | | | | |
| | 2 | 1 | ETOH ViroSeq | 1:2 | 67,212 | 4.83 | 48.8 | No Mutations Identified | | | 100% | 99.62% |
| | | 2 | ViveST_easyMAG | | | | 9.1 | No Mutations Identified | | | | |
| | 3 | 1 | ETOH ViroSeq | 1:4 | 33,606 | 4.53 | 18.5 | No Mutations Identified | | | 100% | 99.54% |
| | | 2 | ViveST_easyMAG | | | | 7.3 | No Mutations Identified | | | | |
| 3 | 1 | 1 | ETOH ViroSeq | 1 | 15,176 | 4.18 | 11.6 | M41L, E44D, | V108I, | L10I, V32I, | 100% | 99.46% |
| | | | | | | | | D67N, L74I, | Y181I | M46I, F53L, | | |
| | | | | | | | | L74V, V118I, | | I54V, Q58E, | | |
| | | | | | | | | M184V, L210W, | | A71V, V82A, | | |
| | | | | | | | | T215Y, K219N | | L90M | | |
| | | 2 | ViveST_easyMAG | | | | 10.9 | M41L, E44D, | V108I, | L10I, V32I, | | |
| | | | | | | | | D67N, L74I, | Y181I | M46I, F53L, | | |
| | | | | | | | | L74V, V118I, | | I54V, Q58E, | | |
| | | | | | | | | M184V, L210W, | | A71V, V82A, | | |
| | | | | | | | | T215Y, K219N | | L90M | | |
| | 3 | 1 | ETOH ViroSeq | 1:4 | 3,794 | 3.58 | 15.7 | M41L, E44D, | V108I, | L10I, V32I, | 100% | 99.23% |
| | | | | | | | | D67N, L74I, | Y181I | M46I, F53L, | | |
| | | | | | | | | L74V, V118I, | | I54V, Q58E, | | |
| | | | | | | | | M184V, L210W, | | A71V, V82A, | | |
| | | | | | | | | T215Y, K219N | | L90M | | |
| | | 2 | ViveST_easyMAG | | | | 7.8 | M41L, E44D, | V108I, | L10I, V32I, | | |
| | | | | | | | | D67N, L74I, | Y181I | M46I, F53L, | | |
| | | | | | | | | L74V, V118I, | | I54V, Q58E, | | |
| | | | | | | | | M184V, L210W, | | A71V, V82A, | | |
| | | | | | | | | T215Y, K219N | | L90M | | |
| 4 | 2 | 1 | ETOH ViroSeq | 1:2 | 28,400 | 4.45 | 4.1 | M41L, T215Y | | | 100% | 99.00% |
| | | 2 | ViveST_easyMAG | | | | 4.1 | M41L, T215Y | | | | |
| 5 | 1 | 1 | ETOH ViroSeq | 1 | 24,336 | 4.39 | 7.1 | M41L, T69N, | K103N, | L10F, V11I, | 100% | 99.54% |
| | | | | | | | | K70R, M184V, | V108I, | K43T, I54V, | | |
| | | | | | | | | L210W, T215F, | Y181C | A71V, V82A, | | |
| | | | | | | | | K219E | | I84V, L90M | | |
| | | 2 | ViveST_easyMAG | | | | 14.8 | M41L, T69N, | K103N, | L10F, V11I, | | |
| | | | | | | | | K70R, M184V, | V108I, | K43T, I54V, | | |
| | | | | | | | | L210W, T215F, | Y181C | A71V, V82A, | | |
| | | | | | | | | K219E | | I84V, L90M | | |

### 5. Conclusions

The use of the samples processed through the ViveST devices of the invention in the ViroSeq HIV-1 Genotyping System (v2.0) demonstrated 100% concordance for drug resistance mutations and greater than 99% at the nucleotide level as compared to the frozen plasma. Additionally, replicates of plasma samples processed through the ViveST devices of the invention generated identical drug resistance mutation patterns. The results demonstrate the ViveST devices' utility for transporting plasma obtained from HIV-1 positive individuals for HIV-1 resistance testing.

### Example 19

### The High Pure System Validation Using the Roche TagMan HCV Assay

### 1. Purpose

The purpose of this study was to validate the ViveST devices of the invention for use with The High Pure System using the Roche COBAS TaqMan HCV (v 2.0) assay. This study describes the results of: precision studies; linearity (analytical measurement range); stability (7 days); accuracy as compared to the frozen plasma; and limit of detection (LOD)/limit of quantitation (LOQ).

### 2. Methodology

The Roche COBAS TaqMan HCV (v2.0) for use with The High Pure System is a quantitative RT-PCR based assay that uses RT-PCR to generate amplified product from the RNA genome of HCV in clinical specimens. The process is based on two major steps: a) extraction of viral RNA from plasma samples, and b) amplification with concurrent detection of viral RNA.

### 3. Experimental Design

All testing on the Roche COBAS TaqMan HCV (v2.0) for use with The High Pure System was performed according to FDA approved protocol (0.5 mL) with no modifications. The Roche HCV assay requires 0.5 mL sample, therefore, 0.8 mL sample was loaded on/recovered from each ViveST device to ensure adequate sample volume. All loaded ViveST devices were stored at ambient temperature (RT). The performance of the samples processed through the ViveST devices of the invention in this assay was evaluated for precision, accuracy, analytical measurement range, stability, and limit of detection (LOD)/limit of quantitation (LOQ).

### 3.1 Precision (Inter and Intra-Assay Precision)

To assess inter- and intra-assay precision, HCV infectious plasma samples with varying viral load values (low, mid, and high viral load) were stored in triplicate on the ViveST devices of the invention, recovered, and tested with the Roche HCV assay on different days (n=27). A summary of the results is provided in Table 36.

TABLE 36
Summary of Intra-Assay and Inter-assay Precision (Mean Values)
ViveST_Roche HCV Intra-assay and Inter-assay Precision

| | Intra-Assay Precision | | | | | | | | | Inter-Assay Precision | | |
|---|---|---|---|---|---|---|---|---|---|---|---|---|
| | Concentration | | | | | | | | | | | |
| | Low | | | Medium | | | High | | | | | |
| | Run # | | | | | | | | | | | |
| | 1 | 2 | 3 | 1 | 2 | 3 | 1 | 2 | 3 | | | |
| Days Stored | 1 | 3 | 7 | 1 | 3 | 7 | 1 | 3 | 7 | Low | Medium | High |
| Replicates | 3 | 3 | 3 | 3 | 3 | 3 | 3 | 3 | 3 | 9 | 9 | 9 |
| Mean | 3.65 | 3.59 | 3.48 | 4.17 | 4.22 | 4.06 | 4.48 | 4.49 | 4.38 | 3.57 | 4.15 | 4.45 |
| Std Dev | 0.15 | 0.04 | 0.07 | 0.13 | 0.04 | 0.07 | 0.01 | 0.03 | 0.09 | 0.11 | 0.11 | 0.07 |
| 95% CI | 0.17 | 0.04 | 0.08 | 0.15 | 0.04 | 0.08 | 0.01 | 0.03 | 0.10 | 0.07 | 0.07 | 0.04 |

### Conclusion:

The inter-assay and intra-assay standard deviations (SDs) achieved at mean concentrations of ˜3.55, ˜4.15 and ˜4.45 LOG IU/mL are <0.15 log IU/mL indicating robust reproducibility. The 95% confidence interval (95% CI) for inter-assay precision was +/−0.07 for all time points for all sample concentrations. The 95% confidence interval (95% CI) for intra-assay precision was +/−0.17 for all time points for all sample concentrations.

### 3.2 Analytical Measurement Range and Accuracy

For testing analytical measurement range, a high titer HCV infectious plasma sample (˜6 log copies/mL) was serially diluted in normal human plasma (7 levels). Each level was loaded onto the ViveST devices of the invention in triplicate, stored for 7 days, recovered, and tested on a single run (n=21). For accuracy as compared to the frozen plasma, identical serial dilutions were frozen (in triplicate), thawed, and analyzed (N=21). Results are provided in Table 37 and FIG. 44.

TABLE 37
HCV Linearity Using the Roche COBAS
TaqMan HCV Test (v2.0)

| | Actual | | | | |
|---|---|---|---|---|---|
| | Results | | ViveST | | |
| | Frozen | ViveST | Results | Standard | |
| | Samples | Results | Average | Deviation | Difference |
| Sample | (LOG | (LOG | (LOG | (LOG | Frozen Vs |
| ID | IU/mL) | IU/mL) | IU/mL) | IU/mL) | ViveST |
| Level 7 | 3.92 | 3.46 | 3.55 | 0.10 | −0.37 |
| | | 3.55 | | | |
| | | 3.65 | | | |
| Level 6 | 4.28 | 3.76 | 3.78 | 0.02 | −0.50 |
| | | 3.79 | | | |
| | | 3.78 | | | |
| Level 5 | 4.59 | 4.06 | 4.11 | 0.05 | −0.48 |
| | | 4.14 | | | |
| | | 4.14 | | | |
| Level 4 | 5.01 | 4.34 | 4.40 | 0.07 | −0.61 |
| | | 4.37 | | | |
| | | 4.48 | | | |
| Level 3 | 5.36 | 4.82 | 4.76 | 0.11 | −0.60 |
| | | 4.83 | | | |
| | | 4.64 | | | |
| Level 2 | 5.70 | 5.09 | 5.16 | 0.08 | −0.54 |
| | | 5.14 | | | |
| | | 5.25 | | | |
| Level 1 | 6.08 | 5.43 | 5.46 | 0.04 | −0.62 |
| | | 5.44 | | | |
| | | 5.51 | | | |

| | |
|---|---|
| Minimum Loss | −0.37 |
| Maximum Loss | −0.62 |
| Average Loss | −0.53 |
| (7 day storage) | |

### Conclusion

This study confirmed good sample correlation across a range of ˜3 to ˜6 LOG (samples processed through the ViveST devices as compared to the frozen plasma) with linear regression analysis yielding an R² value of 0.9954. An average reduction of 0.53 LOG IU/mL HCV RNA was observed for samples stored on the ViveST devices for 7 days at ambient condition (RT) prior to recovery and analysis when compared to the frozen plasma.

### 3.3 Stability

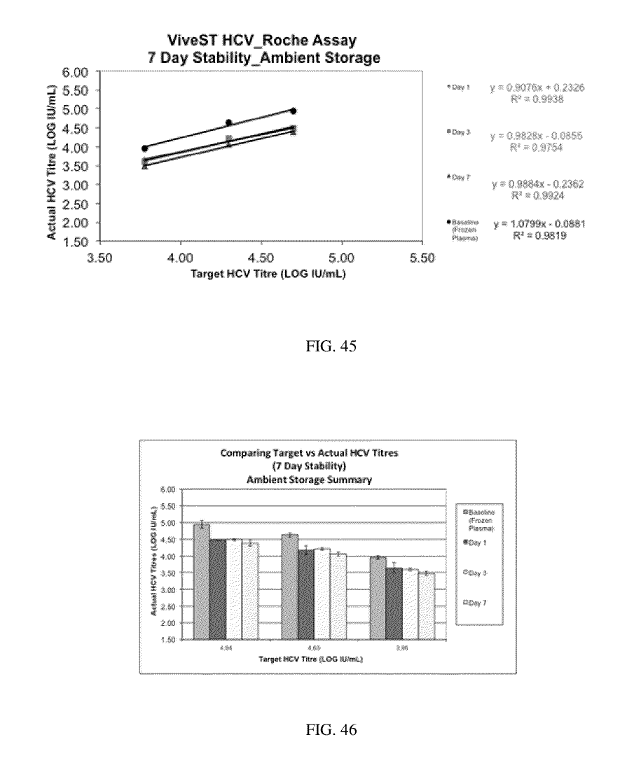

To assess stability, HCV infectious plasma samples with varying viral load values (low, mid, and high viral load) were analyzed on the Roche HCV assay after being stored at ambient condition (RT) on the ViveST devices for 1, 3, and 7 days (n=27). Results are provided in Table 38, FIG. 45 and FIG. 46.

TABLE 38
Results Summary for the HCV 7-Day Stability Studies at
Ambient Storage Conditions using the Roche COBAS
TaqMan HCV Test (v2.0)

| | |
|---|---|
| | Mean Results - |
| Target HCV titre | Ambient Storage |

| (LOG IU/mL) | Frozen | 1 | 3 | 7 |
|---|---|---|---|---|
| 4.70 | 4.94 | 4.48 | 4.49 | 4.38 |
| 4.30 | 4.63 | 4.17 | 4.22 | 4.06 |
| 3.78 | 3.96 | 3.65 | 3.59 | 3.48 |

### Conclusion

For samples stored at ambient temperature (RT), a maximum reduction of 0.57 LOG IU/mL (range 0.31 to 0.57 LOG IU/mL) was recorded between the frozen plasma and the plasma samples stored on the ViveST devices of the invention over a 7-day period (Table 38). The Standard Deviation across all levels/all test points ranged from 0.01 to 0.15. A linear fit (R²>0.97) was retained over the course of the 7-day study as indicated by linear regression analysis across all time points (FIG. 45).

### 3.4 Limit of Detection (LOD)/Limit of Quantitation (LOQ)

For determination of the LOD/LOQ, HCV infectious plasma was diluted in HCV negative human plasma to yield dilutions of approximately 40 to 440 IU/mL. To confirm the HCV RNA concentration, the diluted samples were analyzed and linear regression analysis was performed. 20 replicates of each concentration were then loaded onto the ViveST devices of the invention and stored for 7 days at ambient condition (RT). After recovery, samples were tested using a single lot of extraction and amplification reagents. The Probit analysis was performed to determine the 95% hit rate.

TABLE 39
HCV LOD/LOQ Studies for Frozen Plasma Samples Not
Processed through ViveST using the Roche COBAS
TaqMan HCV Assay

| | | | | | Achieved |
|---|---|---|---|---|---|
| | | Target | | Achieved | HCV |
| | Target | titre | | HCV | Titre |
| | titre | (LOG | Sample | titer | (LOG |
| Level | (IU/mL) | IU/mL) | ID | (IU/mL) | IU/mL) |
| 6 | 12.5 | 1.10 | frozen 6 | 37 | 1.55 |
| 5 | 25 | 1.40 | frozen 5 | 72 | 1.85 |
| 4 | 50 | 1.70 | frozen 4 | 142 | 2.14 |
| 3 | 75 | 1.88 | frozen 3 | 178* | 2.25* |
| 2 | 100 | 2.00 | frozen 2 | 215 | 2.32 |
| 1 | 200 | 2.30 | frozen 1 | 436 | 2.64 |

*= Error during analysis. Value estimated using values of Level 2 and Level 4.

TABLE 40
Summary of HCV LOD/LOQ Data in the Roche COBAS TaqMan HCV Assay

| | | | | | | | Reported |
|---|---|---|---|---|---|---|---|
| | Frozen Sample | | | Percent | | Percent | Mean Viral |
| | Viral Load | Number | Number | Detected | Number | Quantitated | Load (LOG |
| Level | (LOG IU/mL) | tested | Detected | (%) | Quantitated | (%) | IU/mL) |
| 3 | 2.25 | 20 | 20 | 100% | 20 | 100% | 1.89 |
| 4 | 2.14 | 20 | 20 | 100% | 15 | 75% | 1.58 |
| 5 | 1.85 | 20 | 20 | 100% | 0 | 0% | N/A |
| 6 | 1.55 | 20 | 15 | 70% | 1 | 5% | 1.57 |
| | Frozen Sample | | | Percent | | Percent | Reported |
| | Viral Load | Number | Number | Detected | Number | Quantitated | Mean Viral |
| Level | (IU/mL) | tested | Detected | (%) | Quantitated | (%) | Load (IU/mL) |
| 3 | 178 | 20 | 20 | 100% | 20 | 100% | 84 |
| 4 | 142 | 20 | 20 | 100% | 15 | 75% | 41 |
| 5 | 72 | 20 | 20 | 100% | 0 | 0% | N/A |
| 6 | 37 | 20 | 15 | 70% | 1 | 5% | 37 |

### Conclusion

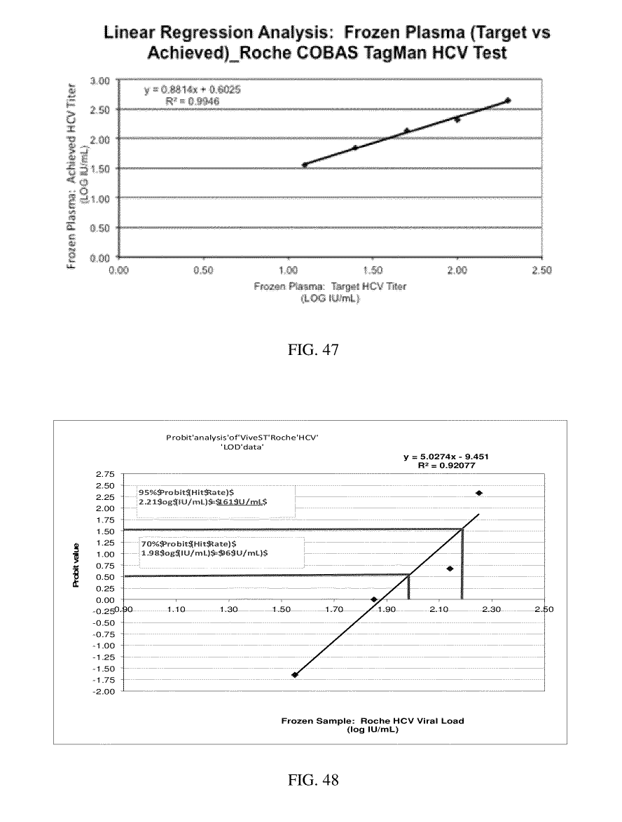

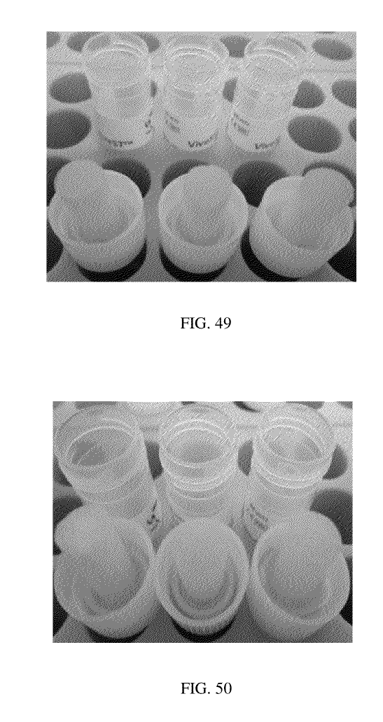

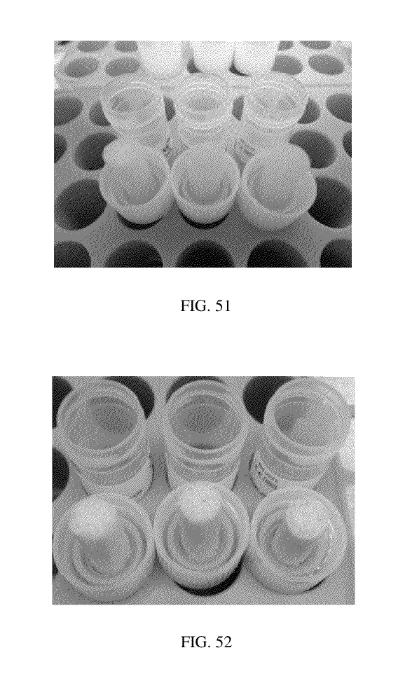

For the LOD/LOQ study, the diluted plasma samples yielded slightly higher HCV viral load values than expected; however, linear regression analysis yielded an R² value of 0.9946, indicating the diluted samples were acceptable for use with the LOD/LOQ study (Table 39 and FIG. 47). Based on the Probit analysis of the data from the plasma samples processed through the ViveST devices, when the plasma sample with a HCV RNA concentration of 161 IU/ml (2.21 LOG IU/mL), was loaded on the ViveST devices of the invention and stored for 7 days at ambient condition (RT), that sample was quantitated with 95% probability (FIG. 48). Probit values were recalculated to determine the limit of detection (LOD). This required calculating the viral load values for the samples that were detected but not quantitated by the AmpliLink software (i.e., results <25 IU/mL).

### 5. Final Conclusions

The use of the ViveST devices of the invention with the Roche COBAS TaqMan HCV Test (v2.0) for use with The High Pure System demonstrated acceptable precision, reproducibility, accuracy, and stability. The results indicate that after 7 days storage at an ambient condition (RT) ˜0.55 LOG IU/mL reduction in HCV concentration is observed for the samples stored and processed through the ViveST devices of the invention as compared to the frozen plasma. The concentration of HCV RNA quantitated with 95% probability after 7 days was 161 IU/mL. The results demonstrate the ViveST devices' utility for storing HCV infectious samples for viral load testing.

### Example 20

### Concentration Study for the ViveST Devices of the Invention

### 1. Purpose

The purpose of this study was to determine if more than 1.0 mL of specimen (i.e., up to 2.0 mL) can be successfully loaded onto the ViveST devices of the invention. All specimens, regardless of load volume, were recovered in 1.0 mL to ascertain if sensitivity is improved by concentrating biological specimens. This study describes the results of specimen load volume experiments, as well as results of analyzing ‘concentrated specimens’ compared to ‘non-concentrated specimens’.

### 2. Methodology

HIV-1 infectious plasma was loaded on/recovered from the ViveST device of the invention. Recovered specimens were analyzed as outlined in the Abbott REALTIME HIV-1 Assay package insert and in accordance with the bioMONTR Research Method (RM-002.00 Quantitation of HIV-1 RNA Using the Abbott REALTIME HIV-1 Assay).

### 3. Experimental Design

### 3.1 Specimen Loading Volume

To assess the maximum volume of plasma that can be successfully loaded onto the ViveST devices of the invention with the polyolefin matrix, HIV-1 infectious plasma (1.0 mL, 1.5 mL and 2.0 mL) was pipetted onto the top of each polyolefin matrix of the individually labeled ViveST device. As described below, pictures were taken to document the results.

Conclusion: 1.0 mL of plasma was loaded onto the polyolefin matrix of the ViveST devices of the invention and was completely absorbed at the time of loading. Additonal volume, up to 1.5 mL, was loaded but was not completely absorbed until approximately 30 minutes after loading. Any volume above 1.5 mL was not appear to be absorbed by the matrix. This excess volume appeard to dry on the interior surface of the cap and could not be recovered for analysis.

### 3.2 Abbott REALTIME HIV-1

To assess concentration of HIV-1 infectious plasma using the ViveST devices of the invention, an HIV-1 infectious plasma sample at a concentration of ˜2.08 LOG c/mL (˜120 c/mL) was analyzed. 10 replicates at 1 mL and 10 replicates at 1.5 mL each were pipetted onto the top of each polyolefin matrix of each individually labeled ViveST device.

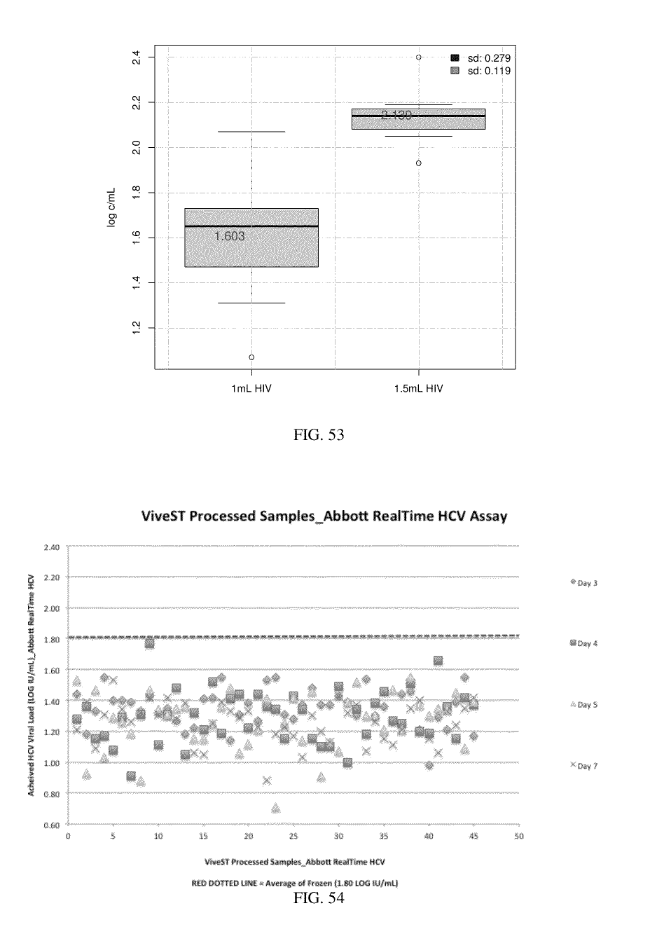

The loaded matrixes were dried overnight in a laminar flow hood at ambient temperature. Devices were capped and stored 4 days at ambient temperature prior to recovery. All specimens were recovered using 1 mL molecular grade water and analyzed according to the Abbott REALTIME HIV-1 package insert (0.5 mL application). The results are provided in Table 41 and FIG. 53.

TABLE 41
Individual Results of HIV-1 Concentration Study using the
Abbott REALTIME HIV-1 Assay

| | Results | Results | Mean | Mean LOG | |
|---|---|---|---|---|---|
| Specimen ID | c/mL | LOG c/mL | c/mL | c/mL | Std Dev |
| 1 mL HIV | 41 | 1.61 | 48 | 1.60 | 0.28 |
| 1 mL HIV | 12 | 1.07 | | | |
| 1 mL HIV | 51 | 1.71 | | | |
| 1 mL HIV | 116 | 2.07 | | | |
| 1 mL HIV | 54 | 1.73 | | | |
| 1 mL HIV | 69 | 1.84 | | | |
| 1 mL HIV | 34 | 1.53 | | | |
| 1 mL HIV | 30 | 1.47 | | | |
| 1 mL HIV | 49 | 1.69 | | | |
| 1 mL HIV | 20 | 1.31 | | | |
| 1.5 mL HIV | 147 | 2.17 | 142 | 2.14 | 0.12 |
| 1.5 mL HIV | 146 | 2.17 | | | |
| 1.5 mL HIV | 112 | 2.05 | | | |
| 1.5 mL HIV | 132 | 2.12 | | | |
| 1.5 mL HIV | 120 | 2.08 | | | |
| 1.5 mL HIV | 142 | 2.15 | | | |
| 1.5 mL HIV | 85 | 1.93 | | | |
| 1.5 mL HIV | 154 | 2.19 | | | |
| 1.5 mL HIV | 250 | 2.4 | | | |
| 1.5 mL HIV | 136 | 2.13 | | | |

Conclusion: An average value of 2.14 LOG c/mL was obtained when 1.5 mL of a low titer HIV-1 infectious plasma sample was loaded on the ViveST devices of the invention and recovered using 1.0 mL of molecular grade water compared to an average value of 1.6 LOG c/mL when 1 mL was loaded and recovered using 1.0 mL molecular grade water. These results indicate that the ViveST devices of the invention may be used to concentrate virus in plasma specimens.

### 4. Final Conclusions

Up to 1.5 mL of plasma can be successfully loaded on the polyolefin matrix of the ViveST devices of the invention. Volumes in excess of 1.0 mL were not immediately absorbed but can be fully absorbed into the matrix after ˜30 minutes. Viral targets were concentrated using the ViveST devices of the invention by recovering a volume less than that loaded. However, there was not a direct proportional relationship between the results obtained with 1 mL input compared to 1.5 mL input indicating that target concentration with the ViveST devices of the invention could have a more meaningful application for qualitative assays (positive/negative tests).

### Example 21

### Low Titer HCV Study

### 1. Purpose

The purpose of this study was to evaluate performance of the ViveST devices of the invention for storage of low titer HCV infectious plasma. This study describes the results of the low titer HCV study.

### 2. Methodology

All testing on the Abbott REALTIME HCV assay was performed according to the FDA approved protocol (0.9 mL) with no modifications. 1 mL HCV infectious plasma was loaded onto the ViveST devices, dried, stored for 3, 4, 5, or 7 days at an ambient temperature and recovered in 1 mL molecular grade water. HCV viral load results of frozen samples were compared to the samples stored and processed through the ViveST devices.

### 3. Experimental Design

A panel of low titer HCV infectious plasma samples (HCV Type 1b) was purchased from Qnostics. Material was shipped on dry ice and stored at −80° C. pending analysis. Qnostics provided the test results: 1.76 LOG IU/mL when tested against the WHO 2^{nd} International Standard; 2.14 LOG IU/mL when tested against the WHO 4^{th} International Standard; and assigned value of 100 IU/mL.

To confirm the viral load of the purchased material, 45 samples were thawed and analyzed without being processed through the ViveST devices (i.e., frozen samples). To evaluate the performance of samples stored and processed through the ViveST devices of the invention, 180 samples were thawed, loaded onto the ViveST devices (1 mL each), dried, and stored at ambient conditions. 45 samples were recovered from the ViveST devices using 1 mL molecular grade water after storage for 3 days, 4 days, 5 days, and 7 days. Frozen samples and all recovered samples were analyzed in the Abbott REALTIME HCV assay in accordance with the package insert and the bioMONTR Research Method (RM-003.00 Quantitation of HCV RNA Using the Abbott REALTIME HCV Assay).

### 4. Results

A summary of the Abbott REALTIME HCV viral load results for the frozen samples and samples stored and processed through the ViveST devices of the invention is provided in Table 42 (LOG IU/mL) and Table 43 (IU/mL) below.

The average concentration of the Qnostics panel samples based on testing 45 frozen samples was 1.80 LOG IU/mL (69 IU/mL) with a range of 1.56-2.20 LOG IU/mL (37-158 IU/mL). The average viral load is below the Qnostics' assigned value of 100 IU/mL. 100% of the samples stored and processed through the ViveST devices of the invention were detected with an average viral load of: 1.35 LOG IU/mL (23 IU/mL) when stored for 3 days at ambient temperature (n=45); 1.29 LOG IU/mL (21 IU/mL) when stored for 4 days at ambient temperature (n=45); 1.27 LOG IU/mL (20 IU/mL) when stored for 5 days at ambient temperature (n=45); and 1.26 LOG IU/mL (19 IU/mL) when stored for 7 days at ambient temperature (n=45).

The Standard Deviations across all assays were: 0.17 LOG IU/mL for frozen samples (n=45); 0.12 LOG IU/mL when stored for 3 days at ambient temperature (n=45); 0.17 LOG IU/mL when stored for 4 days at ambient temperature (n=45); 0.19 LOG IU/mL when stored for 5 days at ambient temperature (n=45); and 0.13 LOG IU/mL when stored for 7 days at ambient temperature (n=45).

The average reduction in viral load for the samples stored and processed through the ViveST devices of the invention, when compared to the frozen plasma, was: 0.45 LOG IU/mL when stored for 3 days at ambient temperature (n=45); 0.51 LOG IU/mL when stored for 4 days at ambient temperature (n=45); 0.53 LOG IU/mL when stored for 5 days at ambient temperature (n=45); and 0.54 LOG IU/mL when stored for 7 days at ambient temperature (n=45).

As shown in FIG. 54, a scatter plot indicates no noticeable trends other than all the samples stored and processed through the ViveST devices yield lower results than the frozen plasma. While the average for the frozen plasma (n=45) was 1.80 LOG IU/mL, all the samples stored and processed through the ViveST devices (n=180) yielded results between 0.71 LOG IU/mL-1.77 LOG IU/mL. Results reported as <1.08 LOG IU/mL (<12 IU/mL) by the Abbott REALTIME HCV data analysis software were manually calculated using a stored HCV calibration curve.

TABLE 42
Summary of Low Copy HCV Study (LOG IU/mL)

| Replicate of Qnostics | | Abbott RealTime HCV (LOG IU/mL) | | | |
|---|---|---|---|---|---|
| HCV panel Samples | FROZEN | Day 3 | Day 4 | Day 5 | Day 7 |
| 1 | 1.82 | 1.44 | 1.28 | 1.53 | 1.21 |
| 2 | 1.89 | 1.18 | 1.36 | 0.93 | 1.39 |
| 3 | 1.75 | 1.33 | 1.15 | 1.47 | 1.09 |
| 4 | 2.11 | 1.55 | 1.17 | 1.03 | 1.31 |
| 5 | 1.76 | 1.40 | 1.08 | 1.29 | 1.53 |
| 6 | 1.89 | 1.40 | 1.29 | 1.26 | 1.34 |
| 7 | 2.00 | 1.39 | 0.91 | 1.19 | 1.26 |
| 8 | 2.12 | 1.33 | 1.31 | 0.88 | 1.32 |
| 9 | 1.75 | 1.43 | 1.77 | 1.47 | 1.42 |
| 10 | 1.77 | 1.32 | 1.11 | 1.34 | 1.31 |
| 11 | 1.79 | 1.35 | 1.31 | 1.31 | 1.42 |
| 12 | 1.81 | 1.27 | 1.48 | 1.35 | 1.28 |
| 13 | 1.64 | 1.18 | 1.05 | 1.36 | 1.38 |
| 14 | 1.88 | 1.22 | 1.37 | 1.15 | 1.06 |
| 15 | 1.81 | 1.41 | 1.21 | 1.15 | 1.05 |
| 16 | 2.17 | 1.42 | 1.52 | 1.25 | 1.25 |
| 17 | 1.69 | 1.55 | 1.19 | 1.36 | 1.39 |
| 18 | 1.83 | 1.14 | 1.41 | 1.48 | 1.33 |
| 19 | 1.71 | 1.31 | 1.44 | 1.06 | 1.29 |
| 20 | 2.20 | 1.38 | 1.22 | 1.17 | 1.33 |
| 21 | 1.70 | 1.27 | 1.44 | 1.21 | 1.23 |
| 22 | 2.00 | 1.53 | 1.36 | 1.41 | 0.88 |
| 23 | 1.64 | 1.55 | 1.34 | 0.71 | 1.18 |
| 24 | 1.80 | 1.31 | 1.15 | 1.25 | 1.23 |
| 25 | 1.68 | 1.28 | 1.43 | 1.42 | 1.17 |
| 26 | 1.70 | 1.37 | 1.34 | 1.14 | 1.03 |
| 27 | 2.19 | 1.48 | 1.15 | 1.46 | 1.3 |
| 28 | 1.68 | 1.37 | 1.10 | 0.91 | 1.2 |
| 29 | 1.85 | 1.37 | 1.10 | 1.13 | 1.13 |
| 30 | 1.87 | 1.43 | 1.49 | 1.07 | 1.43 |
| 31 | 1.89 | 1.39 | 1.00 | 1.39 | 1.32 |
| 32 | 1.78 | 1.30 | 1.34 | 1.52 | 1.37 |
| 33 | 1.73 | 1.54 | 1.18 | 1.3 | 1.07 |
| 34 | 1.56 | 1.30 | 1.38 | 1.3 | 1.26 |
| 35 | 1.59 | 1.36 | 1.46 | 1.71 | 1.15 |
| 36 | 1.73 | 1.27 | 1.27 | 1.47 | 1.11 |
| 37 | 1.69 | 1.44 | 1.25 | 1.21 | 1.21 |
| 38 | 1.58 | 1.46 | 1.51 | 1.55 | 1.35 |
| 39 | 1.61 | 1.20 | 1.20 | 1.37 | 1.4 |
| 40 | 1.69 | 0.98 | 1.19 | 1.3 | 1.15 |
| 41 | 1.60 | 1.29 | 1.66 | 1.35 | 1.06 |
| 42 | 1.77 | 1.21 | 1.36 | 1.38 | 1.33 |
| 43 | 2.08 | 1.39 | 1.15 | 1.45 | 1.24 |
| 44 | 1.71 | 1.55 | 1.42 | 1.09 | 1.35 |
| 45 | 1.69 | 1.17 | 1.37 | 1.39 | 1.47 |
| Average (n = 45) | 1.80 | 1.35 | 1.29 | 1.27 | 1.26 |
| Std Dev | 0.17 | 0.12 | 0.17 | 0.19 | 0.13 |
| 95% CI | 0.05 | 0.04 | 0.05 | 0.05 | 0.04 |

TABLE 43
Summary of Low Copy HCV Study (IU/mL)

| Replicate of Qnostics | | Abbott RealTime HCV (IU/mL) | | | |
|---|---|---|---|---|---|
| HCV panel Samples | FROZEN | Day 3 | Day 4 | Day 5 | Day 7 |
| 1 | 66 | 27 | 19 | 34 | 16 |
| 2 | 78 | 15 | 23 | 9 | 24 |
| 3 | 57 | 22 | 14 | 30 | 12 |
| 4 | 129 | 35 | 15 | 11 | 20 |
| 5 | 58 | 25 | 12 | 20 | 34 |
| 6 | 77 | 25 | 20 | 18 | 22 |
| 7 | 100 | 24 | 8 | 15 | 18 |
| 8 | 133 | 21 | 20 | 8 | 21 |
| 9 | 57 | 27 | 58 | 29 | 27 |
| 10 | 53 | 21 | 13 | 22 | 20 |
| 11 | 62 | 23 | 20 | 20 | 26 |
| 12 | 65 | 19 | 30 | 22 | 19 |
| 13 | 44 | 15 | 11 | 23 | 24 |
| 14 | 76 | 17 | 21 | 14 | 11 |
| 15 | 64 | 26 | 16 | 14 | 11 |
| 16 | 149 | 26 | 33 | 18 | 18 |
| 17 | 49 | 36 | 16 | 23 | 24 |
| 18 | 67 | 14 | 26 | 30 | 22 |
| 19 | 51 | 20 | 27 | 11 | 19 |
| 20 | 158 | 24 | 17 | 13 | 21 |
| 21 | 51 | 19 | 27 | 16 | 17 |
| 22 | 100 | 34 | 23 | 26 | 8 |
| 23 | 44 | 35 | 22 | 5 | 15 |
| 24 | 64 | 20 | 14 | 18 | 17 |
| 25 | 48 | 19 | 27 | 27 | 15 |
| 26 | 50 | 23 | 22 | 14 | 11 |
| 27 | 153 | 30 | 14 | 29 | 20 |
| 28 | 48 | 23 | 13 | 8 | 16 |
| 29 | 71 | 24 | 13 | 14 | 14 |
| 30 | 66 | 27 | 31 | 12 | 27 |
| 31 | 78 | 24 | 10 | 25 | 21 |
| 32 | 60 | 20 | 22 | 33 | 23 |
| 33 | 53 | 34 | 15 | 20 | 12 |
| 34 | 37 | 20 | 24 | 20 | 18 |
| 35 | 39 | 23 | 29 | 16 | 14 |
| 36 | 53 | 19 | 19 | 30 | 13 |
| 37 | 49 | 27 | 18 | 16 | 16 |
| 38 | 38 | 29 | 32 | 35 | 22 |
| 39 | 41 | 16 | 16 | 24 | 25 |
| 40 | 49 | 10 | 15 | 20 | 14 |
| 41 | 40 | 19 | 45 | 23 | 11 |
| 42 | 58 | 16 | 23 | 22 | 21 |
| 43 | 106 | 24 | 14 | 28 | 17 |
| 44 | 51 | 35 | 27 | 12 | 22 |
| 45 | 49 | 15 | 23 | 24 | 26 |
| Average (n = 45) | 69 | 23 | 21 | 20 | 19 |
| Std Dev | 32 | 6 | 9 | 8 | 5 |
| 95% CI | 9 | 2 | 3 | 2 | 2 |

### 5. Final Conclusions

Frozen plasma samples (n=180) with an average viral load of 1.80 LOG IU/mL (69 IU/mL) were stored on the ViveST devices of the invention for up to 7 days. Upon recovery, 100% of these samples were detected using the Abbott's REALTIME HCV assay. While there was some reduction in viral load, the recovery was very reproducible regardless of storage time. These data support the use of a correction factor of 0.5 LOG IU/mL to normalize/align the viral load with values that would be obtained from frozen plasma for the samples stored and processed through the ViveST devices of the invention.

### Example 22

### Validation of the Samples Processed through the ViveST Devices for Use with the Abbott REALTIME HBV Assay

### 1. Purpose

The study purpose was to validate the samples processed through the ViveST devices of the invention for use in the Abbott REALTIME HBV assay. This study describes the results of: precision and accuracy studies; linearity (analytical measurement range); stability (7 days); accuracy as compared to the frozen plasma; and limit of detection (LOD)/limit of quantitation (LOQ).

### 2. Methodology

The Abbott REALTIME HBV assay is an in vitro polymerase chain reaction (PCR) based assay for the quantitation of Hepatitis B Virus (HBV) DNA in human plasma (EDTA) from chronically HBV-infected individuals. The process is based on two major steps: a) extraction of viral DNA from plasma samples; and b) amplification with concurrent detection of viral DNA.

### 3. Experimental Design

All testing on the Abbott REALTIME HBV assay was performed according to the FDA approved protocol (0.5 mL) with no modifications, and in accordance with the bioMONTR Research Method (RM 008.00, Quantitation of HBV DNA Using the Abbott RealtTime HBV Assay). The Abbott HBV assay (0.5 mL protocol) requires 0.7-1.2 mL sample, therefore, 1.0 mL sample was loaded on/recovered from the ViveST devices of the invention to ensure adequate sample volume. All loaded ViveST devices were stored at an ambient temperature (RT). The performance of samples stored and processed through the ViveST devices of the invention in this assay was evaluated for precision/accuracy, analytical measurement range, stability, and limit of detection (LOD)/limit of quantitation (LOQ).

### 4.1 Precision (Inter and Intra-Assay Precision)

To assess inter- and intra-assay precision, HBV infectious plasma samples with varying viral load values (low, mid, and high viral load) were stored in triplicate on the ViveST devices, recovered, and tested with the Abbott REALTIME HBV assay on different days (n=27). A summary of the results is provided in Table 44 below.

TABLE 44
Summary of Intra-Assay and Inter-assay Precision (Mean Values)
Abbott REALTIME HBV_Intra-assay and Inter-assay Precision

| | Intra-Assay Precision | | | | | | | | | Inter-Assay Precision | | |
|---|---|---|---|---|---|---|---|---|---|---|---|---|
| | Concentration | | | | | | | | | | | |
| | Low | | | Medium | | | High | | | | | |
| | Run # | | | | | | | | | | | |
| | 1 | 2 | 3 | 1 | 2 | 3 | 1 | 2 | 3 | | | |
| Days Stored | 1 | 4 | 7 | 1 | 4 | 7 | 1 | 4 | 7 | Low | Medium | High |
| Replicates | 3 | 3 | 3 | 3 | 3 | 3 | 3 | 3 | 3 | 9 | 9 | 9 |
| Mean (log IU/mL) | 3.61 | 3.57 | 3.66 | 4.74 | 4.70 | 4.83 | 5.81 | 5.82 | 5.84 | 3.61 | 4.76 | 5.82 |
| Standard Deviation | 0.04 | 0.05 | 0.06 | 0.02 | 0.13 | 0.10 | 0.02 | 0.04 | 0.03 | 0.06 | 0.10 | 0.03 |
| 95% Confidence | 0.04 | 0.05 | 0.07 | 0.02 | 0.14 | 0.11 | 0.03 | 0.04 | 0.03 | 0.04 | 0.06 | 0.02 |
| Interval | | | | | | | | | | | | |

Conclusion: The inter-assay and intra-assay standard deviations (SDs) achieved at mean concentrations of ˜3.6, ˜4.7 and ˜5.8 LOG IU/mL are <0.13 log IU/mL indicating robust reproducibility. The coefficient of variation (% CV) at a 95% confidence interval for inter-assay precision was <0.06% for all time points for all sample concentrations. The coefficient of variation (% CV) at a 95% confidence level for intra-assay precision was <0.14% for all time points for all sample concentrations.

### 4.2 Analytical Measurement Range and Accuracy

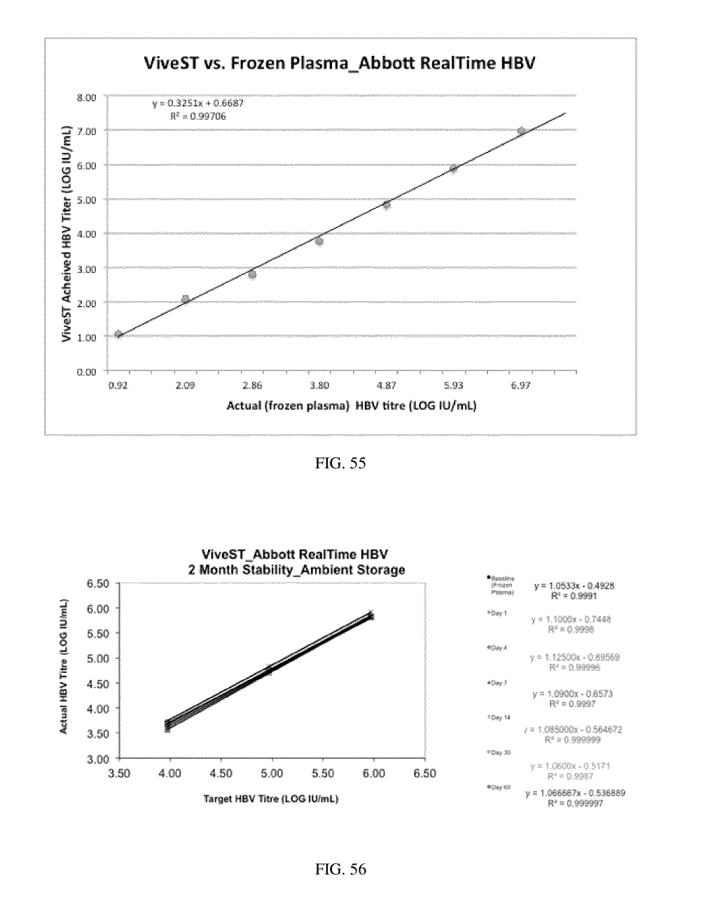

For testing analytical measurement range, a high titer HBV infectious plasma sample (˜7 log IU/mL) was serially diluted in normal human plasma (7 levels). Each level was loaded onto the ViveST devices in triplicate, stored for 7 days, recovered, and tested on a single run (n=21). For accuracy compared to frozen plasma, identical serial dilutions were frozen (in triplicate), thawed, and analyzed (N=21). Results are provided in Table 45 and FIG. 55.

TABLE 45
HBV Linearity Using the Abbott REALTIME HBV Assay
ViveST Device Processed Sample versus Frozen Plasma_Abbott
REALTIME HBV (LOG IU/mL)

| | Actual | Average | | | | |
|---|---|---|---|---|---|---|
| | Results | Results | | ViveST | | Difference |
| Sample | Frozen | Frozen | ViveST | Results | Standard | Frozen Vs |
| ID | Samples | Samples | Results | Average | Deviation | ViveST |
| Level 7 | 1.14 | 0.92 | 1.07 | 1.07 | 0.05 | 0.15 |
| | 0.75 | | 1.03 | | | |
| | 0.87 | | 1.12 | | | |
| Level 6 | 2.15 | 2.09 | 2.15 | 2.09 | 0.07 | 0.00 |
| | 1.97 | | 2.02 | | | |
| | 2.15 | | 2.09 | | | |
| Level 5 | 2.81 | 2.86 | 2.83 | 2.82 | 0.07 | −0.04 |
| | 2.90 | | 2.74 | | | |
| | 2.86 | | 2.88 | | | |
| Level 4 | 3.79 | 3.80 | 3.82 | 3.76 | 0.05 | −0.04 |
| | 3.77 | | 3.74 | | | |
| | 3.85 | | 3.73 | | | |
| Level 3 | 4.93 | 4.87 | 4.83 | 4.84 | 0.04 | −0.02 |
| | 4.82 | | 4.81 | | | |
| | 4.85 | | 4.89 | | | |
| Level 2 | 6.00 | 5.93 | 5.90 | 5.89 | 0.01 | −0.04 |
| | 5.85 | | 5.88 | | | |
| | 5.93 | | 5.88 | | | |
| Level 1 | 7.00 | 6.97 | 6.96 | 6.97 | 0.03 | −0.01 |
| | 6.90 | | 7.00 | | | |
| | 7.02 | | 6.94 | | | |

| | |
|---|---|
| Minimum Loss | 0.15 |
| Maximum Loss | −0.04 |
| Average Loss (7 day storage) | 0.00 |

Conclusion: This study confirmed exceptional sample correlation across a range of ˜1 to ˜7 LOG (samples stored and processed through the ViveST devices of the invention as compared to the frozen plasma) with linear regression analysis yielding an R² value of 0.99706. On average, sample recovered from the ViveST devices of the invention after being stored at an ambient condition (RT) for 7 days yielded equivalent viral load values as compared to frozen plasma.

### 4.3 Stability

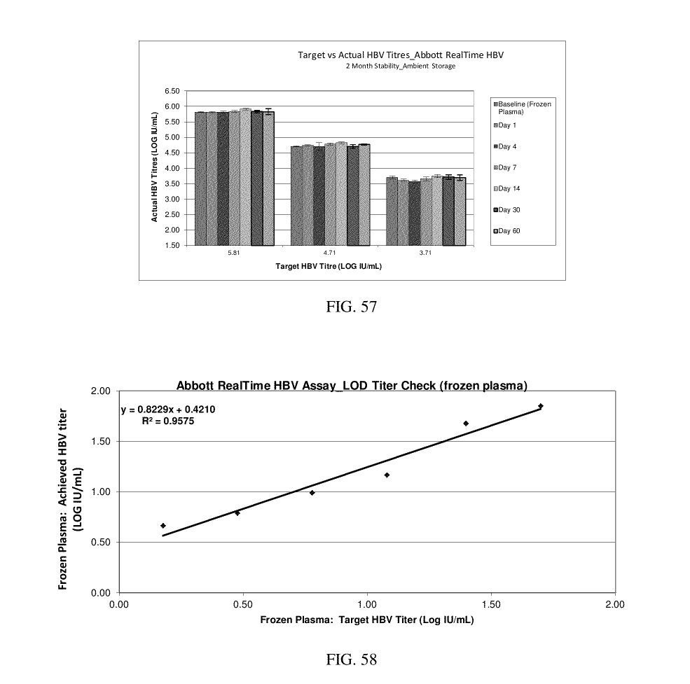

To assess stability, HBV infectious plasma samples with varying viral load values (low, mid, and high viral load) were analyzed on the Abbott REALTIME HBV assay after being stored at an ambient condition (RT) on the ViveST devices of the invention for 1, 4, 7, 14, 30, and 60 days. For accuracy as compared to the frozen plasma, identical serial dilutions were frozen (in triplicate), thawed, and analyzed (N=21). Results are provided in Table 46, FIG. 56 and FIG. 57.

TABLE 46
Results Summary for the HBV 60-Day Stability Studies at Ambient
Storage Conditions using the Abbott REALTIME HBV Assay

| | Target | | | | | | | |
|---|---|---|---|---|---|---|---|---|
| | HBV titre | Frozen | Mean Results (LOG IU/mL): Ambient Storage (Days) | | | | | |
| Level | (LOG IU/mL) | (LOG IU/mL) | 1 | 4 | 7 | 14 | 30 | 60 |
| 1 | 5.97 | 5.81 | 5.81 | 5.82 | 5.84 | 5.91 | 5.83 | 5.83 |
| 2 | 4.97 | 4.71 | 4.74 | 4.70 | 4.78 | 4.83 | 4.71 | 4.77 |
| 3 | 3.97 | 3.71 | 3.61 | 3.57 | 3.66 | 3.74 | 3.71 | 3.70 |

Conclusion: For samples stored on the ViveST devices of the invention over a 60-day period at an ambient conditions (RT) there was no reduction of HBV DNA when compared to the frozen plasma (Table 46 and FIG. 57). The Standard Deviation across all levels/all test points ranged from 0.02 to 0.13. A linear fit (R²>0.99) was retained over the course of the 60-day study as indicated by linear regression analysis across all time points (FIG. 56).

### 4.4 Limit of Detection (LOD)/Limit of Quantitation (LOQ)

For determination of the LOD/LOQ, HBV infectious plasma was diluted in HBV negative human plasma to yield dilutions of approximately 1.5 to 50 IU/mL. To confirm the HBV DNA concentration, the diluted samples were analyzed and linear regression analysis was performed. 15 replicates of each concentration were then loaded onto the ViveST devices of the invention and stored for 7 days at an ambient condition (RT). After recovery, samples were tested using a single lot of extraction and amplification reagents. Probit analysis was performed to determine the 95% hit rate.

TABLE 47
HBV LOD/LOQ Studies for the Frozen Plasma Samples Not Processed through the
ViveST Devices using the Abbott REALTIME HBV Assay
Frozen Plasma: Determination HBV LOD results

| | Target | Target | | Achieved | Average | Achieved | Average |
|---|---|---|---|---|---|---|---|
| | titre | titre (log | | HBV titre | HBV titre | HBV titre | HBV titer |
| Level | (IU/mL) | IU/mL) | Sample ID | (log IU/mL) | (log IU/mL) | (IU/mL) | (IU/mL) |
| 6 | 1.5 | 0.18 | frozen L6 | 1.01 | 0.67 | 10 | 6 |
| | | | | 0.32 | | 2 | |
| 5 | 3 | 0.48 | frozen L5 | 0.76 | 0.79 | 6 | 7 |
| | | | | 0.82 | | 7 | |
| 4 | 6 | 0.78 | frozen L4 | 1.1 | 0.99 | 13 | 11 |
| | | | | 0.88 | | 8 | |
| 3 | 12 | 1.08 | frozen L3 | 1.47 | 1.17 | 30 | 19 |
| | | | | 0.86 | | 7 | |
| 2 | 25 | 1.40 | frozen L2 | 1.77 | 1.68 | 58 | 49 |
| | | | | 1.59 | | 39 | |
| 1 | 50 | 1.70 | frozen L1 | 1.85 | 1.85 | 70 | 70 |

TABLE 48
Summary of LOD/LOQ Data in the
Abbott REALTIME HBV Assay

| | | | | | Mean |
|---|---|---|---|---|---|
| | Frozen Sample | | | | Viral Load |
| | Viral Load | Number | Number | Percent | (LOG |
| Level | (LOG IU/mL) | tested | Detected | Detected (%) | IU/mL) |
| 6 | 0.67 | 15 | 14 | 93% | 0.62* |
| 5 | 0.79 | 15 | 15 | 100% | 0.71* |
| 4 | 0.99 | 15 | 15 | 100% | 1.06* |
| 3 | 1.17 | 15 | 15 | 100% | 1.42 |
| 2 | 1.68 | 15 | 15 | 100% | 1.72 |
| 1 | 1.85 | 15 | 15 | 100% | 1.97 |
| | Frozen Sample | | | | Mean |
| | Viral Load | Number | Number | Percent | Viral Load |
| Level | (IU/mL) | tested | Detected | Detected (%) | (IU/mL) |
| 6 | 6 | 15 | 14 | 93% | 4* |
| 5 | 7 | 15 | 15 | 100% | 6* |
| 4 | 11 | 15 | 15 | 100% | 12* |
| 3 | 19 | 15 | 15 | 100% | 27 |
| 2 | 49 | 15 | 15 | 100% | 54 |
| 1 | 70 | 15 | 15 | 100% | 95 |

*Results reported as <1.00 LOG IU/mL (<10 IU/mL) by the Abbott REALTIME HBV data analysis software were manually calculated using a stored HBV calibration curve.

Conclusion: For the LOD/LOQ study, the diluted plasma samples yielded slightly higher HBV viral load values than expected; however, linear regression analysis yielded an R² value of 0.9575, indicating the diluted samples were acceptable for use with the LOD/LOQ study (Table 47 and FIG. 58). As summarized in Table 48, 14 of 15 samples or 93% with an estimated viral load of 6 IU/mL were detected and yielded a manually calculated mean viral load of 4 IU/mL. All samples (15 of 15) with an estimated viral load of 7 IU/mL were detected and yielded a manually calculated mean viral load of 6 IU/mL.

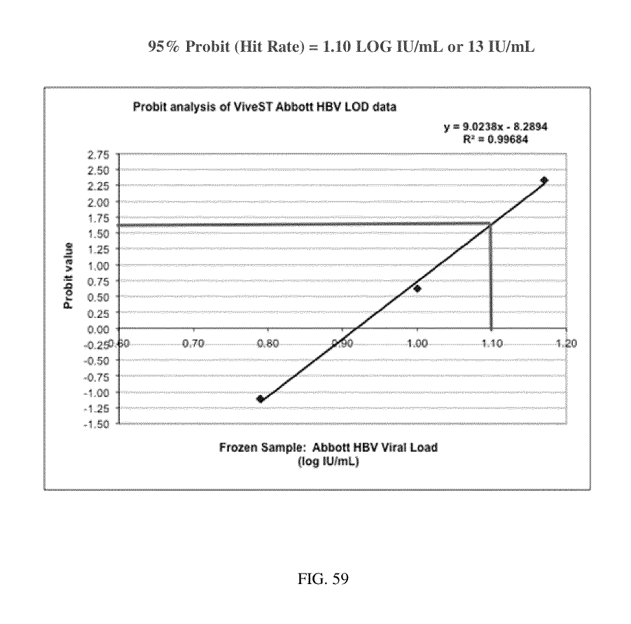

Probit analysis was performed on all the samples stored and processed through the ViveST devices of the invention and analyzed and quantitated by the Abbott REALTIME HBV data analysis software. Based on this analysis, when the plasma sample with a HBV DNA concentration of 13 IU/ml (1.10 LOG IU/mL) was loaded on the ViveST devices of the invention and stored for 7 days at an ambient condition (RT), that sample was quantitated with 95% probability (FIG. 59). The Probit analysis was performed using only sample values quantitated by the Abbott Software (i.e., >10 IU/mL).

### 5. Final Conclusions

The use of the samples stored and processed through the ViveST devices of the invention with the Abbott REALTIME HBV assay demonstrated acceptable precision, reproducibility, accuracy, and stability. The results confirm that HBV infectious plasma stored on the ViveST devices of the invention yields results comparable to those obtained from the frozen plasma not processed through the ViveST devices of the invention.

Other embodiments and uses are apparent to one skilled in the art in light of the present disclosures. Those skilled in the art will appreciate that numerous changes and modifications can be made to the embodiments of the invention and that such changes and modifications can be made without departing from the spirit of the invention. It is, therefore, intended that the appended claims cover all such equivalent variations as fall within the true spirit and scope of the invention.

We claim:

1. A method for preserving and recovering a biological specimen comprising:
(a) providing a dried biological specimen in a device comprising a container defining an interior space having side walls, a bottom and an openable and sealable lid with an absorbent three-dimensional polyolefin matrix removably mounted inside the container, wherein the polyolefin matrix comprises a plurality of interstices with a hydrophobic polyolefin surface and has contained therein the dried biological specimen obtained from an evaporated volume of at least 0.1 ml of a liquid suspension comprising a solvent and the biological specimen absorbed and dried on the matrix;
(b) reconstituting the biological specimen on the polyolefin matrix with a controlled volume of a reconstitution media; and
(c) removing the biological specimen and reconstitution media from the polyolefin matrix by compressing the matrix.

2. The method of claim 1, wherein the polyolefin matrix comprises a plurality of fibers having a substantially hydrophobic surface.

3. The method of claim 2, wherein the fibers within the polyolefin matrix have a polyethylene surface.

4. The method of claim 2, wherein the fibers within the polyolefin matrix comprise polypropylene coated with polyethylene.

5. The method of claim 4, wherein the polypropylene and polyethylene are present in approximately equal amounts by weight.

6. The method of claim 1, wherein the volume of the liquid suspension is at least 0.5 ml.

7. The method of claim 1, wherein the volume of the liquid suspension is at least 1.0 ml.

8. The method of claim 1, wherein the three-dimensional polyolefin matrix is in a shape selected from the group consisting of a cylinder, disk, cube, sphere, pyramid, and cone.

9. The method of claim 1, wherein the biological specimen and reconstitution media are removed from the polyolefin matrix by compressing the matrix in a syringe barrel.

10. The method claim 9, wherein the polyolefin matrix is compressed by at least 50% of the volume of the polyolefin matrix.

11. The method of claim 9, wherein the polyolefin matrix is compressed by at least 80% of the volume of the polyolefin matrix.

12. The method of claim 1, wherein the biological specimen contains an analyte of interest selected from the group consisting of nucleic acids, proteins, carbohydrates, lipids, whole cells, cellular fragments, whole virus and viral fragments.

13. The method of claim 1, wherein the biological specimen contains an analyte of interest selected from the group consisting of DNA and RNA.

14. The method of claim 1, wherein the biological specimen is selected from the group consisting of whole blood, plasma, serum, lymph, synovial fluid, urine, saliva, sputum, semen, vaginal lavage, bone marrow, cerebrospinal cord fluid, physiological body liquids, pathological body liquids, and combinations thereof.

15. The method of claim 1, wherein said liquid suspension comprising said biological specimen further comprises cell suspensions, liquid extracts, tissue homogenates, media from DNA or RNA synthesis, saline and combinations thereof.

16. The method of claim 1, wherein the biological specimen is used for viral load quantitation, genotyping, drug resistance testing, or other analysis of a viral nucleic acid of interest.

17. The method of claim 16, wherein said viral nucleic acid of interest is selected from the group consisting of HCV, HIV, HBV, single- or double-stranded RNA viruses, single- or double-stranded DNA viruses, retrovirus, influenza, and Parvovirus B19.

18. The method of claim 16, wherein said viral nucleic acid of interest is contained within a genome of HCV, HIV, HBV, single- or double-stranded RNA viruses, single- or double-stranded DNA viruses, retrovirus, influenza, or Parvovirus B19.

19. A device for preserving and recovering a biological specimen comprising:
(a) an enclosed container defining an interior space having side walls, a bottom and an openable and sealable lid, and
(b) an absorbent three-dimensional polyolefin matrix removably mounted inside the container wherein the absorbent polyolefin matrix comprises a plurality of interstices defined by a plurality of fibers having hydrophobic polyethylene surfaces, and wherein the absorbent polyolefin matrix can entrain a volume of at least 0.5 ml of a liquid suspension comprising a solvent and a biological specimen.

20. The device of claim 19, wherein the fibers of the polyolefin absorbent matrix comprise a polypropylene core substantially coated with a polyethylene surface.

21. The device of claim 19, wherein the polyolefin matrix is in a shape selected from the group consisting of a cylinder, disk, cube, sphere, pyramid, and cone.

22. The device of claim 19, wherein the polyolefin matrix can entrain a volume of at least 1.0 ml of a liquid suspension.

23. The device of claim 19, wherein the polyolefin matrix has a density of about 0.077 g/cc.

24. The device of claim 19, wherein the polyolefin matrix is compressed by applying force to the plunger against the polyolefin matrix.

25. The device of claim 24, wherein the polyolefin matrix has a volume compressible by at least 50%.

26. The device of claim 19, wherein said biological specimen contains RNA or DNA.
